(19) United States
(12) Patent Application Publication
(10) Pub. No.: US 2015/0379601 A1
(43) Pub. Date: Dec. 31, 2015

(54) Commerce System and Method of Deferring Purchases to Optimize Purchase Conditions

(71) Applicant: My World, Inc., Scottsdale, AZ (US)

(72) Inventor: Kenneth J. Ouimet, Davis, CA (US)

(73) Assignee: MY WORLD, INC., Scottsdale, AZ (US)

(21) Appl. No.: 14/749,366

(22) Filed: Jun. 24, 2015

Related U.S. Application Data
(60) Provisional application No. 62/017,184, filed on Jun. 25, 2014.

(51) Int. Cl. G06Q 30/06

(52) U.S. Cl. CPC G06Q 30/0613

(57) ABSTRACT

A shopping agent is provided. A product displayed at a premises of a first retailer is selected for purchase. A bar code displayed on the product is optically scanned using a mobile device. Data stored in the bar code is transmitted from the mobile device to the shopping agent. A first set of conditions existing while selecting the product is analyzed. A second set of conditions is determined that will result in a lower price for the product. The second set of conditions is communicated from the shopping agent to the mobile device. An option to defer the purchase of the product until the second set of conditions exist is presented. A notification is generated on the mobile device when the second set of conditions exist. The second set of conditions includes purchasing the product at a second retailer. The second set of conditions includes subscribing to the product

### CLAIM OF DOMESTIC PRIORITY

The present application claims the benefit of U.S. Provisional Application No. 62/017,184, filed Jun. 25, 2014, which application is incorporated herein by reference.

### FIELD OF THE INVENTION

The present invention relates in general to consumer purchasing and, more particularly, to a commerce system and method of controlling the commerce system with intelligent personal agents that assist consumers in deferring purchases to optimize purchase conditions.

### BACKGROUND OF THE INVENTION

Grocery stores, general merchandise stores, specialty shops, and other retail outlets face stiff competition for limited consumers and business. Most, if not all, retail stores expend great effort to maximize sales, revenue, and profit. Effective use of promotion budget is critical to increasing profit. Yet, as an inherent reality of commercial transactions, the benefits bestowed on the retailer often come at a cost or disadvantage to the consumer. Maximizing sales and profits for a retailer does not necessarily expand competition and achieve the lowest price for the consumer.

Retailers face economic risk when promoting products to consumers using traditional price discounts. In the past, retailers have made generic offers to an entire population or group of consumers. Coupons published in a newspaper, or on a website, exemplify traditional discount offers made to large groups of consumers. Any consumer that desires to purchase the product from the retailer can search online or locate the newspaper to find a coupon that the retailer has made publicly available. Many consumers purchase the product using a discount coupon, even though the same consumer has purchased the same product at full price in the past, and intends to purchase the product at full price again. By making generic offers readily available to the public, retailers lose profit from sales to consumers that would purchase the product even absent the discount.

Retailers must also consider the expenses and time required to run a successful marketing campaign based on offering discounts. A retailer offering a generic discount on a product must determine what size of discount to offer, whether the offer should be delivered by radio, television, email, newspaper, text message, website, mail, or another medium, and which groups of consumers should receive the offer. After determining the delivery method and targets, the retailer faces the cost of distributing the discount offers. The retailer generally must pay for distribution regardless of the success of a promotion, exposing the retailer to economic risk if the promotion is unsuccessful. The offering retailer is also subject to economic risk associated with reduced profit margin on sales subject to the discount, particularly if more consumers use the coupon than the retailer budgeted for.

On the other side of the transaction, consumers face decision stress associated with the demands of everyday shopping. An overwhelming number of products exist that might satisfy a want or need. For example, the average family spends nearly $10,000 at grocery stores in a given year. The average item at a grocery store costs just $3.00. That means the shopper for a family makes purchasing decisions on roughly 3,000 products per year. Given the vast selection available in most product categories, the average shopper has at least 300,000 to 1,000,000 product options available at the grocery store. The number of products available is far too high for an individual consumer to adequately consider each product, much less identify the best options. Even if a shopper could consider a million different options in a year, the time required for the process would eliminate any economic viability in evaluating every low-cost item. As a result, shoppers are often consistent in purchasing the same products at the same location without actually considering whether other products or retailers offer a better value. The consumer is leaving value on the table.

Consumers are interested in product quality, low prices, comparative product features, convenience, and receiving the most value for the money. However, consumers have a distinct disadvantage in attempting to compile information for their benefit. Retailers have ready access to the historical transaction log (T-LOG) sales data, consumers do not. The advantage goes to the retailer. The lack of access to comprehensive, reliable, and objective product information essential to providing effective comparative shopping services restricts the consumer's ability to find the lowest prices, compare product features, and make the best purchase decisions.

For the consumer, some comparative product information can be gathered from various electronic and paper sources, such as online websites, paper catalogs, and media advertisements. However, such product information is usually sponsored by the retailer, and can be slanted or incomplete. Publicly available retailer information is typically limited to the specific retailer offering an advertised product and presented in a manner favorable to the retailer. The product information released by the retailer is subjective and incomplete, i.e., the consumer only sees what the retailer wants the consumer to see. For example, the pricing information may not provide a comparison with competitors for similar products. The product descriptions may not include all product features or attributes of interest to the consumer.

Alternatively, the consumer can visit all retailers offering a particular type of product and record the various prices, product descriptions, and retailer amenities to make a purchase decision. The brute force approach of one person physically traveling to or otherwise researching each retailer for all product information is generally impractical. Many people do compare multiple retailers, e.g., when shopping online, particularly for big-ticket items. Yet, the time consumers are willing to spend reviewing product information decreases rapidly with price. Little time is spent reviewing commodity items. In any case, the consumer has limited time to do comparative shopping, and mere searching online does not constitute an optimization of the purchasing decision. Optimization requires access to comprehensive, reliable, efficient, and objective product information, to which the consumer does not have access. Consumers remain hampered in achieving a level playing field with retailers.

Consumers are often faced with constraints such as budgets, product availability, and retailer locations when making purchasing decisions. The retail location where the consumer is shopping may not provide the same substitutions as competitors and may have higher pricing on some desired goods. A need exists to optimize consumers' shopping lists in light of real world constraints including product availability, retailer locations, and pricing. In addition, consumers would like to reduce the workload of keeping a family fed and staying within a budgetary constraint.

Consumers generally complete an entire shopping trip at a single retailer, where each item needed for the week is purchased. A consumer may compare similar products placed next to each other on a retail shelf, e.g., different brands, configurations, or sizes of the same type of product. However, a consumer shopping at a first retailer has no easy way to figure out what products could be purchased more cheaply at another retailer, or track how much total money could be saved over an entire shopping trip by purchasing select products at the other retailer. Consumers would benefit from a device and method that analyzed product selections as the consumers shop, and actively sought out better deals. Consumers would also benefit from a list management device that keeps track of purchases that the consumer defers. Technological difficulties still exist in a consumer finding the optimal conditions in which to purchase a product or set of products.

### SUMMARY OF THE INVENTION

A need exists for helping a consumer optimize the conditions of a product purchase. Accordingly, in one embodiment, the present invention is a method of controlling a commerce system comprising the steps of providing a shopping agent, selecting a product for purchase displayed at a premises of a first retailer, optically scanning a bar code displayed on the product using a mobile device, transmitting data stored in the bar code from the mobile device to the shopping agent, analyzing a first set of conditions existing while selecting the product, determining a second set of conditions that will result in a lower price for the product, communicating the second set of conditions from the shopping agent to the mobile device, and presenting an option to defer the purchase of the product until the second set of conditions exist.

In another embodiment, the present invention is a method of controlling a commerce system comprising the steps of providing a shopping agent, selecting a product for purchase at a first retailer, notifying the shopping agent of the selected product, analyzing a first set of conditions existing while selecting the product, determining a second set of conditions that will result in a lower price for the product, and presenting an option to defer the purchase of the product until the second set of conditions exist.

In another embodiment, the present invention is a method of controlling a commerce system comprising the steps of selecting a product for purchase under a first set of conditions, determining a second set of conditions that will result in a lower price for the product, and presenting an option to defer the purchase of the product until the second set of conditions exist.

In another embodiment, the present invention is a method of controlling a commerce system comprising the steps of selecting a product for purchase under a first set of conditions, and presenting an option to defer the purchase of the first product until a second set of conditions exist.

### BRIEF DESCRIPTION OF THE DRAWINGS

FIG. 1 illustrates a retailer engaged in commercial activity with a consumer;

FIG. 2 illustrates a commerce system with a manufacturer, distributor, retailer, and consumer;

FIG. 3 illustrates retail transactions between consumers and retailers with the aid of a service provider;

FIG. 4 illustrates an electronic communication network connecting members of the commerce system;

FIG. 5 illustrates a computer system operating on the electronic communication network;

FIG. 6 illustrates a service provider including intelligent agents for a consumer, retailer, and manufacturer;

FIG. 7 illustrates a consumer expressing intent to buy and a consumer agent performing one-to-one negotiation;

FIGS. 8a-8b illustrate a consumer submitting configuration information to a service provider;

FIG. 9 illustrates a consumer expressing intent to buy a product using a camera;

FIGS. 10a-10d illustrate a consumer submitting intent to buy to an intelligent personal agent using a website;

FIGS. 11a-11b illustrate a consumer submitting intent to buy using a recipe website connected to the intelligent personal agent through an API;

FIGS. 12a-12b illustrate manufacturer and retailer agents performing one-to-one negotiation with consumer agents;

FIG. 13 illustrates reviewing a shopping list to redeem discount offers;

FIGS. 14a-14d illustrate an intelligent personal agent providing shopping guidance;

FIGS. 15a-15b illustrate a consumer agent comparing sets of circumstances surrounding a consumer purchase;

FIGS. 16a-16f illustrate a consumer agent notifying a consumer that superior alternative circumstances exist; and

FIGS. 17a-17b illustrate a consumer completing a checkout process at a retailer.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Historically, retailers have utilized high-low, or “hi-lo,” pricing. With hi-lo pricing, retailers draw consumers in with a few heavily advertised and heavily discounted items, then make a profit on other items sold at a higher profit margin. Retailers face economic risk when promoting a product to consumers using traditional price discounts in a hi-lo pricing model. In the past, retailers have made generic offers to an entire population or group of consumers, e.g., discount coupons published in a newspaper or on a website. Any consumer that desires to purchase the product from the retailer can search online or locate the newspaper to find a coupon that the retailer has made publicly available. In many cases, consumers purchase the product using a coupon, even though the same consumer would have otherwise purchased the product at a higher price without the discount. By making generic offers readily available to the public, the retailer risks losing profit from sales to consumers that would purchase the product even absent the discount.

Retailers must also consider the investment required to run a successful marketing campaign based on offering discounts. A retailer offering a generic discount on a product must determine what size of discount to offer, whether the offer should be delivered by radio, television, email, newspaper, text message, website, mail, or another medium, and which groups of consumers should receive the offer. After determining the delivery method and targets, the retailer faces the cost of distributing the discount offers. The retailer generally must pay for distribution regardless of the success of a promotion, exposing the retailer to economic risk if the promotion is unsuccessful. The offering retailer is also subject to economic risk associated with reduced profit margin on sales of discounted items. More consumers may use the coupon than the retailer budgeted for, e.g., due to a specific discount going viral online.

Consumers may also overwhelmingly utilize the discount without purchasing higher margin items at the same retailer, thus undermining the strategy of the hi-lo pricing model. Price transparency in the internet age is making the hi-lo pricing model obsolete by helping shoppers avoid items with higher markup. Some retailers utilize everyday low prices (EDLP), as an alternative to hi-lo pricing. However, evidence shows that EDLP does not generate as much profit as the hi-lo pricing model. Moreover, recent attempts by large retailers to switch from a hi-lo pricing model to an EDLP model have failed remarkably. One-to-one negotiation, through machine-to-machine commerce and implemented using a virtual marketplace, uses technological advancements to create an alternative to hi-lo and EDLP pricing which is able to increase customer base and profit margin for both retailers and manufacturers. The technology is able to identify, capture, and act on a consumer's intention to buy a product or service.

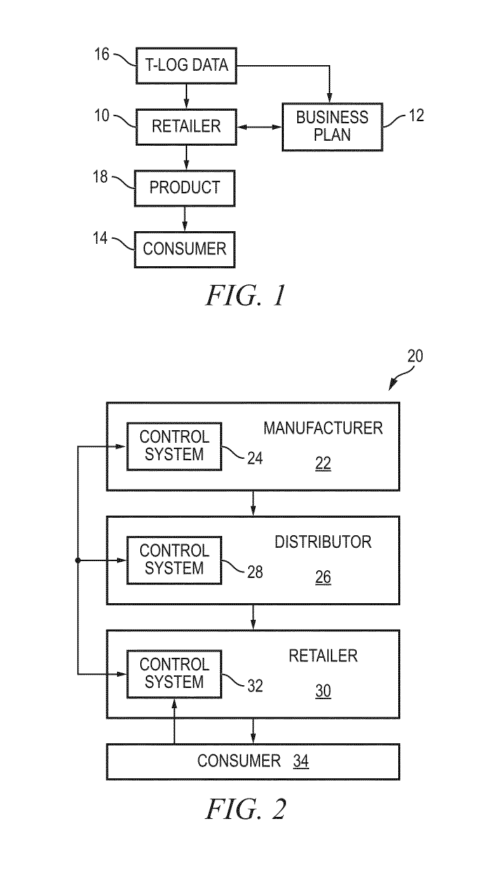

FIG. 1 illustrates a typical commerce system that would benefit from intelligent personal agents identifying and acting on intent to buy. Retailer 10 has certain product lines or services 18 available to a consumer 14 as part of its business plan 12. Product 18 includes not only consumer packaged goods, but also includes services, such as haircuts or automotive repairs, and intangible goods, such as electronic movie tickets or music downloads. Retailer 10 is a grocery store, general consumer product retailer, drug store, discount warehouse, department store, apparel store, specialty store, online retailer, service provider, or other similar entity engaged in commerce. Retailer 10 operates under business plan 12 to set pricing, order inventory, formulate and run promotions, add and remove product lines, organize product shelving and displays, select signage, hire employees, expand stores, collect and maintain historical sales data, evaluate performance, identify trends, and make strategic decisions. Retailer 10 changes or updates business plan 12 as needed or desired. While the present discussion involves retailer 10, the system described herein is applicable to other members in the chain of commerce, and other industries and businesses having similar goals, constraints, and needs.

Retailer 10 routinely enters into sales transactions with customer or consumer 14. Consumer 14 purchases product 18 from retailer 10. Retailer 10 maintains and updates its business plan 12 with the goal of increasing the number of transactions between retailer 10 and consumer 14 (or increasing the total number of consumers engaged in transactions with the retailer), thus increasing revenue and profit for the retailer. Consumer 14 can be a specific individual, account, or business entity. In some cases, the term consumer can refer to a retailer engaged in making purchases from a manufacturer, service provider, distributor, or other entity fulfilling the role of retailer 10 in the transaction.

For each transaction entered into between retailer 10 and consumer 14, information is stored in transaction log (T-LOG) data 16. T-LOG data 16 contains one or more line items for each retail transaction. In one embodiment, T-LOG data 16 is a computer database including a record for each transaction. Each line item or database entry includes information or attributes relating to the transaction, such as store number, product identifier, time of transaction, transaction number, quantity, current price, profit, promotion number, and consumer identity or type number. Retailer 10 provides additional information to T-LOG data 16 such as promotional calendar and events, holidays, seasonality, store set-up, shelf location of products, end-cap displays, flyers, and advertisements, which can be correlated with entries identifying consumer transactions to provide additional information. The information associated with a flyer distribution, e.g., publication medium, run dates, distribution, product location within flyer, and advertised prices, is stored within T-LOG data 16.

FIG. 2 shows commerce system 20 involving the movement of goods between members of the commerce system. Manufacturer 22 produces goods in commerce system 20. Manufacturer 22 uses control system 24 to receive orders, control manufacturing and inventory, and schedule deliveries. Distributor 26 receives goods from manufacturer 22 for distribution within commerce system 20. Distributor 26 uses control system 28 to receive orders, control inventory, and schedule deliveries. Retailer 30 receives goods from distributor 26 or manufacturer 22 for sale within commerce system 20. Retailer 30 uses control system 32 to place orders, control inventory, and schedule deliveries with distributor 26. Retailer 30 sells goods to consumer 34. Consumer 34 patronizes retailer 30 either in person or by using online ordering. Purchases made by consumer 34 are entered into control system 32 of retailer 30 as part of T-LOG data 16.

The purchasing decisions made by consumer 34 drive the manufacturing, distribution, and retail portions of commerce system 20. Higher numbers of positive purchasing decisions made by consumer 34 at retailer 30 lead to more merchandise movement for all members of commerce system 20. Manufacturer 22, distributor 26, and retailer 30 utilize respective control systems 24, 28, and 32 to control and optimize the ordering, manufacturing, distribution, sale of the goods, and otherwise execute respective business plans 12 within commerce system 20 in accordance with the purchasing decisions made by consumer 34.

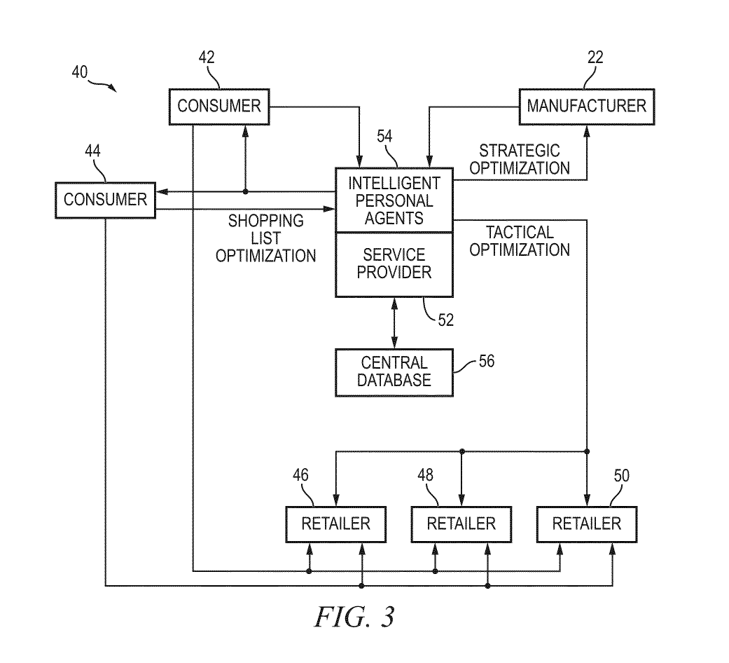

FIG. 3 shows a commerce system 40 with consumers 42-44 engaged in purchasing transactions with retailers 46-50. Manufacturers 22 and distributors 26 supply retailers 46-50, as shown in FIG. 2. Retailers 46-50 are typically local to consumers 42-44, i.e., retailers that consumers 42-44 are likely to patronize in person. Retailers 46-50 can also be remote from consumers 42-44 with transactions handled using electronic communication medium, e.g., ordering by telephone or online via a personal computer or tablet. When ordered online or by telephone, goods are delivered electronically or by common carrier, depending on the nature of the goods. Consumers 42-44 patronize retailers 46-50 by selecting one or more products 18 for purchase from one or more retailers 46-50. For example, consumer 42 visits the store of retailer 46 in person and picks up product 18 from a display shelf for purchase. Consumer 42 contacts retailer 48 by phone or email and selects a different product 18 for purchase. Consumer 44 browses the website of retailer 50 using a personal computer, cell phone, or tablet computer and selects a third product 18 for purchase. Accordingly, consumers 42-44 and retailers 46-50 regularly engage in commercial transactions within commerce system 40.

As described herein, manufacturer 22, distributor 26, retailers 46-50, and consumers 42-44 are members of commerce operating within commerce system 40. The retailer generally refers to the seller of product 18 and the consumer generally refers to the buyer of the product. Depending on the transaction within commerce system 40, manufacturer 22 can be the seller and distributor 26 can be the buyer, distributor 26 can be the seller and retailers 46-50 can be the buyer, or manufacturer 22 can be the seller and consumers 42-44 can be the buyer.

A service provider 52 is a part of commerce system 40. Service provider 52 is a third party that assists consumers 42-44 with the product evaluation and purchasing decision process by providing access to a comparative shopping service and one-to-one negotiation with manufacturers and retailers. More specifically, service provider 52 generates, operates, and maintains an intelligent personal agent 54 for each member of commerce utilizing the service provider. The intelligent personal agents 54 evaluate product attributes and optimize product selection according to consumer-weighted preferences. Intelligent personal agents 54 are computerized agents giving consumers the benefit of access to data stored in central database 56 of service provider 52, which is otherwise unavailable to the consumers. Intelligent personal agents 54 maximize value for consumers 42-44 when spending a grocery budget by using the product attributes and consumer-weighted preferences stored in central database 56. Intelligent personal agents 54 identify intent to buy of consumers 42-44 and utilize the intent to buy in negotiating offers on behalf of consumers. Service provider 52 also provides intelligent personal agents for retailers 46-50 which are capable of negotiating with intelligent personal agents provided for consumers in machine-to-machine commerce. Intelligent personal agents provided for manufacturers negotiate with intelligent personal agents for retailers to get the manufacturers' products stocked at retailers' stores. The agents for the manufacturers also negotiate with consumers to get the consumers to purchase the manufacturers' specific goods over the goods of other manufacturers.

Central database 56 includes store, product, and pricing information collected by or submitted to service provider 52. Central database 56 includes data generated by consumers, manufacturers, and retailers. Central database 56 includes store name, location, and hours for retail stores in the service area of service provider 52. In one embodiment, central database 56 includes information on 20,000 or more retail locations across the United States. Central database 56 includes detailed information on over 3 million products available for purchase at the cataloged stores, including separate categories for the products, attributes of the products, and relationships between the millions of products. Central database 56 includes separate prices for in-store or online purchases, as well as regular prices and available promotional or loyalty prices, which adds up to over 10-20 million total prices stored in the central database. Service provider 52 includes category management algorithms and tools that structure and organize the store, product, and price information into central database 56. In some embodiments, central database 56 is implemented as multiple databases spread across multiple computer systems, each accessible by an application programming interface (API).

Intelligent personal agents 54 provide shopping list optimization to consumers 42-44. Additionally, service provider 52 provides a virtual marketplace for intelligent personal agents 54 to negotiate on behalf of consumers 42 and 44. One-to-one negotiation through service provider 52 creates competition for placement within the limited budgets of consumers by allowing retailers and manufacturers to bid on or make an offer for consumers' business. Intelligent personal agents 54 also assist consumers 42-44 with meal planning by maintaining recipes in central database 56. Consumers 42-44 access recipes through intelligent personal agents 54, or third party websites that maintain recipe databases and interface with intelligent personal agents 54 via an API. Intelligent personal agents 54 saves consumers 42-44 considerable time and money by providing access to a comprehensive, reliable, and objective optimization model or comparative shopping service including identifying and acting on intent to buy. In acting on intent to buy, intelligent personal agents 54 automatically make purchasing decisions on behalf of consumers 42-44 or automatically generate and present comparative pricing data.

Each consumer goes through a product evaluation and purchasing decision process each time a particular product is selected for purchase. Some product evaluations and purchasing decision processes are simple and routine. For example, when consumer 42 is conducting weekly shopping in the grocery store, consumer 42 considers a needed item or item of interest, e.g., canned soup. Consumer 42 has a preferred brand, size, and flavor of canned soup. Consumer 42 enters the grocery store with a strong intent to buy soup generally, and a somewhat weaker intent to buy a specific brand, size, and flavor. Consumer 42 may commonly select the preferred brand from the shelf at a favorite retailer without consideration of price, place the item in the basket, and move on. However, utilizing known qualities of an intent to buy of consumer 42, intelligent personal agent 54 is able to negotiate for a product that satisfies the consumer's intent to buy soup of the preferred flavor, but with a different brand the consumer likes at a lower price.

If consumer 42 is shopping for a big-ticket item, such as a major appliance, the product evaluation and purchasing decision process includes consideration of competing products from several manufacturers 22, visits to multiple retailers 46-50, reviews of product features and warranties, discussions with salespersons, reading consumer reviews, and comparing prices. In any case, understanding the approach of consumer 42 to the product evaluation and purchasing decision process is part of an effective comparative shopping service. Intelligent personal agent 54 is able to observe the product evaluation process of consumers 42-44, infer an intent to buy from specific activity of the consumers, and work for the consumer's benefit based on the identified intent to buy. For instance, intelligent personal agent 54 for consumer 44 may recognize that consumer 44 has an intent to buy a television based on access to browsing history of the consumer on retailer websites. Intelligent personal agent 54 automatically gathers comparative data on televisions fitting the general characteristics of televisions that consumer 44 has been looking for, and negotiates discounts and other offers with retailers.

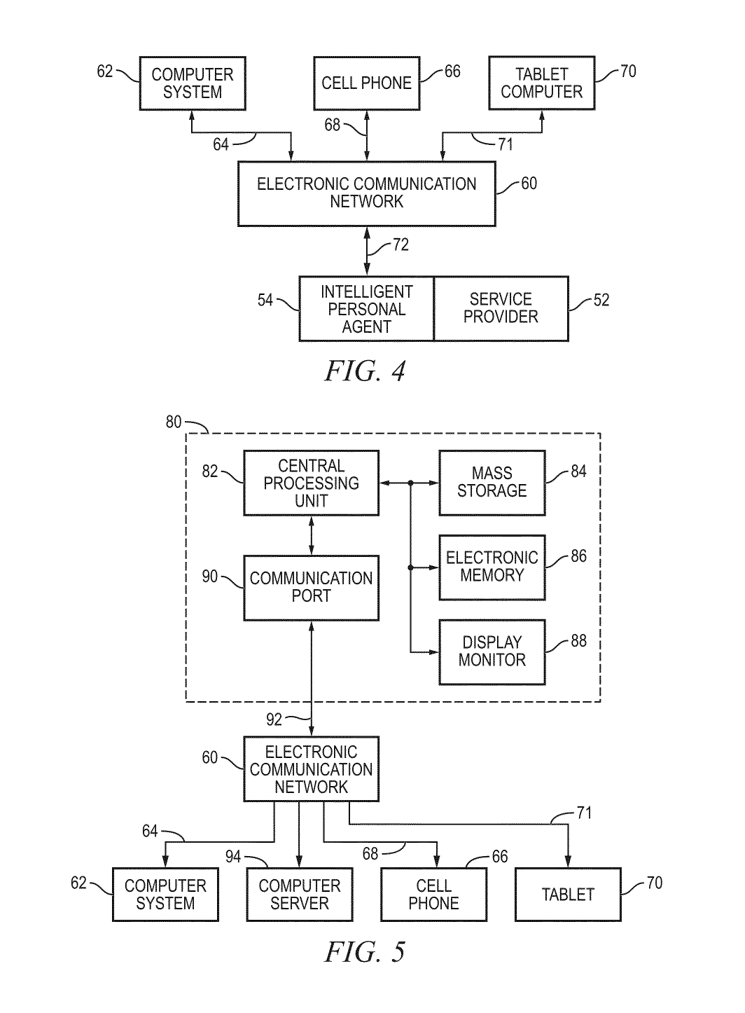

Intelligent personal agents 54 are available to consumers 42-44 via a computer-based online website or other electronic communication medium, e.g., wireless cell phone, tablet, or other personal communication device. FIG. 4 shows an electronic communication network 60 for transmitting information between consumer 42, service provider 52, and retailers 46-50. Consumer 42, or any other member of commerce, operates computer system 62, cell phone 66, or tablet computer 70 to access service provider 52 via an intelligent personal agent 54 created specifically for the consumer or other member of commerce. Computer 62 is connected to electronic communication network 60 by way of communication channel or link 64. Likewise, cellular telephone or smartphone 66 connects to electronic communication network 60 via communication link 68 and tablet 70 is connected to electronic communication network 60 by way of communication channel or link 71.

Service provider 52 communicates with electronic communication network 60 over communication channel or link 72. Generally, members of commerce connect to service provider 52 via an intelligent personal agent 54 created specifically for the member of commerce. Intelligent personal agents 54 include an API providing access to data and features of the intelligent personal agents and service provider. Devices and applications used by members of commerce connect to the API of a respective intelligent personal agent over electronic communication network 60. The electronic communication network 60 is a distributed network of interconnected routers, gateways, switches, and servers, each with a unique internet protocol (IP) address to enable communication between individual computers, cellular telephones, tablets, electronic devices, or nodes within the network. In one embodiment, electronic communication network 60 includes a cell phone service network. In other embodiments, communication network 60 is a global, open-architecture network, commonly known as the internet. Communication channels 64, 68, 71, and 72 are bi-directional and transmit data between computer 62, cell phone 66, tablet 70, service provider 52, and electronic communication network 60 in a hard-wired or wireless configuration. For example, computer 62 has email, and web browsing capability, and consumer cell phone 66 and tablet 70 have email, mobile applications (apps), texting, and web browsing capability.

Further detail of the computer systems used in electronic communication network 60 is shown in FIG. 5 as a simplified computer system 80 for executing software programs used in the electronic communication process. Computer system 80 is a general-purpose computer including a central processing unit (CPU) or microprocessor 82, mass storage device or hard disk 84, electronic memory or RAM 86, display monitor 88, and communication port 90. Communication port 90 represents a modem, high-speed Ethernet link, wireless, or other electronic connection to transmit and receive data over communication link 92 to electronic communication network 60. Computer system 62 and server 94 are configured similar to, and include similar internal parts as, computer 80. Cell phone 66 and tablet 70 include similar components and operate similarly to computer system 80, although commonly run different operating systems, software, and include smaller parts and packaging. Computer systems 62 and 80, server 94, cell phone 66, and tablet 70 transmit and receive information and data over communication network 60.

Computer systems 62, 80, and 94 are physically located in any location with access to a modem or communication link to network 60. For example, computer systems 62, 80, and 94 are located in a home or business office, an office of service provider 52, or are mobile and accompany the user to any convenient location, e.g., remote offices, consumer locations, hotel rooms, residences, vehicles, public places, or other locales with wired or wireless access to electronic communication network 60. Consumer 42 also accesses service provider 52 by mobile apps operating on cell phone 66 or tablet 70, which are carried on the person of consumer 42.

Each of the computers 62, 80, and 94 runs application software and computer programs, which are used to display user interface screens, execute the functionality, and provide the electronic communication features as described herein. The application software includes an internet browser, local email application, mobile apps, word processor, spreadsheet, and the like. In one embodiment, the screens and functionality come from the application software, i.e., the electronic communication runs directly on computer systems 62, 80, and 94. Alternatively, the screens and functions are provided remotely from one or more websites on servers connected to electronic communication network 60.

The software is originally provided on computer readable media, such as compact disks (CDs), digital versatile disks (DVDs), flash drives, and other optical media or mass storage medium. Alternatively, the software is downloaded electronically, such as from a host or vendor website. The software is installed onto the computer system hard drive 84 and/or electronic memory 86, and is accessed and controlled by the computer operating system. Software updates are also available on mass storage medium or downloadable from the host or vendor website. The software, as provided on the computer readable media or downloaded from electronic links, represents a computer program product containing computer readable program code embodied in a non-transitory computer program medium. Computer systems 62, 80, and 94 execute instructions of the application software for communication between consumers 42-44 and service provider 52 to generate shopping lists, accommodate one-to-one negotiation, and make product recommendations. Cell phone 66 or tablet 70 runs one or more mobile apps to execute instructions for communication between consumers 42-44 and service provider 52 which generate shopping lists and make recommendations for consumers 42-44. The application software is an integral part of the control of commercial activity within commerce system 40.

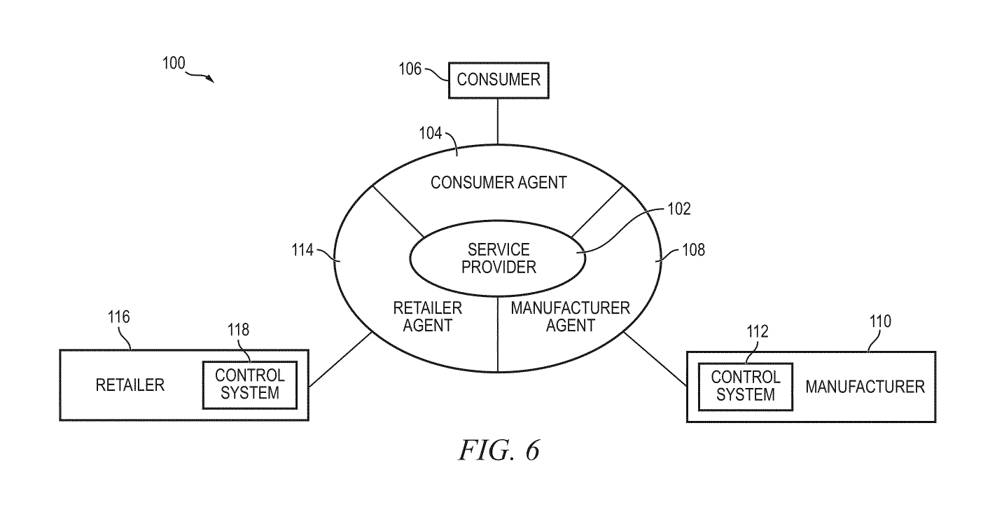

FIG. 6 illustrates commerce system 100 including service provider 102. Service provider 102 is similar to service provider 52. Service provider 102 provides a virtual marketplace allowing one-to-one negotiations between manufacturers, retailers, shoppers, and distributors. Service provider 102 includes personal shopping agent or consumer agent 104 in communication with consumer 106. Service provider 102 also includes brand sales agent or manufacturer agent 108 in communication with manufacturer 110. In some embodiments, manufacturer 110 communicates with manufacturer agent 108 via control system 112 over a digital link in addition to other means of communication. Service provider 102 includes retail sales agent or retailer agent 114 in communication with retailer 116. Retailer agent 114 interfaces directly with control system 118 of retailer 116 in order to automate certain functionality of the retailer agent. Consumer agent 104, manufacturer agent 108, and retailer agent 114 are each intelligent personal agents provided by service provider 102. An intelligent personal agent is an intelligent software application or program designed to interact with a member of commerce, and act on behalf of the member of commerce in one-to-one negotiations with other members of commerce through the other members' intelligent personal agents.

Service provider 102 is a computer hardware or software system that generates and hosts intelligent personal agents, collects and stores retailer, pricing, and product information, and facilitates smart shopping list creation, price comparison, and one-to-one negotiation between members of commerce system 100. For simplicity, FIG. 6 illustrates service provider 102 as including a single consumer agent 104, a single manufacturer agent 108, and a single retailer agent 114. However, in practice, service provider 102 includes separate intelligent personal agents generated specifically for each enrolled consumer, retailer, and manufacturer. In some embodiments, the total number of intelligent personal agents ranges from thousands to hundreds of millions.

Service provider 102 provides an intelligent personal agent 54 for each member of commerce enrolled with the service provider, and controls connections between the personal agents. While FIG. 6 categorizes intelligent personal agents 54 in terms of what type of member of commerce the intelligent personal agent represents, i.e., manufacturer, retailer, or consumer, intelligent personal agents are also considered either shopping agents or sales agents. Transaction occurring through service provider 102 include one party that is selling a product or service to a second party. The intelligent personal agent 54 representing the selling party in a transaction is a sales agent, and the intelligent personal agent representing the buyer is a shopping agent. In the most typical transaction of consumer 106 purchasing a product from retailer 116, consumer agent 104 is a shopping agent and retailer agent 114 is a sales agent. In most transactions between consumer 106 and manufacturer 110, manufacturer agent 108 is the sales agent. If consumer 106 purchases a product from another consumer, the other consumer's intelligent personal agent is a sales agent. Any intelligent personal agent 54, for any member of commerce, is capable of being either a sales agent or shopping agent when fulfilling that role in a particular transaction. All intelligent personal agents 54 acting as sales agents have common features used in negotiating from the sales perspective, regardless of the type of member of commerce represented. All intelligent personal agents 54 acting as shopping agents have common features used in negotiating from the shopper's perspective, regardless of the type of member of commerce represented.

Each member of commerce connected to service provider 102 inputs information into a respective intelligent personal agent for use by the service provider in identifying intent to buy, finding the best comparative product information and prices, and in one-to-one negotiation between consumer agent 104, manufacturer agent 108, and retailer agent 114. Members of commerce enter data using various methods, depending on the capabilities and conveniences particular to each member of commerce. In one embodiment, each intelligent personal agent of service provider 102 includes an API used by members of commerce to input information. Members of commerce enter data directly using the API, or through websites and applications connected to a respective intelligent personal agent via the API.

An API facilitates the request and retrieval of information on behalf of a software program or application. An API is a set of commands, functions, and protocols, which programmers or developers use when building software for a specific operating system or application. An API allows programmers to use predefined functions to interact with an external application or computer system. For example, developers of control systems 112 and 118 make requests to use or access functionality of manufacturer agent 108 and retailer agent 114, respectively, by including calls to the intelligent personal agent API in the source code of the control systems. APIs operate seamlessly between applications, behind the scenes, without requiring user interaction. An API provides a way for applications to work with each other to obtain or share information or functionality needed while running silently in the background.

An API allows a software application to communicate with another application running on a remote server over the internet using a series of API calls. With APIs, calls back and forth between applications are managed through web services. Web services are a collection of technological standards and protocols, including XML (Extensible Markup Language), a programming language by which applications communicate over the internet. An API call can comprise software code written as a series of XML messages. Each XML message corresponds to a different function of the remote service. For example, in a conferencing API, there are XML messages that correspond to each element required to schedule a new Web conference. Those elements include the conference time, the organizer's name and contact information, the invitees, and the duration of the conference.

By providing a means for requesting program services, an API can grant access to or open an application as an interface, defining the way in which separate entities or applications communicate. In some cases, software developers analogize APIs as “doors”, or “gateways,” that enable communication between different applications. APIs provide flexible yet controlled access to the data of an external computer system. The value of existing programs can be multiplied because content of the existing applications can be re-used, accessed, or exploited using APIs.

In recent years, popularity of APIs has steadily increased. Businesses see the benefit of permitting consumers limited access to the functionality and data of existing programs. Third party developers enjoy the fruits of existing programs without having to reinvent the wheel. For example, Company A may create an online mapping program, Maps Program A, which includes an API giving a user access to certain limited functionality or data of Maps Program A. A developer can write a software application or webpage, and subsequently utilize the limited functionality or data of Maps Program A by accessing the API provided by Company A. Consequently, the developer's webpage or software application is powered in part by Maps Program A. Companies that release APIs often do so as part of a larger software development kit (SDK) that includes the API, programming tools, and other instructional documents to make a developer's job easier.

Intelligent personal agents 104, 108, and 114 comprise digital entities that manage purchasing decisions on behalf of the members of commerce. Service provider 102 utilizes APIs in numerous ways to perform the functions of the agents. Members of commerce use APIs to input data into central database 56 of service provider 102 via a respective intelligent personal agent. Control system 112 of manufacturer 110 utilizes the API of manufacturer agent 108 when certain events occur so that service provider 102 has the most up to date information possible about manufacturer 110. Control system 112 automatically updates service provider 102 via an API so that the service provider always has up to date information on the current prices of products made by manufacturer 110, current inventory levels, sales volume, new product lines, and other useful information. In some situations, an employee of manufacturer 110 logs into a website hosted by service provider 102, the website being connected to manufacturer agent 108 via the API on the back end, and manually updates information pertaining to the manufacturer. Information is also updated or added using an application running on a mobile device or desktop computer connected to manufacturer agent 108 via the API.

Control system 118 of retailer 116 is programmed to utilize an API of retailer agent 114 to keep service provider 102 up to date with conditions at the retailer. Control system 118 automatically updates service provider 102 when retailer 116 begins carrying a new product or discontinues an old product. When retailer 116 changes the price on a product, control system 118 automatically updates service provider 102 with the new prices. Retailer 116 updates service provider 102 periodically with the inventory levels of various products, including when products become out of stock or back in stock. An employee of retailer agent 114 is also able to manually update information at service provider 102 by using an app or website connected to retailer agent 114 via an API. When consumer 106 makes a purchase at retailer 116, control system 118 automatically sends T-LOG data related to the sale to retailer agent 114 via the API, and the data is stored in central database 56.

Manufacturer 110 and retailer 116 update service provider 102 through an API of a respective intelligent personal agent every time a sale is made. Service provider 102 records sales data for the members of commerce, including when consumers are offered discounts, when consumers utilize discounts, and what other products consumers purchase in the same sales transaction as a discounted item. The data related to consumer 106 helps manufacturer agent 108 and retailer agent 114 determine whether offering a discount to consumer 106 makes financial sense.

APIs allow control systems 112 and 118 to update the negotiation strategy used by the respective intelligent personal agents. In one embodiment, responsible managers at manufacturer 110 set a profit share amount and an authorized discount on individual products via a web interface, and manually update the figures periodically. In other embodiments, managers determine other factors for manufacturer agent 108 to consider when negotiating one-to-one discount offers with consumer agent 104 or retailer agent 114, and control system 112 programmatically modifies configuration values of manufacturer agent 108 in response to results of the negotiation process received via the API. Control system 118 of retailer 116 configures, and automatically reconfigures, retailer agent 114 using an API in a similar fashion.

In some embodiments, control systems 112 and 118 include APIs accessible by manufacturer agent 108 and retailer agent 114, respectively. Service provider 102 determines more up to date data is required, and uses an API of the control systems to request specific data from manufacturer 110 or retailer 116.

Consumer 106 generally does not use an API of consumer agent 104 directly. However, consumer 106 uses apps, websites, or other computer programs that access consumer agent 104 on behalf of consumer 106 via the API. Consumer 106 uses an app on a mobile device, connected to service provider 102 via the API of consumer agent 104, to upload a photograph of a bar code or quick response (QR) code for the purposes of comparing prices of a product at different retailers or for adding the product to a shopping list. Consumer 106 visits a webpage hosted by service provider 102 and connected to consumer agent 104 through the API on the back end. The website allows a consumer to input information such as intent to buy certain products, create and share smart shopping lists, and track a grocery budget. Consumer 106 configures one-to-one negotiations performed by consumer agent 104 on behalf of the consumer using a website, app, widget, dashboard, or other mechanism connected to the consumer agent via an API. Apps running on a mobile phone, computer, or other appliance or device of consumer 106 connect to consumer agent 104 via an API to update the consumer agent on various activities of the consumer that may relate to the consumer's intent to buy.

Members of commerce also use intelligent personal agent APIs of service provider 102 to retrieve information from service provider 102. Control system 112 accesses manufacturer agent 108 periodically to download information pertaining to deals negotiated by the manufacturer agent, data about the consumers and/or retailers being negotiated with, or other information made accessible by service provider 102. The data downloaded from manufacturer agent 108 via an API is used by control system 112 to modify sales forecasts, develop new product lines, and determine how well the negotiation strategy configured in manufacturer agent 108 is achieving the goals of manufacturer 110. Manufacturer 110 accesses specific information about competitors and pricing from manufacturer agent 108 via the API. Manufacturer 110 also accesses information about retailers and consumers with an intent to buy products of manufacturer 110 or competing manufacturers.

Control system 118 downloads data from service provider 102 via retailer agent 114. Control system 118 receives live updates of one-to-one offers as intelligent personal agent 114 negotiates the offers. Retailer 116 has access to detailed information on consumers receiving discount offers, as well as consumers who have an intent to buy products sold at retailer 116 and competing retailers. The API of retailer agent 114 provides visibility to information about specific competitors and pricing, as well as details of negotiations being lost to competitors and reasons for losing. Retailer 116 uses retailer agent 114 to project how well different discounts provided to different classifications of consumers would work. Retailer agent 114 has visibility into the overall negotiation process of service provider 102, and knows for each negotiated consumer purchase how big of a discount or other consideration would be required to get retailer 116 selected as the place of purchase. Retailer agent 114 generates reports showing what steps could be taken and projecting the total number of additional sales that could be won by authorizing certain discounts on specific products or product classes to specific consumers or consumer groups.

A web app hosted by service provider 102 interfaces with intelligent personal agents via an API to provide a dashboard or portal. Consumer 106, as well as management and other personnel at manufacturer 110 and retailer 116, log into a website hosted by service provider 102 to access the dashboard for a respective intelligent personal agent. Logging in causes the dashboard web app to access the specific intelligent personal agent provided by service provider 102 for the specific member of commerce via the API. Consumers use the dashboard to create and view smart shopping lists, view received one-to-one negotiated discounts, and explicitly input intent to buy for specific products or product categories. Managers can view statistical and other data sets, including graphs and other visualizations. The dashboard is helpful in evaluating performance of the intelligent personal agent in one-to-one negotiations.

Consumer 106 uses a web browser plugin connected to consumer agent 104 via an API to allow interaction between the consumer agent and webpages unrelated to service provider 102, but that include content usable by the consumer agent. Consumer 106 expresses intent to buy a product with the click of a button generated by a web browser plugin on the webpage of the product. Consumer 106 expresses an intent to buy in the mere act of visiting the webpage of the product, albeit a weaker level of intent than in clicking a purchase or add to shopping list button. A web browser plugin analyzes the web activity of consumer 106 and determines intent to buy from websites the consumer visits.

Consumer 106 expresses intent to buy several items at once by clicking a button generated by the web browser plugin on the webpage of a recipe the consumer is interested in preparing for dinner. In other embodiments, a button or other interface mechanism is placed on a webpage by the creator of the webpage with an integrated widget, instead of by a web browser plugin installed by the consumer. Consumer 106, operating a mobile phone and executing a mobile application directed to consumer agent 104, can utilize an API through the mobile application and retrieve individualized information tailored specifically to the consumer through service provider 102. Consumer 106 can input intent to buy to consumer agent 104 indirectly by using apps that interface with the consumer agent. Consumer 106 logs into consumer agent 104 through the app, and the app updates the consumer agent through an API with data relating to the consumer's activity.

Because APIs can be integrated within multiple, separate, remote locations, such as a digital publisher or software application of a retailer, a member of commerce can access product or sales information from any location that implements or has access to an API associated with a respective intelligent personal agent. Depending on the design of the API, the application including the API can host the majority of the agent data and functions needed by the API function calls. Alternatively, the API can be designed such that some of the agent functionality is built around the API and exists remote from service provider 102. In some embodiments, the entire functionality of the agents exists at a location remote from service provider 102, e.g., on computer systems of retailer 116 or manufacturer 110. The intelligent personal agents and service provider 102 may communicate with each other using an API.

Further, because of the flexibility of APIs, accessing information at service provider 102 through an API of an intelligent personal agent is easily achieved by integrating the API into software of a new or existing external application. For example, retailer 116, e.g., a grocery store, can integrate a widget within an existing website of the grocery store, which allows consumers to access information from service provider 102 at the website of the grocery store through the consumer agent, powered by the API. A mobile phone app connects to consumer agent 104 via the API to supply the consumer agent with the physical location of consumer 106 based on Global Positioning System (GPS) triangulation. A refrigerator owned by consumer 106 connects to consumer agent 104 via the API to update the consumer agent as to the contents of the refrigerator.

In some cases, a transaction or information request from a member of commerce can be completed using a single agent. For example, consumer 106 first obtains access to consumer agent 104. Consumer 106 accesses consumer agent 104 as a mobile application on a mobile device, as a general software application executed by an electronic device, or through a web browser where the consumer agent is accessed from a website of a retailer, publisher, manufacturer, or any other internet website. Upon accessing consumer agent 104, the consumer agent, using API technology, can obtain information about retailers, manufacturers, and products that has already been retrieved and is stored in central database 56. Service provider 102 receives the API call from consumer agent 104, and provides the information requested back to the consumer agent. Consumer agent 104 then provides the requested data to the app, program, or website that made the original API request via another API. Service provider 102 controls and approves responding with the requested information. APIs provide members of commerce with remote, flexible, and controlled access to the product, manufacturer, and retail data stored on one or more databases accessible by service provider 102.

Thus, information regarding retailer 116 can be provided to service provider 102 before consumer agent 104 is accessed by consumer 106, and interaction with retailer 116 is not required when information is requested. Rather, consumer 106 retrieves predetermined information about a seller of a product, the product, and product preferences of the consumer by initiating an API request for information to service provider 102 through consumer agent 104. Consumer agent 104 analyzes the information from service provider 102, and can create a shopping list for consumer 106, or recommend products for the consumer, based on the information received from the service provider. Consumer agent 104 and service provider 102 compare retailers, products, and other information and provide an automated comparative service for the consumer. Prices of products for individual consumers can be predetermined by service provider 102 with information gathered from product vendors, or prices for individual consumers are calculated on the fly through one-to-one negotiation.

Service provider 102 provides a virtual marketplace for one-to-one negotiations between consumers, retailers, and manufacturers. Retailers and manufacturers compete against each other for placement on shopping lists of consumers. Service provider 102 allows retailers and manufacturers to have visibility into specific competitors and pricing. Manufacturer agent 108 understands when consumer 106 intends to buy a product produced by manufacturer 110. When consumer 106 has expressed an intent to buy a specific product made by manufacturer 110, manufacturer 110 does not need to offer a discount to consumer 106, thus saving money compared to a coupon or other discount available to the public as a whole. Service provider 102 assists retailers and manufacturers to make additional sales, and assists consumers in purchasing goods or services at a high value by providing a machine-to-machine negotiation service over the electronic network. Consumer agent 104 negotiates on behalf of consumer 106 to create an optimized shopping list following the priorities set by consumer 106 with optimized prices for products consumer 106 desires and at the retailers consumer 106 prefers.

Consumer agent 104 and service provider 102 increase price transparency for consumer 106. Service provider 102 has real time access to the prices for products at retailer 116 and other retailers by interfacing with control system 118. Increased price transparency benefits consumer 106 by helping ensure the consumer does not overpay for products. Consumer agent 104 automatically compares prices and recommends that consumer 106 shop where the price for an item is lowest, or where the consumer can get the greatest overall value. On the other hand, increased consumer price transparency reduces the retailer's ability to increase prices to improve profit margins. While retailer 116 gives up something by allowing increased price transparency, the retailer in return gets access to highly useful information about consumers' intent to buy. Accessing intent to buy allows retailers and manufacturers to target marketing dollars in a smart manner, ensuring that each transaction is profitable.

The intent to buy of consumer 106 triggers consumer agent 104 into action. For weaker intents, consumer agent 104 simply gathers product prices from local retailers and adds the information to a recommended products or wish list of consumer 106. For somewhat stronger and more specific intents to buy from consumer 106, consumer agent 104 automatically performs a one-to-one negotiation among retailers, manufacturers, and other members of commerce to satisfy the intent to buy. Retailer 116 wants to satisfy the intent to buy of consumer 106 with a product purchased from retailer 116. Manufacturer 110 wants to satisfy the intent to buy with a product made by manufacturer 110. One-to-one negotiations through the virtual marketplace of service provider 102 allows manufacturer 110 and retailer 116 to control the commerce system to satisfy a greater number of consumers' intents to buy. A consumer expressing an intent to buy triggers one-to-one negotiation through service provider 102, which in turn results in more products moving off the shelves of retailer 116. Manufacturer 110 produces and sells more products to fill the shelves of retailer 116. For strong intents to buy, consumer agent 104 can automatically order a product shipped to the home of consumer 106.

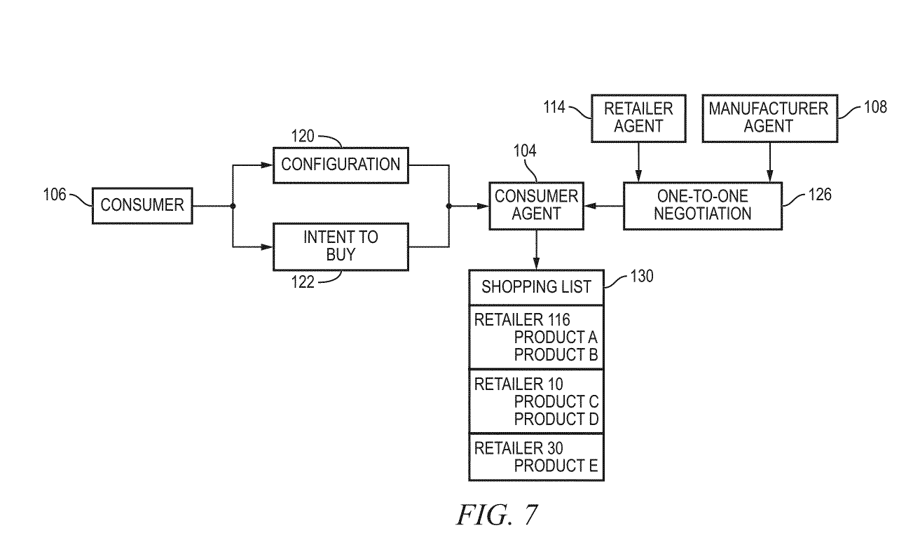

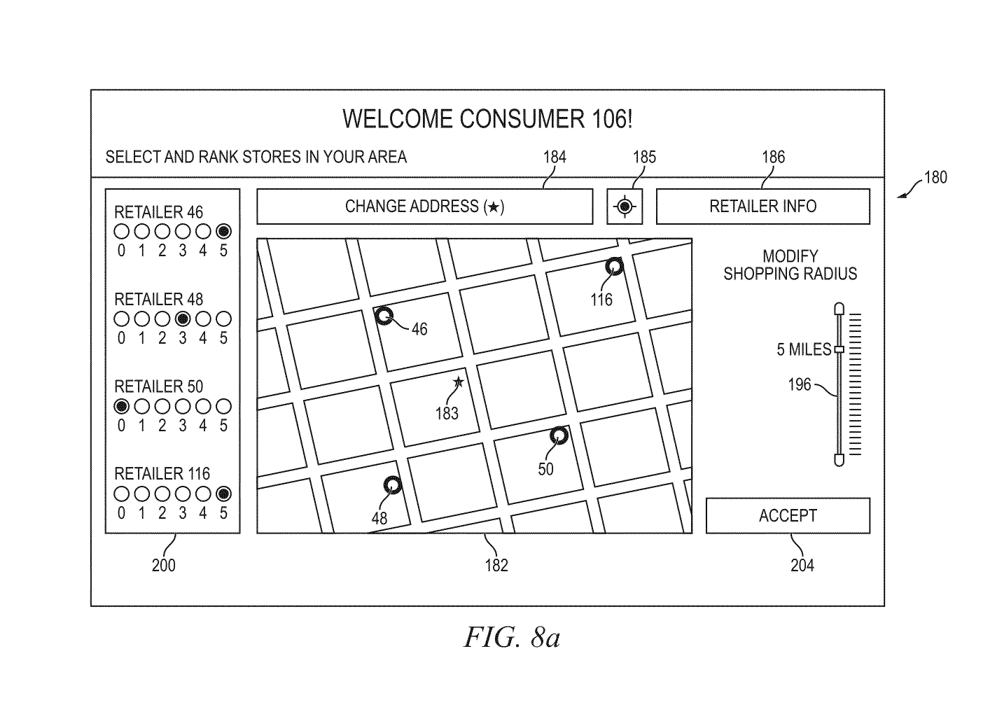

FIG. 7 shows consumer agent 104, provided by service provider 102, populating shopping list 130 for consumer 106. In some embodiments, consumer agent 104 includes multiple shopping lists 130 set up by consumer 106 for different purposes. As a preliminary step, consumer 106 submits configuration 120 to consumer agent 104 via a website, dashboard, app, or other mechanism connected to the consumer agent via an API. Configuration 120 notifies consumer agent 104 as to the negotiation priorities and product preferences of consumer 106. After configuration, consumer 106 supplies intent to buy 122 information to consumer agent 104. Intent to buy 122 provides consumer agent 104 and service provider 102 with notice that consumer 106 is interested in purchasing a product or service. Consumer agent 104 connects to retailer agent 114, manufacturer agent 108, as well as many more agents representing other retailers, manufacturers, distributors and other members of commerce through service provider 102.

Service provider 102 acts as a virtual marketplace allowing for automatic computerized one-to-one negotiation 126 between members of commerce. Consumer agent 104 performs one-to-one negotiation 126 according to configuration 120 set by consumer 106, and adds the winning product from manufacturer 110 sold at retailer 116 onto shopping list 130. Consumer 106 continues submitting intent to buy 122 for various products and services, further populating shopping list 130. Negotiated deals are loaded onto loyalty cards, payment cards, or a phone app of consumer 106 for redemption on a subsequent shopping trip to retailer 116. In some embodiments, negotiated deals are stored on a computer system of retailer 116 by retailer agent 114 communicating with control system 118 via an API. Discounts are associated with a loyalty card assigned to consumer 106 within a computer system of retailer 116. In another embodiment, negotiated deals are associated with a payment card or other payment method that consumer 106 will use when shopping at retailer 116. Negotiated deals can be a specific named price for a product, a discount to be applied at a retailer, a discount for buying multiple products at once, buy one get one free, a bundle of different products, or a mix-and-match of products from a set. A mix and match discount allows consumer 106 to select a certain number of products out of a set of possible products to achieve a discount.

Negotiated deals can also be similar to deals struck in commodities markets. Consumer agent 104 is able to consider advanced deals, e.g., call options or put options, for each individual item on shopping list 130, that consumer 106 would never be able to consider for each of the multitude of products purchased every trip. The virtual marketplace of service provider 102 gives a commerce system many features of a commodities market, and automatically negotiates for the benefit of consumer 106. Consumer agent 104 is able to lock in a specific price on a specific item for a specific amount of time. Negotiating the term of a subscription may operate as a sort of call option by locking in the price of a product for the term of the subscription.

Manufacturers and retailers can also offer a discount to consumer 106 requiring a certain bundle or basket of goods to be purchased from the same manufacturer or retailer. The basket of products can include products from a shopping list 130 of consumer 106 and products consumer 106 would not have otherwise purchased. Manufacturers and retailers can give a discount that requires consumer 106 to spend a certain amount of money at the particular retailer or on the particular manufacturer's goods by a certain date. Consumer agent 104 only accepts deals that consumer 106 will likely fulfill, and ensures that consumer 106 fulfills the deal once accepted.

Configuration 120 includes settings related to negotiation strategy and product preferences which consumer 106 uses to control consumer agent 104. Consumer 106 performs configuration 120 by logging into a website hosted by service provider 102 and accessing a configuration dashboard. An API connects the website hosted by service provider 102 to consumer agent 104. The configuration dashboard connects to consumer agent 104 via an API, reads and displays any previous configuration data 120, and displays sliders, radio buttons, checkboxes, or text boxes as needed for the specific aspects available for consumer 106 to configure. The configuration dashboard uses the API to store updated configuration data 120 to consumer agent 104 when consumer 106 changes the configuration and clicks a save button. In other embodiments, consumer 106 submits configuration 120 using a phone app or other application running locally to the consumer and connected to consumer agent 104 via the API.

Consumer 106 indicates intent to buy 122 for a type of product, or attributes of a desired product, to consumer agent 104 via the API of the consumer agent. Consumer 106 communicates intent to buy 122 to service provider 102 over an electronic network using, for example, a computer or cell phone. Consumer 106 submits intent to buy 122 for multiple products at once using a list of general product descriptions or attributes. For example, consumer 106 submits intent to buy 122 by submitting a shopping list indicating a desire to purchase milk, detergent, and deodorant. Consumer agent 104 uses intent to buy 122 for types of products or products with specific attributes to place a particular product or products on shopping list 130 in place of the generic intent to buy 122 indicated by consumer 106.

Intent to buy 122 represents many different types of data submitted by consumer 106 to consumer agent 104. Consumer 106 submits intent to buy 122 to consumer agent 104 by merely going about the consumer's normal daily routine. Devices used by consumer 106 for various activities throughout the day are connected to consumer agent 104 through the API, and submit relevant data without being proactively instructed by the consumer. Consumer agent 104 collects data from numerous sources, all connected via the API, and organizes the intent to buy 122 information based on strength of the intent, confidence in the intent, specificity or scope of the intent, and other relevant factors.

Each intent to buy 122 is stored in central database 56 as a data structure. When consumer 106 submits intent to buy 122 information, consumer agent 104 either creates a new intent to buy data structure using the information as a base, or uses the information to modify one or more existing intent to buy data structures. Additional intent to buy 122 information submitted by consumer 106 can be used to increase the strength, confidence, or specificity of an existing intent to buy. Consumer agent 104 groups each piece of intent to buy 122 information together in a data structure of related information, and assigns a ratings to each data structure based on the combination of each included piece of information.

Each intent to buy 122 data structure relates to a single product that consumer 106 has an intent to buy. A piece of intent to buy 122 information submitted by consumer 106 may be associated with multiple data structures if the piece of information indicates that consumer 106 is considering buying multiple products, e.g., the consumer views a recipe and consumer agent 104 understands an intent to buy each ingredient of the recipe separately. A piece of intent to buy information that indicates consumer 106 is considering only one of a multiple products is only associated with a single intent to buy data structure. Each data structure represents a single product for purchase. If consumer 106 has an intent to buy both a regular cola and a diet cola, a first data structure exists for the intent to buy a regular cola and a second data structure exists for the intent to buy a diet cola. If consumer 106 only has an intent to buy either a diet cola or a regular cola, a single data structure is created that contains both diet cola and regular cola within the scope of the intent.

Factors of each intent to buy 122 data structure include intent strength. The strength of the intent relates to the likelihood that consumer 106 ultimately purchases a product based on the intent. One of the strongest intent indicators is a specific statement from consumer 106 that the consumer will buy a specific product that the consumer has previously purchased on a regular basis in the past. Consumer agent 104 has high confidence that consumer 106 will make a purchase within the scope of the intent, so the intent to buy 122 is strong. A weaker intent exists when consumer 106 explicitly adds a product to a wishlist. Consumer agent 104 is not sure how soon consumer 106 is likely to purchase the product, or if the consumer will end up not making the purchase. A still weaker intent exists when consumer 106 browses a web page selling a product without explicitly indicating any intention with regard to the product.

Another factor of each intent to buy 122 data structure is confidence of consumer agent 104 in the intent. Many pieces of information submitted by consumer 106 to consumer agent 104 could either indicate an intent to buy a product or could just be a normal activity of consumer 106 not related to any purchasing intention of the consumer. The more likely a specific piece of information is to be based on an intention of consumer 106 to purchase a product, the higher the confidence level of consumer agent 104 in the intent. A low confidence occurs when a piece of information could be interpreted in multiple ways. A high confidence occurs when a piece of information is not open to multiple interpretations and clearly relates to an intent to buy 122 of consumer 106.

The specificity or scope of an intent to buy 122 data structure is an indication of the total number of products that could potentially satisfy the intent of consumer 106. If consumer 106 indicates she is thirsty, the scope of the intent to buy 122 is all potable liquids. Consumer 106 may indicate with the same intent to buy 122 data, or with a later intent to buy submission to consumer agent 104, that a soda is not acceptable to quench her thirst. In that case, the scope of the intent to buy 122 data structure is reduced to non-carbonated beverages. The scope of an intent to buy 122 may be used to define a consideration set. A consideration set is the set of discrete products that a consumer would consider to fulfil a specific intent.

Configuration 120 data may also constitute intent to buy 122 data when applicable to a specific intent to buy 122 data structure. Consumer agent 104 evaluates the applicability of configuration 120 previously entered by consumer 106 for each new piece of intent to buy 122 data. If consumer 106 previously indicated that drinks with caffeine are unacceptable, any intent to buy data structure for drinks automatically pulls in that scope limitation. The scope of the intent to buy of a thirsty consumer 106 will not include caffeinated sodas, teas, or coffee.

In some instances, consumer agent 104 correlates a piece of intent to buy 122 data received with other intent to buy data previously received and stored in central database 56. A piece of intent to buy 122 data received by consumer agent 104 may modify an established intent to buy submitted by consumer 106 rather than representing a new intent to buy for a completely separate product. Consumer agent 104 may receive several pieces of intent to buy 122 data, submitted through different methods, which in combination give the consumer agent confidence to act on behalf of consumer 106, even though any of the pieces of intent to buy information in isolation would not be actionable.

Consumer agent 104 receives intent to buy 122 data generated by activities of consumer 106 on a periodic or continual basis. With each new piece of intent to buy 122 information received, consumer agent 104 makes judgment calls based on the new information in combination with all previous information. Consumer agent 104 may receive successive pieces of intent to buy 122 that each raises the confidence level of the consumer agent with respect to a single specific product. A first piece of intent to buy 122 information triggers consumer agent 104 to pull default prices of various products in a certain category from multiple nearby retailers. A second piece of intent to buy 122 may narrow the potential products within the scope of the intent to buy to only a single product, or a class of substitutable products from which consumer agent 104 is free to select, which triggers consumer agent 104 to negotiate for qualifying products at various retailers. A third piece of intent to buy 122 data may raise the strength of the intent to buy to the point where consumer agent 104 can proactively order the product for consumer 106. In one embodiment, consumer agent 104 creates only a single rating applied to each intent to buy data structure, which takes into consideration factors pertinent to strength, confidence, and scope.

Depending on the strength, confidence, and scope of an intent to buy 122, consumer agent 104 performs different actions with the intent. If an intent to buy 122 rates low on the scale of characteristics, consumer agent 104 merely compares publicly available prices for the product, and presents such products on a suggestion list of recommended products next time consumer 106 uses an app or website of service provider 102. Consumer agent 104 may create a webpage for consumer 106 that illustrates various types of products falling into the scope of the intent to buy. For a higher rated intent, consumer agent 104 actually negotiates with local retailers for a better deal and generates a popup notification on a phone or computer of consumer 106 that a deal is available. For the highest rated intents, consumer agent 104 is authorized by consumer 106 to automatically place orders for items. Consumer 106 is able to configure the thresholds for consumer agent 104 proactively taking different actions in response to different levels of intent to buy 122 characteristic ratings.

Consumer agent 104 selects specific products for placement on shopping list 130 based on relative consumer value of competing products that satisfy intent to buy 122 indicated by consumer 106. Consumer agent 104 places specific products at specific prices on shopping list 130 in place of the more general product identifications provided by consumer 106. For example, consumer agent 104 places one gallon of brand A milk at $3.49, a 50 oz. bottle of brand B concentrated detergent at $11.99, and brand C antiperspirant at $3.49 on shopping list 130 for consumer 106 to fulfill consumer desires for milk, detergent, and deodorant. Consumer agent 104 determines which specific products to place on the list for generic desires or needs of consumer 106 based on configuration 120 and a one-to-one negotiation 126 that generates the best price on brands consumer 106 finds acceptable at retailers that consumer 106 finds acceptable.

Consumer 106 communicates intent to buy 122 to consumer agent 104 using voice recognition technology in one embodiment. Using, e.g., a microphone built within a smartphone, a consumer issues voice commands to the consumer agent to accomplish a variety of tasks. The consumer issues voice commands to add one or more products to a shopping list. By communicating that consumer 106 wishes to add a product to a shopping list, consumer agent 104 recognizes that the consumer has developed an intent to buy 122 for the product. Any variety of voice commands can be utilized to allow the consumer to communicate an intent to purchase or interact with the consumer agent. Consumer agent 104 makes product purchases actionable by placing products on shopping list 130 upon processing voice commands from consumer 106.

Using a cell phone app developed by service provider 102, consumer 106 speaks the name of a product to express intent to buy 122 for the product. The app displays a photo of a product satisfying the intent. Consumer 106 swipes a touchscreen of the cell phone to modify the intent to buy 122 or to purchase the displayed product. Swiping different directions on the touchscreen performs different actions. Swiping up changes the size of the product, e.g., changing a gallon of milk to a quart of milk. Swiping left changes health related qualities of the product, e.g., between white bread, wheat bread, and gluten free bread. Swiping down tells consumer agent 104 that the suggestion is way off, and the consumer agent should try analyzing the voice sample again and suggest a completely different product. Swiping right tells consumer agent 104 to negotiate for the product and either add the product to a shopping list 130 or purchase the product.

Consumer 106 communicates intent to buy 122 using QR codes. A QR code contains a variety of information, and can contain information identifying one or more products. One example of using QR codes to identify an intent to purchase involves an advertisement of a publisher. Whether through digital or print media, consumer 106 views a model or celebrity with a particular appearance and develops a desire to look like the model or celebrity. The model or celebrity may be wearing a variety of products, i.e., clothes, makeup, hair products, jewelry, and the like. Consumer 106 may not be aware of the exact products worn by the model or celebrity, but develops an interest to purchase at least one product to gain the appearance of the model or celebrity. QR codes placed on the advertisement in proximity to the model or celebrity create a link from the physical page to an electronic location, such as a website. Consumer 106 scans or photographs the QR code using a smartphone, and consumer agent 104 processes the information in the QR code. The QR code contains information about one or more products worn or used by the model or celebrity. Consumer agent 104 automatically negotiates one-to-one pricing or other deals when consumer 106 scans the QR code associated with the products.

Consumer 106 indicates intent to buy 122 using a camera on a smartphone or mobile device. Using, e.g., visual recognition software in conjunction with the camera, consumer agent 104 identifies potential products of interest to a consumer using pictures captured using the camera or uploaded to the smart phone. For example, consumer 106 captures a picture of the beach while away on vacation. Consumer agent 104 processes the picture and recommends or places on a shopping list items related to the beach such as sunscreen, a beach umbrella, or sandals. Consumer agent 104 identifies an intent to purchase 122 of consumer 106 in a variety of settings using the software functionality of the consumer agent and hardware tools already existing on mobile devices. By identifying an intent to purchase 122 and preparing products for sale (placing the products on shopping list 130), consumer agent 104 translates product impressions into actual sales. Once consumer agent 104 places a product on shopping list 130, consumer 106 can take action, i.e., finalize a product purchase conveniently and efficiently prepared using the consumer agent.

In some embodiments, retailer agent 114 identifies an intent to buy of retailer 116. Retailer agent 114 manages product inventory on behalf of retailer 116 through an API connection to control system 118. Retailer agent 114 identifies current product inventory, essential product inventory, and past product inventory purchases of retailer 116. Retailer agent 114 provides consideration sets for the product inventory and enables manufacturers to bid for placement within the consideration sets.

Intelligent personal agents evaluate subscriptions for products to ensure that product inventory is always available. For example, consumer agent 104 suggests a subscription to have eggs delivered weekly to consumer 106 as part of a subscription with retailer 116 because consumer agent 104 recognizes that the consumer frequently consumes eggs. Consumer agent 104 recognizes that consumer 106 buys the same razor blades with a regular frequency, i.e., monthly, and recommends the consumer enter into a subscription with the manufacturer of the razor blades to acquire a better deal. Retailer agent 114 suggests a subscription with manufacturer 110 for organic chicken where the retailer agent has identified that organic chicken is a popular retail item and must be readily available for sale by retailer 116 to consumers.

Consumer agent 104 suggests consumer 106 enter into a subscription for products the consumer buys at regular intervals. Consumer agent 104 also suggests subscriptions when a retailer or manufacturer offers discounts on items consumer 106 intends to purchase when the discounts require a subscription to redeem. In one embodiment, consumer agent 104 handles the subscription, and continually orders a product as long as consumer 106 is obligated to purchase the product based on the agreement reached in one-to-one negotiation 126. Consumer agent 104 can offer to subscribe to monthly purchases of a product to receive a discount from retailer 116 or manufacturer 110 as a part of one-to-one negotiation 126. On the other hand, retailer 116 or manufacturer 110 can offer a discount if consumer 106 will accept a subscription.

In some cases, consumer agent 104 automatically subscribes to regular shipments of certain products to obtain a discounted offer for consumer 106. For instance, if consumer agent 104 consistently puts the same product on a shopping list 130 of consumer 106 for a certain period, and the consumer always buys the product each time, then the consumer agent can stop putting the product on a shopping list 130 and simply order the product automatically instead.

Intent to buy 122 is a key component of the sales transaction in a demand driven model. Service provider 102 assists retailer 116, consumer 106, and manufacturer 110 by identifying an intent to purchase 122 of the consumer or retailer and managing the intent using intelligent personal agents. Because the agents are configured to understand the purchasing patterns of retailer 116 and consumer 106, agents identify an intent to purchase 122 without receiving specific instruction from the consumer or retailer. In other words, the agents can identify intent to purchase 122 before the retailer or consumer even recognizes the intent to purchase, and can proactively provide product information, place products on a shopping list 130, or even automatically order products to be shipped to the consumer.

In one embodiment, consumer 106 views an advertisement for product Y, or may simply view product Y and develop an interest in the product. The consumer uses a camera, integrated within a smartphone, to take a picture of product Y. Because consumer agent 104 and service provider 102 are accessible using a mobile device, the consumer agent processes the image of product Y, and initiates negotiation with a plurality of retailer agents that can make discount offers for product Y or provide detailed information regarding product Y. Using the image from the camera, the consumer agent can further identify additional products related to product Y, i.e., affinity products or substitute products.

After consumer agent 104 identifies an intent to buy 122 of consumer 106, the consumer agent commences one-to-one negotiation 126. Service provider 102 connects consumer agent 104 with intelligent personal agents of other members of commerce, e.g., retailer agent 114 and manufacturer agent 108, which supply the desired product or service within commerce system 100, and which consumer 106 approves of. All identified retailers and manufacturers compete for placement on shopping list 130. One-to-one negotiation 126 is a form of machine-to-machine commerce, where decisions are computerized.

In one embodiment, consumer 106 expresses intent to buy 122 for a type of good having specific attributes, e.g., quality, quantity, size, features, ingredients, service, warranty, and convenience. Manufacturer 110 produces a product fitting intent to buy 122. Another manufacturer produces a competing product also fitting the requirements of intent to buy 122. Each manufacturer producing a qualifying product competes to have the good produced by the respective manufacturer placed on shopping list 130 by consumer agent 104. Each retailer selling a qualifying product competes to have the item added to shopping list 130 associated with a shopping trip to that retailer. Consumer agent 104 identifies the specific product, sold at a specific retailer, which offers the best subjective value for consumer 106 for products that satisfy intent to buy 122.

Service provider 102 uses discount offer information provided by retailers and manufacturers to respective intelligent personal agents and product data stored in central database 56 to provide one-to-one offer negotiation 126. Retailers and manufacturers provide service provider 102 with discount information so that the service provider can offer optimized discounts to consumer 106 in order to make a sale to consumer 106. The discount information includes a maximum discount for each product and a profit share for service provider 102 in the event that service provider 102 generates an additional sale. The profit share specifies a percentage of the incremental profit above the maximum discount that service provider 102 receives as a commission.

In other embodiments, retailers and manufacturers program respective intelligent personal agents with other strategic considerations used in one-to-one negotiation 126. Retailer 116 configures retailer agent 114 to offer larger discounts to consumers with shopping lists including competing retailers. Retailer agent 114 offers smaller discounts to consumers that already frequent retailer 116. Thus, retailer 116 saves spending marketing dollars on customers who already prefer retailer 116, and targets customers who are likely to be swayed into patronizing the retailer, thus saving retailer 116 money. Retailer 116 configures retailer agent 114 to offer reduced or no discounts to consumers with a history of patronizing retailers to use offered discounts without purchasing other, more profitable, products. Retailer agent 114 saves retailer 116 from wasting marketing dollars on consumers unlikely to provide significant profit for the retailer. In one embodiment, retailer agent 114 integrates with an inventory system of retailer 116, and automatically offers greater discounts on products that are overstocked. Agents for service providers offer greater discounts when the schedules of workers are more open, or when the service is out of season for seasonal services.

Manufacturer 110 configures manufacturer agent 108 to offer larger discounts to consumers that have an intent to buy, or a history of buying, the products of competing manufacturers. Service provider 102 provides visibility to specific competitors and pricing, so manufacturer agent 108 understands when consumers are buying competing products and the price paid. In some embodiments, a manufacturer or retailer agent understands when consumers use or buy competitors' products, even though service provider 102 hides the specific data from retailers and manufacturers themselves. Increased discounts to consumers with intent to buy 122 indicating a competing product helps manufacturer 110 gain new customers and increase market share. In some embodiments, manufacturer 110 authorizes manufacturer agent 108 to offer a product discount making the specific sale unprofitable, or even to give away products at no cost to consumer 106, when the customer shows a strong historical preference for competing products.

Manufacturer agent 108 allows manufacturer 110 to market more expensive products to consumers who already use products made by manufacturer 110. Consumer 106 is a regular user of razor X produced by manufacturer 110. Manufacturer 110 releases a new product line, razor Y, which is more expensive for consumer 106 and more profitable for manufacturer 110. Manufacturer agent 108 recognizes consumer 106 is a user of razor X and offers a discount on razor Y for consumer 106 so that the consumer is able to try, and then switch to, the new more profitable razor Y.

The virtual marketplace provided by service provider 102 allows for one-to-one negotiation between computerized agents for consumers, retailers, and manufacturers. One-to-one negotiations enable consumers to get optimized prices by creating competition for placement on a consumer's shopping list. One-to-one negotiations optimize marketing budgets for retailers and manufacturers by targeting the most profitable areas. Visibility to specific competitors and pricing allows intelligent personal agents to implement advanced negotiation strategies, and offer complicated deals, controlled or configured by members of commerce.

Utilizing intent to buy 122 provides a significant technological advancement over prior art methods of analyzing consumer behavior for pricing models. Prior to analyzing the intent to buy 122 of consumers and retailers, pricing models were based on backward looking data, e.g., what consumers had previously purchased. Considering what consumers intend to buy in the future, not just what the consumers have purchased in the past, allows advanced one-to-one negotiations with increased probability of positive purchasing decisions by consumers. Considering specific products for which consumer 106 has specifically stated an intent to buy is much more useful than analyzing historical purchasing data.

After consumer 106 expresses an intent to buy 122, and consumer agent 104 performs one-to-one negotiation 126 to identify a specific product produced by a specific manufacturer and available at a specific retailer, the specific product is added to shopping list 130. Consumer 106 continues expressing intent to buy 122 for various items, until the consumer is ready to go shopping. Consumer agent 104 organizes shopping list 130 into an optimized shopping trip. Products are grouped by retailer, and retailers are ordered to provide the most convenient round trip for consumer 106. Negotiated discounts are loaded onto loyalty cards in the possession of consumer 106, printed out by the consumer as coupons, or otherwise communicated to the retailers selling the products. In FIG. 7, the shopping trip designed by consumer agent 104 involves consumer 106 driving to retailer 116 and buying product A and product B. Consumer 106 drives from retailer 116 to retailer 10 and buys products C and D, and finally drives to retailer 30 to purchase product E. Consumer 106 follows the suggestions of consumer agent 104. Consumer agent 104 controls what specific products consumer 106 buys and at which retailers.

In some embodiments, where an online retailer won one-to-one negotiation 126 for one or more products on shopping list 130, items for purchase at online retailers are highlighted or separately presented. Consumer 106 merely approves online purchases and consumer agent 104 automatically orders the products, pays with a previously entered payment method, and has the items shipped to a previously established shipping address.

Service provider 102 assists retailers and consumers by controlling purchase decisions within the commerce system. Service provider 102 automates pre-shopping for the consumer while at the same time providing an easy-to-manage promotion system to retailers that reduces economic risk associated with the EDLP and hi-lo pricing models. Consumer 106 receives a one-to-one offer that takes into consideration the relative value of numerous factors to the consumer. Service provider 102 uses the consumer information to create competition between retailers to provide a product or service to consumer 106. Retailer 116 and manufacturer 110 easily manage discount promotions. Retailer 116 and manufacturer 110 reduce economic risk by using service provider 102 to eliminate over-discounting. Service provider 102 controls the commerce system by comparing options and predicting the most valuable option for consumer 106 while limiting economic risk of the retailer. As a result, consumer 106 gets the most valuable product available at an optimal discount with reduced decision stress. The retailer makes an additional sale at an optimum price to increase sales revenue. The service provider shares in the increased sales revenue of the retailer or manufacturer by earning a commission. Thus, each member of the commerce system involved in the purchasing decision benefits from the personal discount offers.

Computerized agents for retailers, consumers, and manufacturers communicate over an electronic network to negotiate through service provider 102, which acts as a virtual marketplace. Service provider 102 uses information provided by consumer 106 including desired products or intent to buy 122 and consumer preferences or configuration 120 submitted by consumer 106 to consumer agent 104. Consumer 106 manages the configuration 120 and intent-to-buy 122 information to determine personal product preferences, store preferences, attribute preferences, and price switching thresholds. Alternatively, consumer 106 provides configuration values simply by shopping at retailers that submit T-LOG data detailing the purchase history of consumer 106. Personal product preferences for consumer 106 are provided directly by consumer 106 or derived from past product purchases of consumer 106, preferences of other consumers, or from particular product attributes identified by consumer 106.

Product preferences signal that consumer 106 prefers a certain product or type of product. Retailer preferences indicate that consumer 106 prefers to shop at particular retailers. Attribute preferences indicate that consumer 106 prefers products with certain attributes, such as certain flavors, ingredients, or manufacturing processes. For example, consumer 106 indicates to consumer agent 104 an intent to buy 122 for milk. Price threshold preferences indicate a relative value between two or more competing products. When a substitute product is offered at a price at or below the price threshold relative to a preferred product, consumer agent 104 knows that consumer 106 is willing to purchase the substitute product instead of the preferred product.

Consumer agent 104 includes many features that automate pre-shopping and shopping decisions and activities. Shopping related decisions are offloaded from human beings, e.g., consumer 106, to computer agents, e.g., consumer agent 104. Consumer agent 104 is able to automatically order products online and have the products delivered to consumer 106 in response to intent to buy 122. Consumer 106 expresses an intent to buy a product, and consumer agent 104 negotiates for and orders a specific product from a specific retailer. Consumer agent 104 automatically reorders important products so that consumer 106 never runs out of favorite products.

Consumer agent 104 understands recipes and meal plans, and is configured by consumer 106 to always keep several days' worth of meals in stock in the consumer's kitchen. Consumer agent 104 understands the favorite recipes of consumer 106 and automatically rotates through ordering the ingredients necessary to prepare different recipes. Consumer 106 adds new recipes to the rotation or removes old recipes from the rotation using a mobile phone app or website. The recipe rotation is a consideration set of recipes that consumer agent 104 selects from. Consumer 106 rates recipes and meals to control the frequency with which ingredients for a particular recipe are automatically purchased by consumer agent 104. Consumer 106 configures consumer agent 104 to always keep a minimum number of meals ready to prepare at any given time, e.g., always have at least three different meal options at any given time available to prepare.

Consumer agent 104 tracks the inventory of products that consumer 106 buys, or that the consumer agent buys for the consumer. Consumer agent 104 automatically buys in bulk when appropriate. Consumer agent 104 combines ingredients for multiple recipes and buys a single package big enough to make all recipes being purchased. For instance, when buying the ingredients for two different recipes that each call for a pound of ground beef, consumer agent 104 purchases a single two-pound package of beef when doing so would reduce the total purchase price. Consumer agent 104 understands when a package of a product is larger than is required for the recipes being purchased. For instance, when purchasing ingredients for a recipe that calls for marjoram, consumer agent 104 does not purchase additional marjoram if a large marjoram shaker was recently purchased for a different recipe.

Consumer agent 104 automates both pre-shopping and shopping decisions and activities. Consumer agent 104 automates pre-shopping by putting together meal plans, negotiating for the required ingredients, and creating optimized shopping lists for consumer 106. Once consumer agent 104 is fully trained, the consumer agent puts together a weekly shopping list for consumer 106, without any intervention by the consumer, that provides a weeks' worth of meals. Decision stress for consumer 106 is greatly reduced by not having to decide what meals to cook or where the best value can be attained on the products required.

Consumer agent 104 automates shopping by automatically purchasing products available online. Consumer agent 104 automatically purchases products online when an online retailer offers the best deal through one-to-one negotiation 126. If consumer 106 prefers automatic online ordering, consumer agent 104 is authorized to pay a certain percentage premium for online ordering over what the same product could be purchased for at a brick-and-mortar store. Consumer agent 104 can order some products online while also creating a shopping list for consumer 106 to purchase other products on a shopping trip. Consumer agent 104 creates a list of all products required to make every meal for the week, and consumer 106 merely goes to a local retailer and buys everything on the list. In some embodiments, service provider 102 contracts with local grocers, or other retailers or distributers, for local delivery of certain fresh produce, meats, or other products. Service provider 102 also programs consumer agent 104 to utilize publically available delivery methods and sources.

Consumer agent 104 also helps automate shopping utilizing GPS technology and a mobile device. When consumer 106 embarks on a shopping trip, the consumer takes a mobile device with GPS capability on the shopping trip. An app running on the mobile device connects to consumer agent 104 via an API to determine which retailer locations consumer 106 is going to on the shopping trip. The app displays a map on the mobile device showing the current location of consumer 106 and the best path the consumer should travel to get to the next retailer on shopping list 130. When multiple retailers are on shopping list 130, the app automatically navigates to subsequent retailers after shopping at a previous retailer is complete. When the shopping trip is complete, the app automatically navigates consumer 106 back home.

Consumer agent 104 also provides GPS capability within retailers. Service provider 102 knows the layouts of retailers, as well as where products are stocked on the shelves of retailers. Consumer agent 104 has access to the data about product locations within retailers, and plans out the best path for consumer 106 to take within the retailer. Consumer agent 104 knows the location of consumer 106 within the store and communicates information about the location of consumer 106 and products within the retailer to the mobile device of consumer 106. The app displays the present location of consumer 106 within a retailer, and the locations of products required to be purchased. The app also displays an optimal path through the store that consumer 106 should follow to pick up each needed product.

Consumer agent 104 manages and automates purchasing decisions for consumer 106. The consumer purchasing process is optimized. Decision-making is shifted from the human consumer to a digital agent. Sales agents for manufacturers and retailers automate sales decisions. Consumer agent 104 creates, modifies, and acts on shopping lists for consumer 106. Consumer agent 104 manages home inventory, finds products, plans shopping lists and trips, saves deals to loyalty cards, and controls shopping logistics. The kitchen of consumer 106 stays fully stocked with a variety of meals ready to cook, and the consumer merely follows a brief shopping list each week to pick up the needed ingredients that cannot be economically ordered for delivery. Consumer 106 does not worry about making decisions as to which specific products fulfill the requirements of recipes, or provide the best subjective value for the consumer. Consumer agent 104 automatically creates a meal plan each week and creates an optimized shopping list for consumer 106.

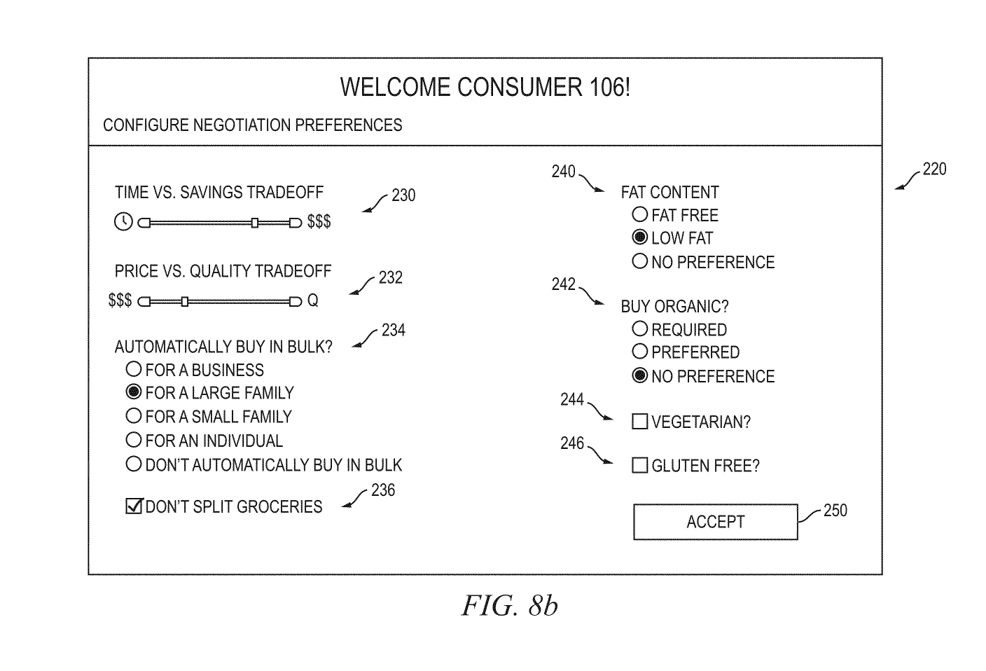

FIGS. 8a-8b illustrate screens displayed when consumer 106 browses to a webpage hosted by service provider 102 and connected to consumer agent 104 by an API to enter configuration data 120. Consumer 106 browses to retailer selection webpage 180 in FIG. 8a to select and rank retailers located near a place of residence of the consumer. Map 182 displays a bird's-eye view of the area around residence 183 of consumer 106, including retailers 46, 48, 50, and 116, which service provider 102 knows to be located in proximity of residence 183 based on information in central database 56. Clicking one of retailers 46, 48, 50, and 116 on map 182 with a mouse pointer triggers a small pop-up on the map with details of the particular retailer. Change address button 184 triggers a pop-up allowing consumer 106 to move the location of residence 183 on map 182. In other embodiments, consumer 106 moves residence 183 on map 182 by dragging and zooming the map and clicking on a new location for residence 183. GPS button 185 moves residence 183 to a location determined based on a GPS signal received by the device consumer 106 is using to access webpage 180. Retailer info button 186 triggers a large pop-up separate from map 182 with detailed information on visible retailers. Consumer 106 uses slider 196 to select how far away from residence 183 the consumer is willing to travel to a retailer. Retailer list 200 displays a list of retailers within proximity of residence 183, and allows consumer 106 to rate each retailer. The ratings are used to determine how likely consumer agent 104 is to select a product offer from particular retailers. Accept button 204 saves retailer preferences and returns to a main consumer dashboard of the website, or advances to another screen used to enter additional configuration 120 information.

Map 182 illustrates a portion of a map selected by consumer 106. Consumer 106 configures consumer agent 104 with a home address used as residence 183, and map 182 illustrates the geographical area near the home address. Consumer 106 may also enter an address other than a home address to shop at retailers in other locations. Map 182 illustrates city streets, buildings, businesses, and other geographic features near residence 183. Map 182 highlights known retailers that are within a configurable distance of residence 183. In some embodiments, map 182 is generated on webpage 180 using a third party service that includes an API for controlling the map display.

Consumer 106 clicks change address button 184 with a mouse pointer, or touches the button on a touchscreen, to move residence 183 on map 182. Consumer 106 may move residence 183 on map 182 because the consumer actually moved to a new neighborhood in real life and needs to begin shopping at stores in the new neighborhood. Consumer 106 may move residence 183 to a location other than the home address of the consumer in order to shop in an area other than where the consumer lives, for instance to go on a one-time shopping trip near work or a friend's house. Consumer 106 clicks or touches GPS button 185 to activate GPS detection and move residence 183 to wherever consumer 106 is on the globe when the consumer activates the GPS button. A GPS receiver in the device consumer 106 is using receives a GPS signal from one or more GPS satellites and uses the signals to calculate the consumer's position.

In some embodiments, consumer 106 configures consumer agent 104 to always select retailers nearby the consumer's current location. Consumer agent 104 monitors the location of consumer 106 utilizing an app on a mobile phone carried by the consumer. Consumer agent 104 can automatically renegotiate new offers from new retailers as needed when consumer 106 travels to new locations. In other embodiments, consumer agent 104 only automatically renegotiates offers at new retailers when consumer 106 indicates a desire to shop in a new area.

Shopping radius slider 196 allows consumer 106 to configure how far the consumer is willing to travel to shop at a retailer. In FIG. 8a, slider 196 is set to five miles, so only retailers within five miles of residence 183 are displayed on map 182 and listed on retailer list 200. When consumer 106 slides slider 196 using a mouse pointer or finger on a touchscreen, map 182 is zoomed accordingly. If slider 196 is adjusted to include retailers within ten miles of residence 183, map 182 is zoomed out so that at least 20 miles across is shown in each direction across the map. Additional retailers, which are located between five miles and ten miles away from residence 183, are added to the map.

Retailer list 200 contains a list of each retailer within the selected distance of residence 183. The retailers in retailer list 200, and displayed on map 182, are the set of retailers which consumer agent 104 will negotiate with during one-to-one negotiations 126. Each retailer in list 200 includes an associated set of radio buttons adjacent to the name of the retailer. The radio buttons of list 200 allow consumer 106 to rate each identified retailer on a scale from zero to five, although other scales are used in other embodiments. The radio buttons indicate to consumer agent 104 the relative value of shopping at different retailers for consumer 106. Consumer agent 104 uses the ratings during negotiations to determine whether to accept an offer from a particular retailer.

In FIG. 8a, consumer 106 has rated retailers 46 and 116 with a five out of five, the highest possible rating. Consumer agent 104 recognizes that consumer 106 likes retailers 46 and 116, and will prioritize offers from retailers 46 and 116 during one-to-one negotiations. Even if a slightly lower price on a product is available from retailer 48 or 50, consumer agent 104 may accept an offer from retailer 46 or 116 instead due to the consumer's expressed preference. Consumer 106 has rated retailer 48 as a three out of five, indicating to consumer agent 104 that the consumer does not like retailer 48, but is willing to shop there for a sufficient discount. Consumer 106 has rated retailer 50 with a zero, indicating to consumer agent 104 to avoid accepting any offer from retailer 50 no matter the discount.

Consumer 106 uses webpage 180 to enter part of configuration 120. Consumer 106 chooses a general location where shopping should occur, then ranks specific retailers in the vicinity. Consumer agent 104 uses the rankings by consumer 106 in selecting deals from the retailers during one-to-one negotiations. When consumer 106 moves residence 183, adjusts shopping radius 196, or changes the rankings of retailers in list 200, consumer agent 104 automatically renegotiates for products on shopping list 130 at the new set of retailers as necessary.

FIG. 8b illustrates webpage 220 used by consumer 106 to further enter configuration data 120. Webpage 220 allows configuration of preferences consumer agent 104 uses during one-to-one negotiation 126 with retailers and manufacturers. Slider 230 controls the tradeoff that consumer agent 104 makes between time and cost savings. Some deals being offered may save consumer 106 money, but increase shopping trip time due to requiring an additional stop as a part of the shopping trip. Some deals may require travel to a retailer further away to receive a cost savings. When consumer 106 moves slider 230 more toward the clock icon, i.e., more toward time savings, consumer agent 104 prioritizes the consumer's time. Consumer agent 104 attempts to reduce the number of stores consumer 106 must travel to, and tries to use retailers closer to residence 183. If consumer 106 adjusts slider 230 all the way toward time savings, consumer agent 104 makes every effort to create a shopping list with items at only one store which is as close to residence 183 as possible, even if more money could be saved otherwise. If consumer 106 adjusts slider 230 all the way toward money savings, consumer agent 104 takes the best discount or deal on all products, even if consumer 106 must travel to every retailer in town to receive the discounts. In one embodiment, slider 230 controls how large a discount must be before consumer agent 104 will extend the total trip time of a shopping trip.

Slider 232 controls the price versus quality tradeoff that consumer agent 104 makes when performing one-to-one negotiation 126 on behalf of consumer 106. Consumer 106 uses slider 232 to express a preference between higher quality products and cost savings. With slider 232 adjusted more toward a preference for lower price, consumer agent 104 is more likely to select generic or store brands for products consumer 106 intends to buy. With slider 232 adjusted toward a preference for higher quality products, consumer agent 104 prefers higher quality products to small cost savings.

Radio buttons of bulk setting 234 configure automatic buying in bulk for consumer agent 104. Consumer agent 104 uses bulk setting 234 to choose what size of certain products to select for consumer 106. As an example, consumer 106 expresses an intent to buy for “creamy peanut butter,” without indicating a unit size to purchase. If consumer 106 previously set bulk setting 234 to “for a large family,” consumer agent 104 decides to negotiate for a twin pack of forty ounce peanut butter containers. However, if consumer 106 indicate purchases are “for an individual,” consumer agent 104 negotiates for a single twelve ounce package of peanut butter. In one embodiment, bulk setting 234 is not used if consumer 106 expresses an intent to buy 122 for a specific quantity or size of a product. Consumer agent 104 buys the requested size or quantity without overriding the specific intent to buy 122 of consumer 106 based on bulk setting 234. Consumer agent 104 uses bulk setting 234 when consumer 106 expresses an intent to buy 122 without indicating a size or quantity.

Checkbox 236 allows consumer 106 to prevent consumer agent 104 from splitting up perishable grocery items among multiple retailers. When checkbox 236 is checked, consumer agent 104 only adds perishable items to shopping list 130 from a single retailer. The retailer used for perishable items on shopping list 130 may change if a second retailer offers a lower price on the basket of groceries as a whole, but the perishable items will remain listed for a single, although possibly different, retailer. Without checkbox 236 active, consumer agent 104 suggests a shopping trip to consumer 106 which involves buying perishable items at multiple retailers. Buying perishable items from multiple retailers is unsatisfactory to consumer 106 when, for instance, perishable items from a first retailer must sit outside in a hot car while the consumer enters a second retailer. When only a single retailer is used for perishable items, consumer 106 visits that retailer last so that perishable items are taken directly to residence 183 and refrigerated.

Fat content setting 240 includes radio buttons that allow consumer 106 to select a default fat content attribute for negotiated grocery products. For instance, consumer 106 enters an intent to buy 122 for ranch salad dressing. Consumer agent 104 automatically negotiates for and adds a fat free or low fat ranch salad dressing to shopping list 130 when consumer 106 previously selected “fat free” or “low fat,” respectively, using fat content setting 240. When consumer 106 specifies an intent to buy 122 including a product with a specific fat content, consumer agent 104 does not override the intent to buy.

Organic setting 242 includes radio buttons that allow consumer 106 to buy organic products by default. Consumer 106 can tell consumer agent 104 to always buy organic products when available for a specific intent to buy 122, or can tell consumer agent 104 that organic items are preferred as long as the price is not too high. Organic setting 242 gives consumer 106 the ability to buy organic products without specifying organic as an attribute with each intent to buy 122. Checkbox 244 allows consumer 106 to specify a global preference for vegetarian products. Checkbox 246 allows consumer 106 to specify a global preference for gluten free products.

Accept button 250 saves the current state of the settings on webpage 220 to consumer agent 104 as configuration 120 and returns the web browser used by consumer 106 to a home screen, a main dashboard, or a subsequent configuration screen. After saving configuration 120, consumer agent 104 commences negotiating on a one-to-one basis with retailers and manufacturers selling products for which consumer 106 expresses an intent to buy 122.

Retailer agent 114 and manufacturer agent 108 offer similar configuration webpages, but with purchasing options relevant to the particular member of commerce. Retailers and manufacturers set minimum inventory levels, maximum inventory levels, and other preferences related to how respective agents should make purchases. In addition, retailer agent 114 and manufacturer agent 108 operate as sales agents. Separate webpages are usable to enter configuration 120 for sales decisions being made by the sales agents.

Sales agents are configurable with maximum discounts for specific products. A global maximum discount percentage is also configurable. A sales agent can be configured to automatically consider the maximum discount for each product to be a certain value relative to the cost of that particular good to that particular member of commerce. That is, retailer agent 114 knows the wholesale cost of each product retailer 116 sells, and can automatically set the maximum discount offered to consumer 106 to be the cost of the product to the retailer, 1% above cost, or even below cost. A sales agent can be configured to have a blanket 1% profit margin maximum discount, while additionally authorizing greater discounts on specific products the retailer or manufacturer wants to promote.

Retailer agent 114 and manufacturer agent 108 are configurable with a profit share percentage. Service provider 102 earns a percentage of incremental profit for each sale accomplished through one-to-one negotiation 126. The incremental profit is the amount a consumer ultimately pays for a profit above the maximum authorized discount. A greater profit share percentage increases the chance that consumer agent 104 selects the product made by manufacturer 110. Retailer agent 114 and manufacturer agent 108 are configured with a maximum budget, and the sales agent only offers discounts to consumers up to that maximum amount each week or month.

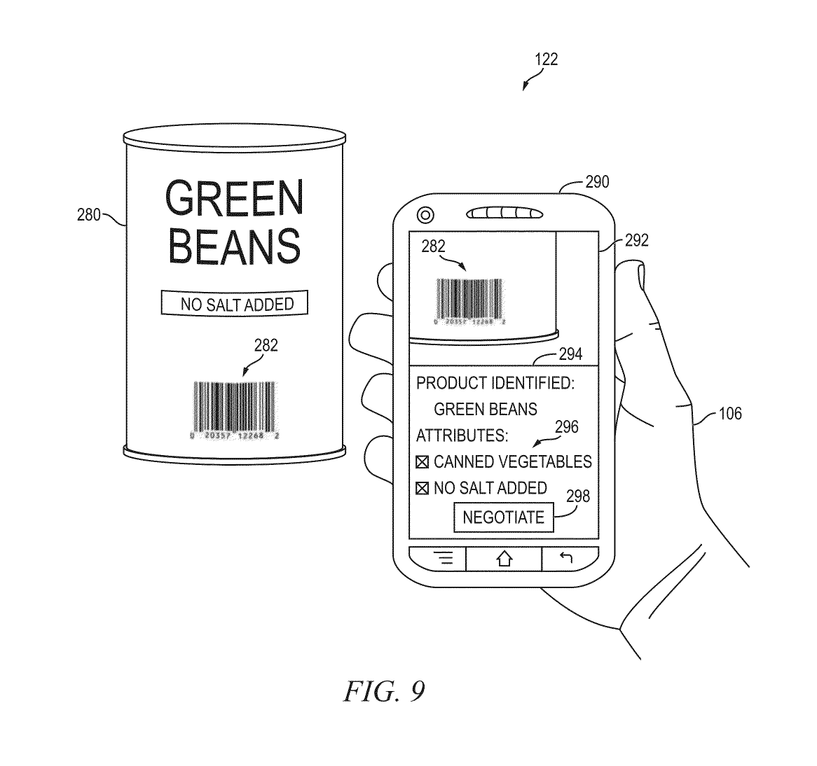

FIG. 9 illustrates one method of consumer 106 submitting intent to buy 122. Using a camera of mobile device 290, consumer 106 snaps a picture of product 280 using a phone app designed to submit intent to buy 122. Product 280 is a can of green beans with no salt added, but can also be any product consumer 106 would like to purchase. Product 280 includes Universal Product Code (UPC) 282 that identifies the product as a can of green beans with no salt added, including the brand of the manufacturer who made the product. Consumer 106 holds mobile device or cell phone 290, which includes a camera on the back of the cell phone. The image seen by the camera is shown on a viewfinder portion 292 of the screen. When the camera picks up a valid UPC, information output portion 294 of the screen displays the product and any attributes associated with the product. Information output portion 294 of the screen includes attribute list 296 and one-to-one negotiation activation button 298.

Consumer 106 uses a specific app on cell phone 290 designed to access consumer agent 104 via the API and enter intent to buy 122. Viewfinder 292 displays whatever image is captured by the camera of cell phone 290, with the display of the viewfinder changing as the phone is moved or objects in front of the camera move. Computer hardware and software within cell phone 290 analyze the image of viewfinder 292 every frame to determine if a product in the camera's view includes information regarding a product. In other embodiments, cell phone 290 does not analyze every frame, but rather a photo is sent to consumer agent 104 each time consumer 106 activates the capture of a photograph using a button on cell phone 290.

Consumer 106 uses cell phone 290 to submit intent to buy 122 in various situations. When consumer 106 is using the last can of green beans at home, the consumer scans a UPC of the last can of green beans to express an intent to buy 122 for more green beans. Consumer agent 104 receives the intent to buy 122, negotiates for green beans on a one-to-one basis with manufacturers and retailers, and adds a green bean product to a shopping list for consumer 106. In another instance, consumer 106 is at retailer 46 and picks up a desired product off a shelf. Consumer 106 scans the product so that consumer agent 104 performs one-to-one negotiation 126 with not only retailer 46, but also other approved retailers. Consumer agent 104 has the potential to negotiate a discount for the product at retailer 46, so consumer 106 receives a discount using one-to-one negotiation 126 while shopping in person at a retailer.

When consumer 106 points the camera of cell phone 290 at a recognized product, the app displays information about the product on information panel 294. In one embodiment, cell phone 290 sends the UPC code to service provider 102 via the API of consumer agent 104, and the service provider returns information about the product for display. In the case of product 280, information panel 294 identifies the product as green beans and shows attribute list 296 including “canned vegetables” and “no salt added.” Attribute list 296 allows consumer 106 to check or uncheck individual attributes by touching the attributes on the screen. An attribute of product 280 that is unchecked is not considered as limiting the scope of the intent to buy 122 for the product.

For instance, consumer 106 unchecks “no salt added” and clicks negotiate button 298. Consumer agent 104 realizes that while the scanned product included the attribute “no salt added,” the attribute is not important to consumer 106. The intent to buy 122 is for green beans more generally, and consumer agent 104 includes green beans both with and without salt in the scope of the intent to buy 122. Consumer 106 does not negotiate on the basis of the “no salt added” attribute, but negotiates for green beans with the attribute “canned vegetables.” Consumer 106 can also uncheck the “canned vegetables” attribute to have consumer agent 104 not only negotiate for canned green beans, but also include fresh green beans and frozen green beans.

After consumer 106 clicks negotiate button 298 to express an intent to buy 122 for no salt added canned green beans, consumer agent 104 negotiates for the product and places the winning deal on a shopping list 130.

In other embodiments, an app on cell phone 290 automatically uploads every picture taken to consumer agent 104 without the use of a special camera app that allows consumer 106 to explicitly express an intent to buy. If consumer 106 captures a photograph of product 280 using a camera phone, the picture of the green bean can is uploaded to consumer agent 104. Consumer agent 104 analyzes the picture for any products, and can identify the product by any branding used, text identifying the product, a valid UPC or QR code included in the picture, or through other visual clues as to the identity of the product.

Photographs taken by consumer 106 are automatically uploaded to consumer agent 104 for analysis. The camera can be the camera built into mobile device 290, or can be a standalone point-and-shoot camera with a data connection. Consumer 106 also uses an app made by service provider 102 to take photos and specify how the photo should be interpreted as intent to buy 122 data. A strong intent to buy 122 is understood when consumer 106 takes a photo of a product, or a UPC or QR code identifying a product, and expresses an interest in purchasing the product. Consumer agent 104 understands an intent to buy 122 for a product that consumer 106 takes a photo of without specifically expressing an intent to buy the product, but the strength of the intent is weaker. Consumer agent 104 can infer intent to buy 122 from the context of photos even when no product is specifically in frame. If consumer 106 takes a photo of a beach, consumer agent 104 realizes the context of the photo and understands an intent to buy 122 for products used on the beach. If consumer 106 takes a photo in snowy terrain, consumer agent 104 understands an intent to buy 122 for products used in snow.

In other embodiments, consumer 106 creates recipes using mobile device 290. Consumer 106 takes a photograph of a recipe, and the app running on mobile device 290, or consumer agent 104, recognizes the image as a recipe. Consumer agent 104 or mobile device 290 parses the image for the list of ingredients and amounts, and consumer 106 clicks or presses an add recipe to rotation button to have consumer agent 104 periodically buy the ingredients for the recipe. In another example, consumer 106 wants to create a recipe that is nothing more than a single product that can be warmed up in the microwave. Consumer 106 takes a photo of the product, a box of pizza pockets for example, and clicks a generate recipe button. Consumer agent 104 creates a recipe with the product so that the product can be purchased automatically as a cold lunch or microwave meal.

Consumer 106 can also use mobile device 290 to scan products that are purchased without the guidance of consumer agent 104. Consumer agent 104 tracks inventory of products purchased by consumer 106 and can recommend recipes that can be prepared given the ingredients available in the consumer's kitchen. One way for consumer agent 104 to gain the information of what is purchased by consumer 106 is for the consumer to manually scan in each item using mobile device 290. Consumer agent 104 also links with loyalty card programs of retailers, and receives information about each product purchased when the loyalty card is scanned at a checkout register of the retailer.

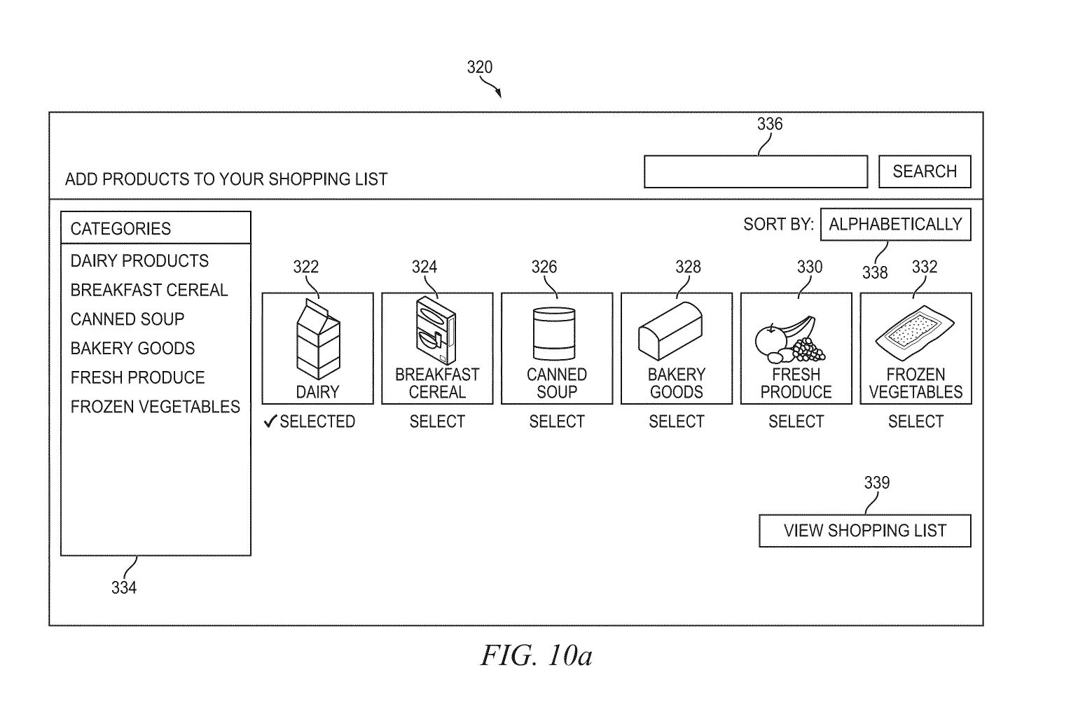

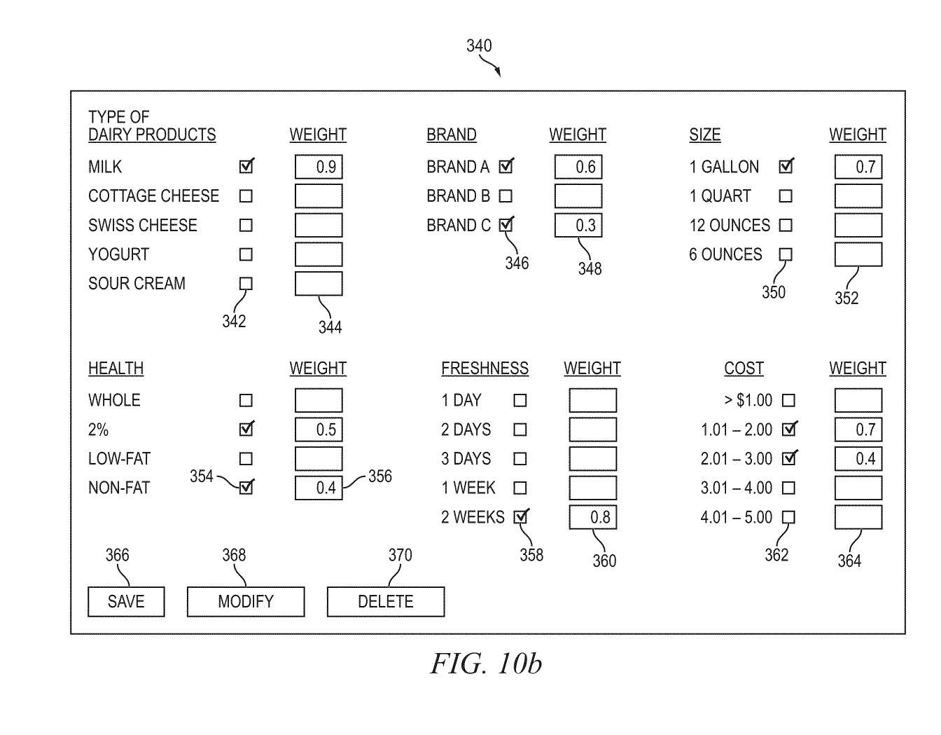

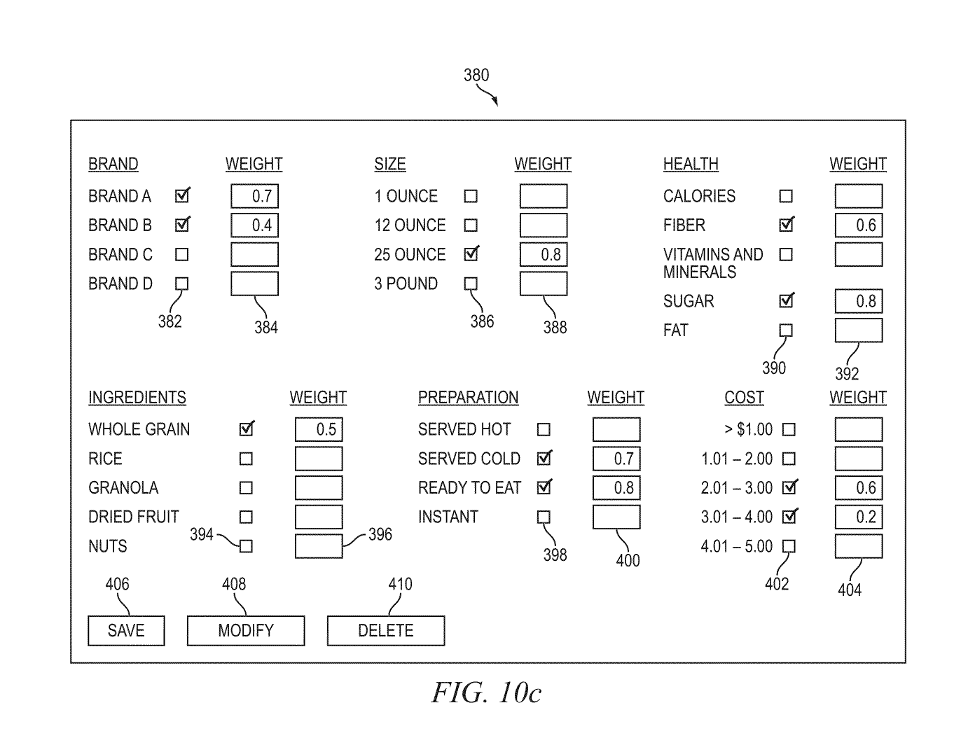

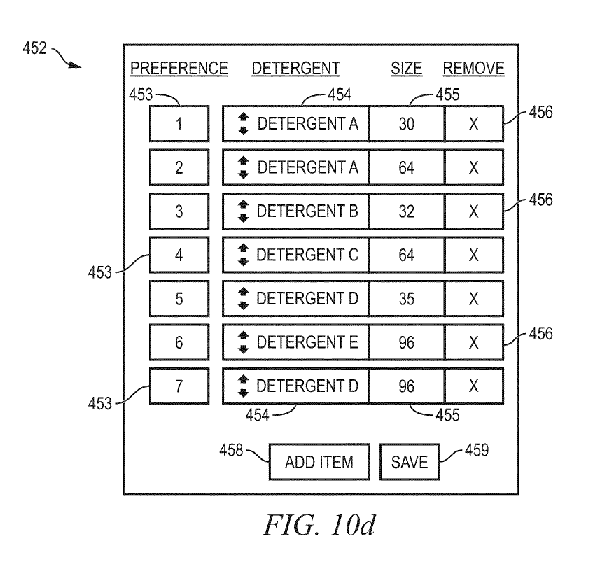

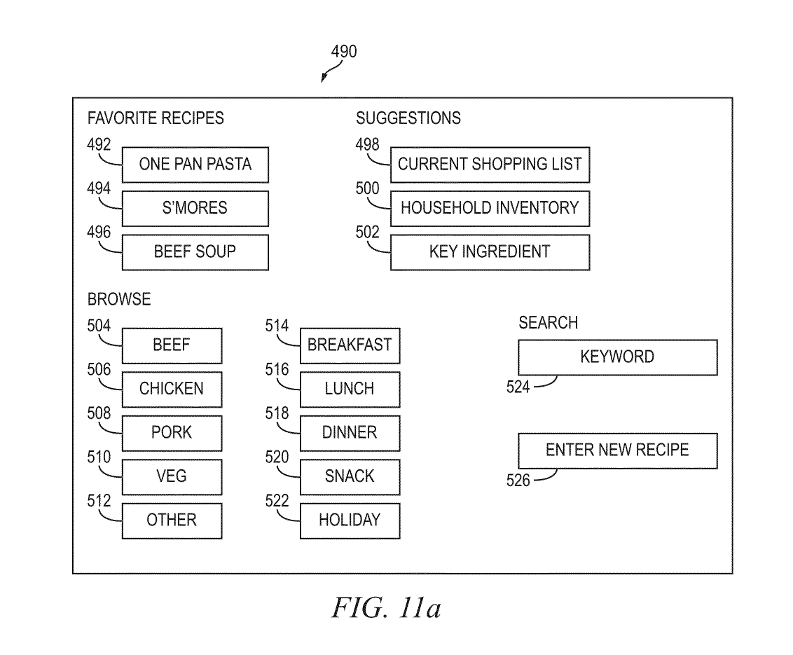

FIG. 10a shows webpage 320, usable by consumer 106 to enter intent to buy 122 for a specific product. Webpage 320 is also used to create a recipe based around a product. Consumer 106 finds a product on webpage 320, as described below, and then clicks a button to generate a recipe that simply includes the product, or adds the product to an existing recipe. For a breakfast meal, consumer 106 searches for cereal on webpage 320 and generates a new recipe including simply the selected cereal. Afterwards, consumer 106 searches for milk on webpage 320. Consumer 106 clicks to add milk to the existing cereal recipe webpage. Consumer agent 104 is thereafter able to select the recipe of milk and cereal as a breakfast recipe, and buy milk and cereal for consumer 106.

Webpage 320 is hosted on service provider 102 or a computer system controlled by retailer 116, manufacturer 110, or elsewhere, and connects to consumer agent 104 via an API. Webpage 320 presents categories of food items. A category is presented for each type of food item. For example, block 322 with corresponding select button is presented for dairy products, block 324 with corresponding select button is presented for breakfast cereal, block 326 with corresponding select button is presented for canned soup, block 328 with corresponding select button is presented for bakery goods, block 330 with corresponding select button is presented for fresh produce, and block 332 with corresponding select button is presented for frozen vegetables. A list of categories of food items is also presented in block 334. Block 336 with adjacent search button enables consumer 106 to search for other categories or specific food items. Block 338 enables consumer 106 to sort the categories of food by cost, frequency or recency of purchase, alphabetically, or other convenient ordering.

Consumer 106 clicks on the select button corresponding to a category of food item. In the present example, consumer 106 clicks the select button for block 322 to choose attributes and weighting factors or preference levels for dairy products. The available attributes for dairy products are presented in a pop-up window on webpage 320 or on a different webpage. FIG. 10b shows pop-up window 340 overlaying webpage 320 with attributes for type of dairy product, brand, size, health, freshness, and cost. Each attribute has an associated consumer-defined weighting factor for relative importance to consumer 106. For example, the attributes for type of dairy product include milk, cottage cheese, Swiss cheese, yogurt, and sour cream. Consumer 106 can select one or more attributes under the type of dairy product by clicking on one of checkboxes 342. A checkmark appears in the specific checkboxes 342 selected by consumer 106. Consumer 106 can enter a weighting value or indicator in a block 344 corresponding to the importance of any selected attribute. The weighting factor can be a numeric value, e.g., from 0.0 (lowest importance) to 1.0 (highest importance), “always”, “never”, or other designator meaningful to consumer 106. Alternatively, block 344 includes a sliding scale or other user interface element to select a relative value for the weighting factor. The sliding scale adjusts the preference level of the product attribute by moving a pointer along the length of the sliding scale. The computer interface can be color coded or otherwise highlighted to assist with assigning a preference level for the product attribute. In the present pop-up window 340, consumer 106 selects milk under type of dairy product and assigns a weighting factor of 0.9. Consumer 106 considers milk to be an important type of dairy product to be added to the shopping list.

In pop-up window 340, the attributes for brand include brand A, brand B, and brand C. A brand option is provided for each type of dairy product or for the selected type of dairy product. Consumer 106 can select one or more attributes under brand by clicking on one or more of checkboxes 346. A checkmark appears in the specific checkboxes 346 selected by consumer 106. Consumer 106 removes a checkmark by clicking a checkbox 346 that was previously selected. Consumer 106 enters a weighting value or indicator in block 348 corresponding to the importance of the selected attribute. The weighting factor can be a numeric value, e.g., 0.0-1.0. Alternatively, block 348 includes a sliding scale to select a relative value for the weighting factor. In the present pop-up window 340, consumer 106 selects brand A with a weighting factor of 0.6 and brand C with a weighting factor of 0.3 for the selected milk attribute. Consumer 106 considers either brand A or brand C to be acceptable, but brand A is preferred over brand C as indicated by the relative weighting factors. The weighting factors associated with different brands allows consumer 106 to assign preference levels to acceptable brand substitutes.

The attributes for size include 1 gallon, 1 quart, 12 ounces, and 6 ounces. A size option is provided for each type of dairy product or for the selected type of dairy product. Consumer 106 can select one or more attributes under size by clicking on one of checkboxes 350. A checkmark appears in the specific checkboxes 350 selected by consumer 106. Consumer 106 can enter a weighting value or indicator in block 352 corresponding to the importance of the selected attribute. The weighting factor can be a numeric value, e.g., 0.0-1.0. In the present pop-up window 340, consumer 106 selects “1 GALLON” with a weighting factor of 0.7 for the selected milk attribute. Consumer 106 indicates a desire to buy only one-gallon containers of milk. However, because the rating is only 0.7, consumer agent 104 adds other sizes of milk containers in some cases. For instance, consumer agent 104 adds two half-gallon containers of milk when half-gallon containers are on sale for less than half the price of a gallon of milk. If consumer 106 wants only one-gallon containers, rating the “1 GALLON” attribute as a 1.0 prioritizes the attribute at the highest possible level.

The attributes for health include whole, 2%, low fat, and non-fat. A health option is provided for each type of dairy product or for the selected type of dairy product. Consumer 106 can select one or more attributes under health by clicking on one or more of checkboxes 354. A checkmark appears in the specific checkboxes 354 selected by consumer 106. Consumer 106 can enter a weighting value or indicator in block 356 corresponding to the importance of the selected attribute. The weighting factor can be a numeric value, e.g., 0.0-1.0. In pop-up window 340, consumer 106 selects 2% with a weighting factor of 0.5 and non-fat with a weighting factor of 0.4 for the selected milk attribute. Consumer 106 considers either 2% milk or non-fat milk to be acceptable, but 2% milk is preferred over non-fat as indicated by the relative weighting factors. The weighting factors associated with different health attributes allow consumer 106 to assign preference levels to acceptable health attribute substitutes.

The attributes for freshness include one day old, two days old, three days old, one week from expiration, or two weeks from expiration. A freshness option is provided for each type of dairy product or for the selected type of dairy product. Consumer 106 can select one or more attributes under freshness by clicking on one or more of checkboxes 358. A checkmark appears in the specific checkboxes 358 selected by consumer 106. Consumer 106 can enter a weighting value or indicator in block 360 corresponding to the importance of the selected attribute. The weighting factor can be a numeric value, e.g., 0.0-1.0. In the present pop-up window 340, consumer 106 selects 2 weeks to expiration with a weighting factor of 0.8 for the selected milk attribute.

The attributes for cost include less than $1.00, $1.01-$2.00, $2.01-$3.00, $3.01-$4.00, or $4.01-$5.00. Consumer 106 can select one or more attributes under cost by clicking on one or more of checkboxes 362. A checkmark appears in the specific checkboxes 362 selected by consumer 106. Consumer 106 can enter a weighting value or indicator in block 364 corresponding to the importance of the selected attribute. The weighting factor can be a numeric value, e.g., 0.0-1.0. In the present pop-up window 340, consumer 106 selects $1.01-$2.00 with a weighting factor of 0.7 and $2.01-$3.00 with a weighting factor of 0.4 for the selected milk attribute. Consumer 106 is willing to pay either $1.01-$2.00 or $2.01-$3.00, but would prefer to pay $1.01-$2.00 as indicated by the relative weighting factors.

In one embodiment, consumer 106 creates custom ranges to rate separately for any of the attributes listed on pop-up window 340. For instance, consumer 106 desires 1% milk and adds a 1% option to the health attribute, or wants to rate cost in 50-cent increments instead of one-dollar increments. Once the consumer-defined attributes and weighting factors for milk are selected, consumer 106 clicks on accept button 366 to express an intent to buy 122 for the dairy product identified. Consumer agent 104 performs a one-to-one negotiation 126 and adds a corresponding product to shopping list 130.

Consumer 106 can add, delete, or modify additional types of dairy products, such as cottage cheese, Swiss cheese, yogurt, and sour cream, in a similar manner as described for milk in FIG. 10b. For each type of dairy product, consumer 106 selects one or more brand attributes and associated weighting factors, size attributes and weighting factors, health attributes and weighting factors, freshness attributes and weighting factors, and cost attributes and weighting factors. For each type of dairy product, consumer 106 clicks on accept button 366 to express an intent to buy 122 for the displayed configuration. Consumer 106 can also click on modify button 368 or delete button 370 to change or cancel a previously entered product configuration. If multiple dairy products can satisfy the same intent to buy, i.e., consumer 106 wants a dairy product that is either milk or yogurt, consumer 106 simply selects multiple types of dairy products on a single instance of pop-up window 340. If consumer 106 wants to express an intent to buy 122 for both milk and yogurt, the consumer visits pop-up window 340 two times, and each time selects one of the products.

Once the attributes and weighting factors for all dairy products have been entered for which consumer 106 wishes to make an intent to buy 122, consumer 106 returns to webpage 320 in FIG. 10a to select the next product category. In the present example, consumer 106 clicks the select button for block 324 to choose attributes and weighting factors for breakfast cereal. The available attributes for breakfast cereal products are presented in a pop-up window on webpage 320 or on a different webpage. FIG. 10c shows pop-up window 380 overlaying webpage 320 with attributes for brand, size, health, ingredients, preparation, and cost. Each attribute has an associated consumer-defined weighting factor for relative importance to consumer 106. For example, the attributes for brand include brand A, brand B, brand C, and brand D. Consumer 106 can select one or more attributes under brand by clicking on one or more of checkboxes 382. A checkmark appears in the specific checkboxes 382 selected by consumer 106.

Consumer 106 can enter a weighting value or indicator in block 384 corresponding to the importance of the selected attribute. The weighting factor can be a numeric value, e.g., from 0.0 (lowest importance) to 1.0 (highest importance), “always”, “never”, or other designator meaningful to consumer 106. Alternatively, block 384 includes a sliding scale to select a relative value for the weighting factor. The sliding scale adjusts the preference level of the product attribute by moving a pointer along the length of the sliding scale. The computer interface can be color coded or otherwise highlighted to assist with assigning a preference level for the product attribute. In the present pop-up window 380, consumer 106 selects brand A with a weighting factor of 0.7 and brand B with a weighting factor of 0.4 for the selected brand attribute. Consumer 106 considers either brand A or brand B to be acceptable, but brand A is preferred over brand B as indicated by the relative weighting factors. The weighting factors associated with different brands allow consumer 106 to assign preference levels to acceptable brand substitutes.

The attributes for size include 1 ounce, 12 ounce, 25 ounce, and 3 pound. Consumer 106 can select one or more attributes under size by clicking on one or more of checkboxes 386. A checkmark appears in the specific checkboxes 386 selected by consumer 106. Consumer 106 can enter a weighting value or indicator in block 388 corresponding to the importance of the selected attribute. The weighting factor can be a numeric value, e.g., 0.0-1.0. In the present pop-up window 380, consumer 106 selects 25-ounce size with a weighting factor of 0.8.

The attributes for health include calories, fiber, vitamins and minerals, sugar content, and fat content. Health attributes can be given in numeric ranges. Consumer 106 can select one or more attributes under health by clicking on one of checkboxes 390. A checkmark appears in the specific checkboxes 390 selected by consumer 106. Consumer 106 can enter a weighting value or indicator in block 392 corresponding to the importance of the selected attribute. The weighting factor can be a numeric value, e.g., 0.0-1.0. In the present pop-up window 380, consumer 106 selects fiber with a weighting factor of 0.6 and sugar content with a weighting factor of 0.8. Consumer 106 considers fiber and sugar content with numeric ranges to be important nutritional attributes according to the relative weighting factors.

The attributes for ingredients include whole grain, rice, granola, dried fruit, and nuts. Consumer 106 can select one or more attributes under ingredients by clicking on one or more of checkboxes 394. A checkmark appears in the specific checkboxes 394 selected by consumer 106. Consumer 106 can enter a weighting value or indicator in block 396 corresponding to the importance of the selected attribute. The weighting factor can be a numeric value, e.g., 0.0-1.0. In the present pop-up window 380, consumer 106 selects whole grain with a weighting factor of 0.5.

The attributes for preparation include served hot, served cold, ready-to-eat, and instant. Consumer 106 can select one or more attributes under preparation by clicking on one or more of checkboxes 398. A checkmark appears in specific checkboxes 398 selected by consumer 106. Consumer 106 can enter a weighting value or indicator in block 400 corresponding to the importance of the selected attribute. The weighting factor can be a numeric value, e.g., 0.0-1.0. In the present pop-up window 380, consumer 106 selects served cold with a weighting factor of 0.7 and ready-to-eat with a weighting factor of 0.8.

The attributes for cost include less than $1.00, $1.01-$2.00, $2.01-$3.00, $3.01-$4.00, or $4.01-$5.00. Consumer 106 can select one or more attributes under cost by clicking on one or more of checkboxes 402. A checkmark appears in the specific checkboxes 402 selected by consumer 106. Consumer 106 can enter a weighting value or indicator in block 404 corresponding to the importance of the selected attribute. The weighting factor can be a numeric value, e.g., 0.0-1.0. In the present pop-up window 380, consumer 106 selects $2.01-$3.00 with a weighting factor of 0.6 and $3.01-$4.00 with a weighting factor of 0.2. Consumer 106 is willing to pay either $2.01-$3.00 or $3.01-$4.00, but would prefer to pay $2.01-$3.00 as indicated by the relative weighting factors.

Once the consumer-defined attributes and weighting factors for breakfast cereal are selected, consumer 106 clicks on accept button 406 to express an intent to buy 122 for cereal having the selected attributes. The consumer-defined attributes and weighting factors for breakfast cereal can be modified with modify button 408 or deleted with delete button 410 in pop-up window 380.

Consumer 106 can add, delete, or modify other breakfast cereals in a similar manner as shown in FIG. 10c. For instance, consumer 106 visits pop-up window 380 to express an intent to buy 122 for a high-fiber cereal for herself, and returns to pop-up window 380 to add a separate intent to buy for a sugary cereal for her children. For each breakfast cereal, consumer 106 selects one or more brand attributes and associated weighting factors, size attributes and weighting factors, health attributes and weighting factors, ingredients attributes and weighting factors, preparation attributes and weighting factors, and cost attributes and weighting factors. For each breakfast cereal, consumer 106 clicks on accept button 406 to express an intent to buy 122 for that particular cereal. Consumer 106 can also click on modify button 408 or delete button 410 to change or cancel a previously entered product configuration.

Consumer 106 makes selections of attributes and weighting factors for canned soup in block 326, bakery goods in block 328, fresh produce in block 330, and frozen vegetables in block 332, as well as other food categories, in a similar manner as shown in FIGS. 10b and 10c. The food categories can also be selected from block 334 in FIG. 10a. The consumer-defined product attributes and weighting factors for each food category are stored in central database 56 as a part of a history stored for consumer 106.

Intent to buy 122 is also expressed using a consideration set 452, as illustrated in FIG. 10d. A consideration set includes products under consideration for purchase that are substitutes for each other within a product or product type, and rankings for the products. A consideration set could be set up manually by a member of commerce for each product potentially being purchased. In a new consideration set, before determining product rankings, all products in the consideration set have the same default ranking. Intelligent personal agents 54 use consideration sets to determine purchasing priorities of members of commerce during one-to-one negotiation 126. For example, in FIG. 10d consumer 106 identifies seven detergent products that the consumer would consider purchasing. Consumer 106 arranges the list in order of preference, with the most desirable product ranked or listed first. The seven detergent products that consumer 106 is considering for purchase form a consideration set comprising the detergent products that consumer 106 would consider purchasing. In other embodiments, items in a consideration set are ranked by consumer 106 defining a rating for each item.

A consideration set can be created based on consumer input. For example, consumer 106 can submit a list of products for service provider 102 to consider as alternatives fulfilling a certain need or want. Alternatively, a consideration set is formed by selecting desired products or removing products that are not under consideration from a list of possible products. For example, consumer 106 is presented with a list of twenty-six detergent products including detergent brands A through Z. Consumer agent 104 generates the default consideration set based on a search for a product performed by consumer 106, or based on an input of weighted attributes by the consumer through the process of FIGS. 10a-10c. Consumer 106 selects detergent brands A-E as the consideration set of detergent products the consumer would consider purchasing. Detergent brands F-Z are omitted from the consideration set. When consumer agent 104 determines which detergent product to place on a shopping list 130 for consumer 106, the consumer agent limits the products under consideration to detergent products A-E. In one embodiment, service provider 102 offers a one-to-one marketing feature to retailers and manufacturers. A manufacturer can target specific consumers with value messages in an attempt to get consumers to add the manufacturer's product to a consideration set. Manufacturer 110 sets up a consideration set for specific products that the manufacturer finds acceptable to fulfill a more general intent to buy 122.

Consideration sets can also be created using product attributes submitted as part of configuration 120. For example, consumer 106 indicates that he will only purchase organic food products. Consumer agent 104 only considers organic food products for placement on a shopping list for consumer 106 when the consumer indicates an intent to purchase a food product. Consideration sets can also be determined from T-LOG data of consumer 106 or similar consumers. For example, T-LOG data indicates that consumer 106 has purchased detergent products A-E in the past. Consumer agent 104 includes detergents A-E in the consideration set for consumer 106 when the consumer is seeking to purchase a laundry detergent. Consumer agent 104 saves consideration sets for future use when consumer 106 desires or needs a product and indicates an intent to purchase a product from the consideration set. Items on a consideration set are alternatives that can replace each other on a shopping list when consumer agent 104 determines one of the products fulfills the desires of consumer 106 better than another product.

In FIG. 10d, consumer 106 uses a pop-up on the website of service provider 102 to create a consideration set 452 consisting of laundry detergent products the consumer is willing to consider. Consumer 106 lists the 96-load size of detergent brand D as the least desirable detergent that consumer 106 is willing to consider. Consumer 106 lists the 96-load size of detergent brand E as sixth most preferable option, and the 35-load size of detergent brand D as the fifth most preferable option. Consumer 106 lists the 64-load size of detergent brand C as the fourth most preferable option, the 32-load size of detergent brand B as third most preferable option, and the 64-load size of detergent brand A as the second most preferable option. Finally, consumer 106 lists the 30-load size of detergent brand A as the most preferable option.

Consideration set 452 consists of ranked preference column 453, brand column 454, product size column 455, and remove product column 456. The webpage displaying consideration set 452 includes an add item button 458 and save button 459. Ranked preference column 453 illustrates to consumer 106 the order of products. Ranked preference column 453 generally stays static due to consideration set 452 being ordered by preference rank. In some embodiments, consumer 106 sorts consideration set 452 by other factors, and ranked preference column 453 is displayed out of order. Brand column 454 displays the brands of products being considered. Up and down arrows within the individual brand fields of brand column 454 are clickable by consumer 106 to move specific rows up or down relative to the rest of consideration set 452. Consumer 106 also drags individual rows with a mouse pointer or a finger on a touchscreen to rearrange the rows within consideration set 452.

Product size column 455 is used to display the size attribute of each detergent product under consideration. Size is used because consumer 106 decided to differentiate the detergent products based on size. Consumer 106 can add columns for other attributes of detergent, e.g., high efficiency, and rank products based on other attributes in addition to or instead of size. When products other than detergents are ranked as a consideration set, other attributes applicable to the products being ranked are used instead of number of loads. Remove product column 456 includes a button on each row that removes the particular product from consideration set 452 when clicked by consumer 106. Add items button 458 opens a separate screen or pop-up allowing consumer 106 to search or browse for other items that consumer agent 104 should consider as alternatives in consideration set 452. When consumer 106 clicks or touches save button 459, consumer agent 104 saves consideration set 452 in central database 56 for use during one-to-one negotiations for the product.

Consideration sets are the products considered by consumer agent 104 when consumer 106 expresses an immediate intent to buy 122 for a product. Service provider 102 allows one-to-one marketing in addition to one-to-one negotiation. A particular retailer can run a marketing campaign to attempt to get the retailer's products onto more consumers' consideration sets. A print ad may have a value statement and a QR code which, when scanned by a cell phone of consumer 106, adds a particular item to a consideration set of the consumer. An online web ad includes a button to add an item to a consideration set.

Consumer agent 104 maintains consideration sets for different classes or types of products, e.g., detergents, deodorants, salad dressing, sandwich meat, or any other product consumer 106 purchases. When consumer 106 expresses an intent to buy 122 for a product fitting within an established consideration set, consumer agent 104 uses the related consideration set as the set of specific products to negotiate for. In one embodiment, consumer 106 adds a specific product to a shopping list, then instructs consumer agent 104 to generate a consideration set to begin with. Consumer agent 104 generates a consideration set of products similar to the specific product that other consumers have indicated are substitutes. Consumer agent 104 also bases the beginning consideration set on previous preferences expressed by consumer 106. Consumer 106 then uses a screen similar to FIG. 10d to modify and save the generated consideration set.

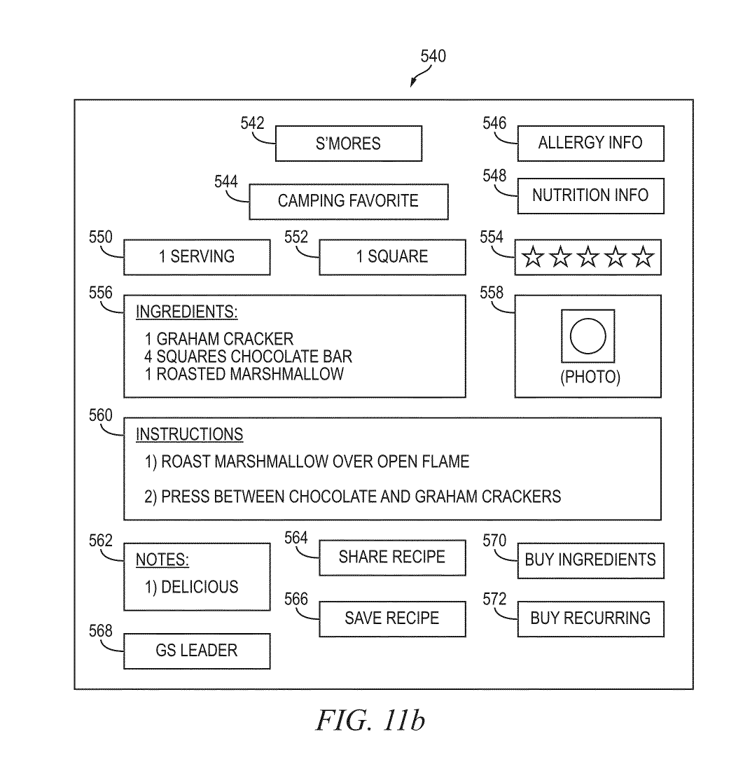

Other websites, not owned and operated by service provider 102, include elements usable by consumer 106 to enter an explicit intent to buy 122. A shopping website may have a button or widget connected to consumer agent 104 via an API that consumer 106 clicks to explicitly express a desire to purchase a displayed product. Consumer agent 104 adds the product to a shopping list 130 or automatically purchases the product. A button on a recipe website connects to the consumer agent 104 API to add each product necessary to make a viewed recipe to a shopping list 130. FIGS. 11a-11b illustrate a recipe website connected to consumer agent 104 through an API.

FIG. 11a illustrates a sample recipe webpage 490, usable to enter an intent to buy 122 related to a recipe consumer 106 is interested in preparing. Webpage 490 is hosted on service provider 102. In other embodiments, a third party hosts webpage 490, and widgets or plugins are used to interface with service provider 102 and consumer agent 104 via an API. Webpage 490 allows consumer 106 to easily browse recipes previously entered by others, and share recipes for other consumers to use. Consumer 106 searches for or browses to recipes and expresses an intent to buy 122 for each ingredient needed to make the recipe in one process step. In some embodiments, consumer agent 104 also understands an intent to buy 122 for equipment necessary to make a recipe, e.g., a specific sized pan, when the consumer agent has information that the consumer does not own the specific equipment required to prepare the recipe.

Recipes are contributed to central database 56, or another database used for webpage 490, by consumer 106 and other consumers, professional chefs, home cooks, retailers, manufacturers, distributors, staff of service provider 102, or other sources. Webpage 490 displays recipes 492-496 as favorites that consumer 106 previously marked as a favorite, or that consumer agent 104 knows the consumer has previously prepared regularly. Consumer agent 104 accesses the recipes in central database 56 to search for and suggest recipes 498-502 of interest to consumer 106 based on criteria specified by the consumer and the recipe information stored in the central database. Consumer agent 104 also suggests recipes 498-502 based on past buying or eating habits of consumer 106. Once a recipe, e.g., recipes 492-502, is entered into the recipe database, consumer agent 104 allows the recipe to be easily shared online by generating a uniform resource locator (URL) link, saving as an offline document, through QR codes pointing to the recipe, and in the form of an automatically generated email message. For example, consumer 106 wants to share or prepare recipe 494 for S'mores. Consumer 106 logs into webpage 490, or otherwise logs into consumer agent 104 with a widget or plugin in communication between the recipe webpage and the consumer agent.

Category buttons 504-522 include text indicating various categories of recipes contained in central database 56. Consumer 106 clicks, touches, or otherwise activates a button 504-522 to view or browse recipes associated with the selected category on a separate webpage or on a pop-up overlaid on webpage 490. Search box 524 allows consumer 106 to enter keywords and search for recipes that include the entered keyword. For example, consumer 106 can enter the name of an ingredient to view recipes that include the ingredient, or the consumer can enter a specific dish to determine whether any recipes for the dish are contained in central database 56. Consumer 106 adds a new recipe to the recipe database by selecting new recipe button 526 on recipe webpage 490. Selecting new recipe button 526 opens an individual recipe webpage, similar to webpage 540 in FIG. 11b, but without prefilled recipe information. Consumer 106 fills in the webpage like a form to input a new recipe to central database 56.

Consumer 106 clicks one of recipes 492-502, browses to a recipe using buttons 504-522, or searches for a recipe using search box 524, to bring up an individual recipe webpage 540. FIG. 11b shows an example of individual recipe webpage 540 after consumer 106 clicks S'mores button 494. Individual recipe webpage 540 contains title block 542, brief description block 544, allergy information block 546, nutritional information block 548, number of servings block 550, serving size block 552, rating block 554, ingredient list block 556, photograph block 558, cooking instructions block 560, notes block 562, share recipe button 564, save recipe button 566, contributor block 568, buy ingredients button 570, and buy recurring button 572.

Title block 542 displays the title entered for the recipe. Consumer 106 clicked the recipe button for S'mores, so title block 542 reads “S'mores.” Brief description block 544 contains a short snippet of text to describe the recipe that is displayed in search results along with the title to give additional context. Allergy information block contains a list of allergens contained in the recipe's ingredients, e.g., gluten, dairy, or peanuts. Nutritional information block 548 contains health information for the recipe, e.g., calories per serving or fat content. Number of servings block 550 displays the recommended number of people consumer 106 can serve by making the recipe as presented. Serving size block 552 displays the recommended serving size each person would eat to serve the number of people listed in number of servings block 550. Rating block 554 allows consumer 106 to submit a rating for the recipe on a scale from one to five stars. Ratings are accumulated among all consumers by service provider 102 so that other consumers can see which recipes are rated highly by users and which are rated poorly.

Ingredient list 556 lists each ingredient and the amount required to make the recipe. Ingredient list 556 may also list any specific equipment needed to make the recipe, such as a griddle, a certain size of cake pan, or a certain mixer attachment. In one embodiment, each ingredient listed is a hyperlink that can be clicked or touched by consumer 106 to express an intent to buy 122 for that individual ingredient. Photo block 558 displays previously entered photographs uploaded by other consumers who made the recipe, and also allows consumer 106 to upload a photograph after making the recipe. Cooking instruction block 560 displays a list of process steps required to make the recipe. Notes block 562 allows consumer 106 to enter notes about the recipe, e.g., a reminder that a specific step took longer than the recommended amount of time. A note entered in block 562 can be stored in consumer agent 104 for future reference only by consumer 106, or can be stored in central database 56 and viewed by anyone who subsequently views the same recipe.

Share recipe button 564 enables a pop-up over webpage 540 allowing for automatic sharing of the recipe over social media sites, email, via QR code, or via other methods. Save recipe button 566 allows consumer 106 to bookmark the recipe. Bookmarked recipes are pinned to webpage 490 for easy retrieval by consumer 106 in the future. Contributor block 568 displays the username of the individual who entered the recipe. In some embodiments, contributor block 568 is a hyperlink allowing consumer 106 to view other recipes from the same contributor. Buy ingredients button 570 allows consumer 106 to express an intent to buy 122 for each ingredient required for the recipe with a single click. When consumer 106 clicks or touches buy ingredients button 570, consumer agent 104 recognizes the intent to buy all ingredients, negotiates for each ingredient, and adds the winning offer for each ingredient to shopping list 130. In some embodiments where webpage 490 is hosted by a third party unrelated to service provider 102, buy ingredients button 570 is generated by a web browser plugin installed by consumer 106. The web browser plugin recognizes webpage 540 as a recipe website, detects the ingredients listed on the current page, and inserts a buy ingredients button on the webpage linked to consumer agent 104.

Buy recurring button 572 adds the opened recipe to the rotation of recipes that consumer agent 104 automatically buys on a recurring basis. A new webpage or popup opens where consumer 106 can rate and categorize the recipe to add the recipe to a consideration set of recipes. Consumer 106 uses webpage 540 to add existing recipes to a rotation, or to create or import new recipes that the consumer would like to prepare periodically. Webpage 540 also allows modification of existing recipes to make tweaks or add notes and pictures.

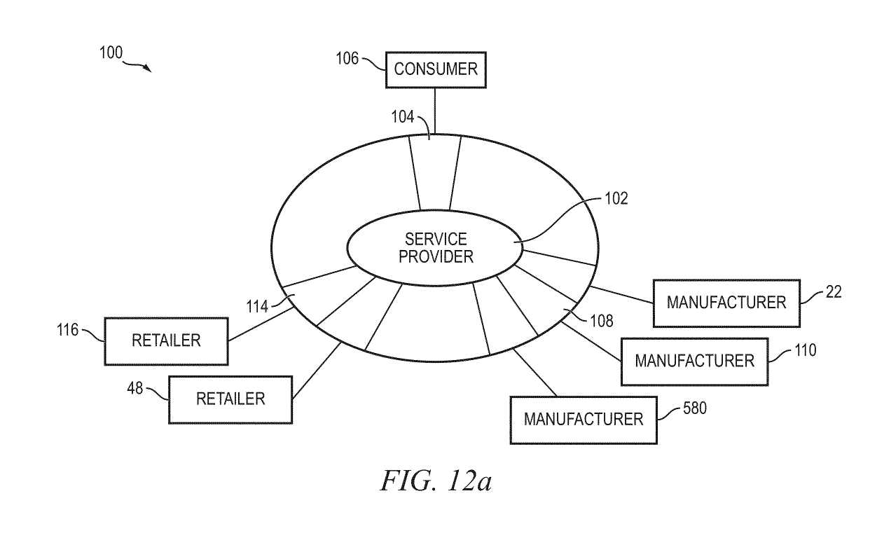

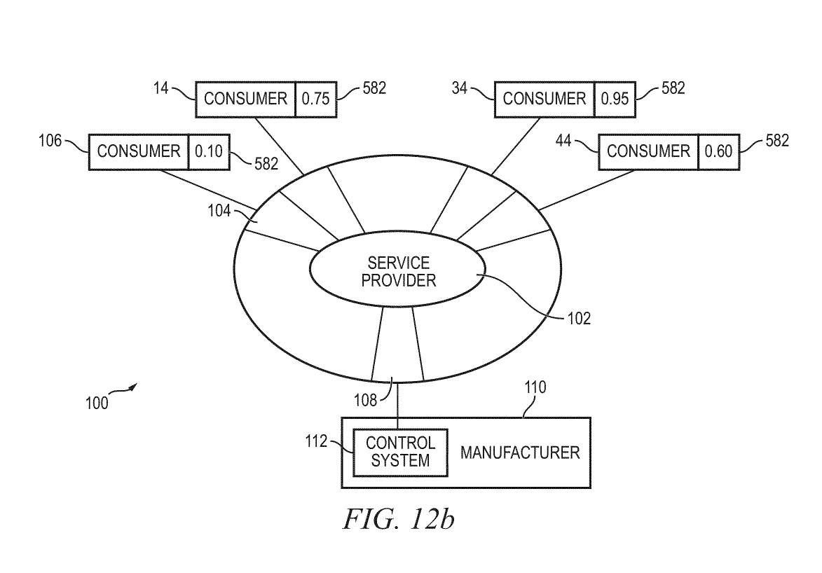

FIG. 12a illustrates one-to-one negotiation 126 occurring between consumer 106, retailers 116 and 48, and manufacturers 22, 110, and 580 using service provider 102 as a virtual marketplace. Consumer 106 connects to service provider 102 through consumer agent 104. Manufacturer 110 connects to service provider 102 via manufacturer agent 108. Retailer 116 connects to service provider 102 via retailer agent 114. Retailer 48 and manufacturers 22 and 580 also connect to service provider 102 via respective intelligent personal agents.

When consumer 106 expresses an intent to buy 122, service provider 102 acts as a virtual marketplace by connecting consumer agent 104 to agents for retailers that sell the object of the intent to buy and manufacturers who make the product. Service provider 102 further acts as a virtual marketplace by allowing retailers and manufacturers to compete against each other for placement on shopping list 130 of consumer 106. Generally, each identified retailer competes against other retailers for consumer 106 to purchase the item at that particular retailer, and each manufacturer competes against other manufacturers for consumer 106 to buy the specific product brand produced by the particular manufacturer. The intent to buy 122 expressed by consumer 106 is a forward-looking demand signal at the one-to-one level, i.e., intent to buy 122 allows service provider 102 to understand the forward-looking purchasing decision intents of individual consumers.

In FIG. 12a, consumer 106 has expressed an intent to buy 122 for, e.g., product 280, which is canned green beans with no salt added. Service provider 102 identifies that retailers 116 and 48 are the only two retailers in proximity of consumer 106 that sell canned green beans. In one embodiment, retailer 50 also sells canned green beans, but is not included in one-to-one negotiation 126 by service provider 102 because consumer 106 has rated retailer 50 with a zero on webpage 180 of FIG. 8a. Service provider 102 further identifies manufacturers 22, 110, and 580 as the only manufacturers selling canned green beans at retailers 116 and 48.

Retailers and manufacturers have visibility to certain preferences of consumer 106, as well as certain information on competing manufacturers and retailers. In one embodiment, manufacturer agent 108 understands that consumer 106 prefers green beans produced by manufacturer 110, and does not offer a discount during one-to-one negotiation 126. In another case, manufacturer agent 108 for manufacturer 110 understands that the intelligent personal agent for manufacturer 22 has a winning offer, and consumer agent 104 communicates to losing manufacturer agents what price or discount could switch the consumer agent to putting that particular manufacturer's product on shopping list 130. Intelligent personal agents that are currently losing decide whether to offer the discount required to add that manufacturer's product to shopping list 130 based on preferences and strategy considerations previously entered by the manufacturer. In one embodiment, intelligent personal agents for retailers and manufacturers have visibility into all current discounts on the table, and are able to figure out what offer is needed to become the winning offer.

Retailers and manufacturers have visibility to a shopping history of consumer 106 to aid in negotiation strategy. The intelligent personal agent for retailer 48 realizes consumer 106 prefers retailer 116, and that a more aggressive discount is required to switch items on shopping list 130 from retailer 116 to retailer 48. In one embodiment, retailers and manufacturers have visibility to items already on shopping list 130. Retailer 48 has the ability to offer a larger discount on a group of products if consumer agent 104 will switch the entire basket of products to retailer 48. The visibility that retailer agents and manufacturer agents have into the activity of consumers and competing agents allows implementation of advanced negotiation strategies. In one embodiment, control systems of manufacturers and retailers have access to all the data of respective intelligent personal agents via an API, and the negotiation strategy is implemented on the control system. Service provider 102 notifies the intelligent personal agents of retailers and manufacturers when a new intent to buy 122 is available for negotiation, and the intelligent personal agents communicate the intent to buy to respective control systems of the retailers and manufacturers. Control systems use the information available through the intelligent personal agent API to determine an initial offer to make, as well as to change negotiation strategy to win negotiations that are going to other retailers or manufacturers. Consumer agent 104 places a product satisfying intent to buy 122, from the winning manufacturer and at the winning retailer, on shopping list 130.

Negotiations are one-to-one because retailers and manufacturers negotiate with consumers on a one-to-one basis. Manufacturers and retailers offer deals to consumers that are tailored specifically for the individual consumer. Manufacturers and retailers have visibility to see purchase history and other background on individual consumers. Intelligent personal agents for individual manufacturers and retailers negotiate with intelligent personal agents for individual consumers. Consumer agents negotiate on a one-to-one basis with retailers and manufacturers. Individual consumer agents negotiate separately with multiple retailers and manufacturers on an individual basis and accept the best deal. Manufacturers and retailers are added to the negotiation by service provider 102 individually based on the preferences of consumer 106.

FIG. 12b illustrates one embodiment of one-to-one negotiation from the viewpoint of manufacturer 110. Four different consumers, namely consumers 14, 34, 44, and 106, have expressed an intent to buy 122 for a certain product produced by manufacturer 110. Each consumer expresses an intent to buy 122 via a respective intelligent personal agent using an app or website connected to the agent through an API. Once a consumer expresses an intent to buy 122 for a product made by manufacturer 110, service provider 102 goes to work connecting the consumers to manufacturer 110 for one-to-one negotiation between agents representing each consumer and the manufacturer. The four consumers may express an intent to buy 122 at approximately the same time, or manufacturer agent 108 may perform the negotiations spread out in time from each other.

Manufacturer agent 108 determines how much of a discount would need to be given to each consumer in order to sway the consumer to purchase the product made by manufacturer 110. In one embodiment, illustrated in FIG. 12b, each consumer is assigned a rating 582 corresponding to a percentage of a maximum possible discount that needs to be given for manufacturer 110 to be selected over other manufacturers in a consumer's consideration set. A lower score means less of a discount is given, and a higher score means a larger discount should be given. A 0.00 score indicates that a consumer is all but guaranteed to buy the manufacturer 110 product, even if other manufacturers offer competitive discounts. A score of greater than 1.00 indicates that a consumer is unlikely to select the product made by manufacturer 110 even at the maximum discount. In some embodiments, manufacturer 110 configures manufacturer agent 108 to offer products at a loss, or even free, to certain consumers as a part of the marketing plan of the manufacturer.

In some embodiments, the rating 582 takes into account the value to manufacturer 110 if a consumer were to buy the product from manufacturer 110. For instance, consumers who show high brand loyalty may be rated higher overall because if the consumer switches to the manufacturer 110 product, the consumer will likely stick with manufacturer 110. Consumers who tend to buy additional products with a higher profit margin may get rated higher by retailers because of the prospect of additional value from additional purchases. A higher rating to potentially more profitable consumers gives a higher discount on a particular product to those consumers.

Manufacturer agent 108 generates a rating 582 for a consumer whenever the particular consumer expresses an intent to buy 122 for a product that the manufacturer can satisfy. The ratings 582 are based on configuration 120 set by the consumer related to the particular product, historical data related to the consumer's buying preferences, competitor pricing, and other data available to manufacturer agent 108 by reading central database 56. Manufacturer 110 configures how the different factors considered in determining rating 582 are used by logging into a web interface or app connected to manufacturer agent 108 through an API. In some embodiments, control system 112 interfaces with manufacturer agent 108 to automatically adjust weighting of the factors, increase the maximum discount, increase the total budget allocated for discounts, or otherwise reconfigure negotiations performed by manufacturer agent 108.

In other embodiments, manufacturer agent 108 does not generate ratings, but instead merely communicates an intent to buy 122 to control system 112 using an API of the control system. Control system 112 has access to all the data that manufacturer agent 108 takes into account when negotiating a price with a consumer by reading data using the API of the manufacturer agent. Manufacturer 110 performs all the work of negotiation by programming control system 112 to utilize the available data any way the manufacturer wishes to generate an offer to a consumer. Control system 112 generates a price, communicates the offer to manufacturer agent 108 in response to the intent to buy 122, and the manufacturer agent uses the offer to try to get the manufacturer's particular product on the shopping list of the particular consumer. In some embodiments, manufacturer agent 108 communicates the result of the offer back to control system 112, and the control system has an opportunity to make another offer if prudent.

In FIG. 12b, consumer 106 has been rated a 0.10, indicating that only a small discount needs to be given on a product satisfying intent to buy 122. Consumer 106 is already likely to select the product made by manufacturer 110. Manufacturer agent 108 knows consumer 106 is likely to buy the manufacturer 110 product because manufacturer agent 108 has access to purchase history showing that consumer 106 has selected the product made by manufacturer 110 in the past. However, perhaps in response to competing manufacturers running a sale, and not believing the loyalty of consumer 106 to manufacturer 110 is one hundred percent, manufacturer agent 108 offers a small discount to make sure the product from manufacturer 110 is selected. Thus, consumer 106 is rated at 0.10 and not 0.00.

Consumer 14 has been rated a 0.75. Manufacturer agent 108 has determined that consumer 14 will require a larger discount than consumer 106 in order to switch to the product from manufacturer 110. Consumer 14 has been loyal to a competitor's product, but has been commonly persuaded to try new brands by discounts in the past. Manufacturer agent 108 determines that 75% of the maximum discount will persuade consumer 14 to try the product made by manufacturer 110.

Consumer 34 is more loyal to a competing manufacturer's product, and is rated as a 0.95. Consumer 34 will be difficult to persuade to switch to the manufacturer 110 product and is given nearly the largest authorized discount. On the other hand, consumer 44 is only rated as a 0.60. Consumer 44 was previously as loyal to a competitor's product as consumer 34, and rated a 0.95 as well. However, on the last shopping trip, the 0.95 discount was successful in persuading the consumer agent for consumer 44 to select the manufacturer 110 product for consumer 44. Consumer 44 expressed satisfaction in the decision to try the manufacturer 110 product, so manufacturer 110 backs off the discount to 0.60, to keep consumer 44 with manufacturer 110 while ratcheting up the profit margin for the manufacturer. In other embodiments, other factors are used in determining consumer ratings, or discounts are directly calculated without a separate rating system for consumer intent to buy 122.

Manufacturer agent 108 continues one-to-one negotiation 126 with each consumer as individual consumers express an intent to buy 122 for one of the manufacturer's products. The goal of manufacturer agent 108 is to determine the smallest discount that will result in the consumer agent for the particular consumer selecting the manufacturer's product for inclusion on a shopping list 130. Retailer agents go through a similar process in attempting to get consumers to shop at the particular retailer's locations. The virtual marketplace provided by service provider 102 enables machine-to-machine commerce. That is, decisions during negotiations are computerized, and made by intelligent personal agents.

The one-to-one negotiations performed by manufacturer agent 108, configured by manufacturer 110 and control system 112, allow manufacturer 110 to control the commerce system like never before. Manufacturer 110 moves more products from the factories and warehouses of the manufacturer to shelves of retailers and into consumers' homes by allowing manufacturer agent 108 to perform one-to-one negotiation with retailers and consumers. Likewise, one-to-one negotiations performed by retailer agent 114 significantly increase the control retailer 116 has over the commerce system. Retailer 116 utilizes one-to-one negotiations provided by retailer agent 114 to increase the amount of products moving from store shelves to consumers' homes and pantries. Sales agents for retailers and manufacturers automatically entice consumers to make positive purchasing decisions. Revenue and profit for manufacturers and retailers rise accordingly. The decision process is computerized, meaning one-to-one negotiation occurs between computerized agents, and purchasing decisions are made by computerized agents. Only with the virtual marketplace provided by service provider 102 are retailers and manufacturers able to negotiate with every consumer on an individualized basis.

Purchasing decisions for consumer 106 are transferred to personal shopping agent 104. As consumer 106 uses consumer agent 104 to make more and more decisions, the consumer gains trust in the consumer agent. Eventually, consumer 106 fully trusts consumer agent 104 and no longer feels the need to override the consumer agent's suggestions. When consumer 106 fully trusts consumer agent 104, the consumer agent purchases products for the consumer without verification. Products available online are automatically purchased and shipped, and consumer 106 merely follows a shopping plan from consumer agent 104 periodically to purchase items not available from online retailers. Consumer 106 simply expresses an intent to buy 122 in any one of a myriad of ways, and consumer agent 104 controls the flow of goods from manufacturer 110 and retailer 116 to the doorstep of consumer 106. Service provider 102, through intelligent personal agents, ultimately controls what goods traverse the commerce system, where the goods come from, and where the goods go.

Movement of goods through commerce system 100 is a direct result of one-to-one negotiation made possible by service provider 102 being a virtual marketplace connecting consumer agent 104, manufacturer agent 108, and retailer agent 114. An intent to buy 122, expressed by consumer 106 to consumer agent 104 either explicitly or inferentially, triggers one-to-one negotiation and machine-to-machine commerce among the members of commerce system 100. Intent to buy 122 leads to one-to-one negotiation 126, which in turn leads to savings for consumer 106 and additional products moved through the commerce system for manufacturer 110 and retailer 116. Goods move between members of the commerce system that would not have without service provider 102. Service provider 102 influences purchases and causes goods to go to or come from different members of commerce than would otherwise occur. Consumer 106 benefits by satisfying needs and wants with optimal products at optimal prices, and with reduced decision stress. Retailer 116 and manufacturer 110 benefit by increasing revenue. Retailers and manufacturers increase revenue with service provider 102 by selling more goods to consumers, and by targeting deals to the consumers that will be swayed to make a positive purchasing decision based on the deal.

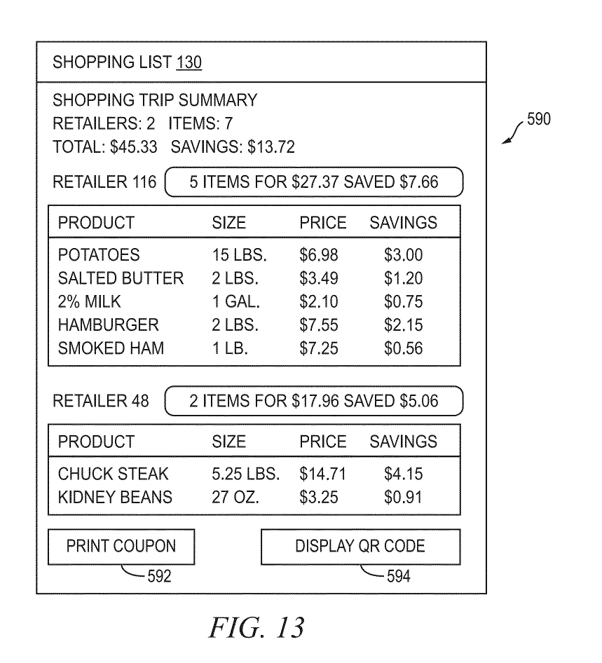

FIG. 13 illustrates consumer 106 viewing shopping list 130 after consumer agent 104 has selected a few recipes for the consumer to prepare. In other use cases, consumer 106 manually selects recipes to prepare, or the consumer manually selects individual products, to add to shopping list 130. Consumer agent 104 adds any items to shopping list 130 that the consumer agent was unable to order online within the parameters set in configuration 120. Shopping list 130 is displayed on webpage or mobile app screen 590. Shopping list 130 is organized into a shopping trip with five items to buy at retailer 116 and two items to buy at retailer 48. Webpage 590 displays various facts and statistics about shopping list 130 related to the savings consumer agent 104 has attained for consumer 106. Consumer 106 performs the shopping trip at any time the consumer considers shopping list 130 complete. Consumer 106 can also perform the shopping trip when one of the products is needed immediately. In one embodiment, consumer 106 goes shopping at any time that is convenient for the consumer. Consumer agent 104 customizes the shopping list based on the amount of food currently in inventory at the residence of consumer 106. If consumer agent 104 is configured to provide meals for one week out, but consumer 106 still has food for 3 days remaining at home, consumer agent 104 creates a shopping list 130 to provide for 4 additional days of meals. Consumer 106 takes the shopping trip as shopping list 130 is illustrated in FIG. 13, or continues adding to the shopping list by expressing further intent to buy 122 for other recipes or specific products.

Consumer 106 uses any of a number of methods to redeem the discounts achieved by consumer agent 104 during one-to-one negotiation 126. Consumer 106 links loyalty cards issued by retailers the consumer uses to consumer agent 104. When deals are negotiated, service provider 102 allows consumer agent 104 to populate the deals into the control systems of retailers so that discounts are automatically available to consumer 106 when the consumer scans a loyalty card at checkout. In some embodiments, consumer 106 uses print coupon button 592 to print out specific manufacturer and retailer coupons required to attain the negotiated deals. In other embodiments, display QR code button 594 is used to display a QR code referencing the shopping list and negotiated discounts. Consumer 106 has a checker at retailer 116 or retailer 48 scan the QR code at checkout to receive discounts negotiated for a retailer. An app on a mobile phone can also communicate negotiated deals via near-field communication. Retailers are able to communicate with their respective intelligent personal agents via an API to verify the deals consumer 106 is attempting to redeem are validly negotiated deals.

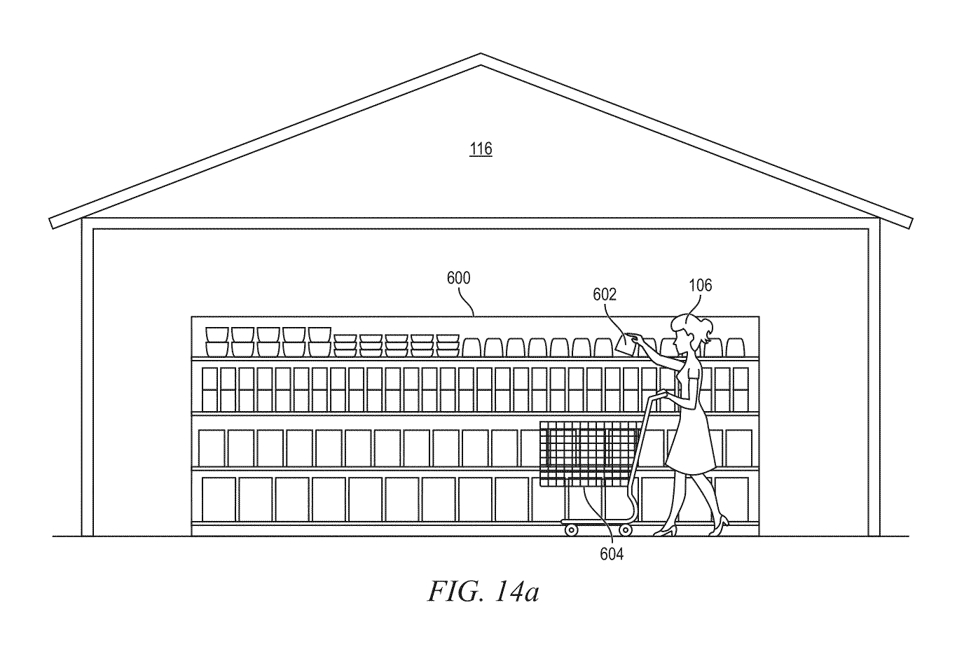

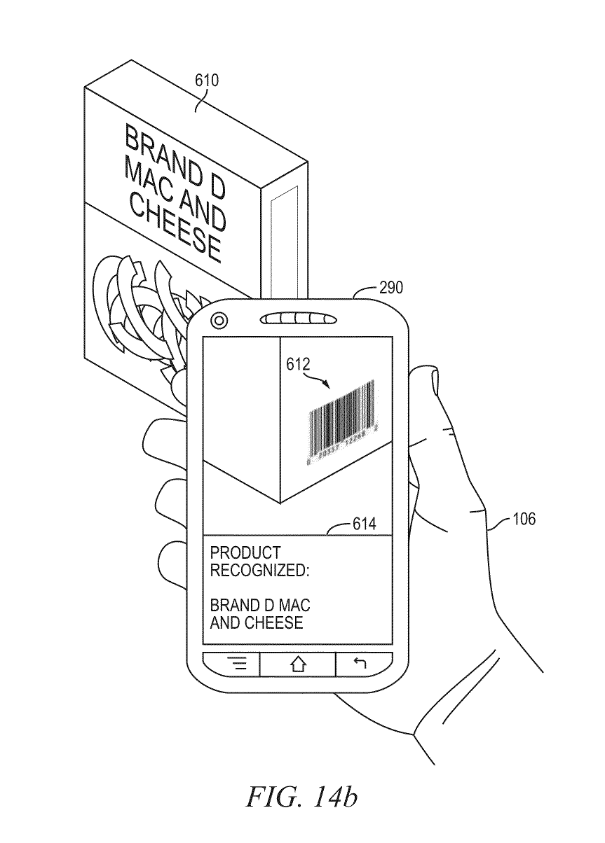

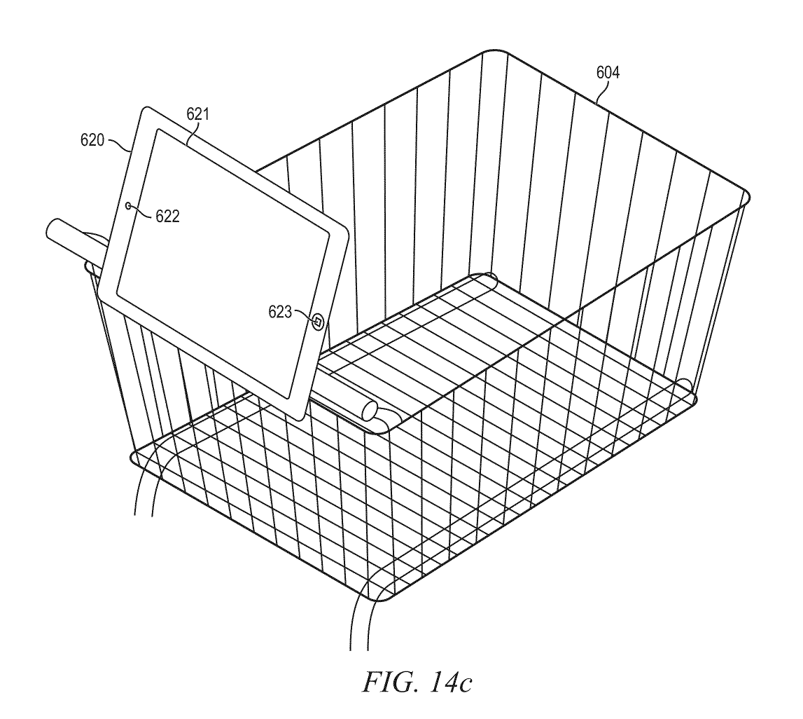

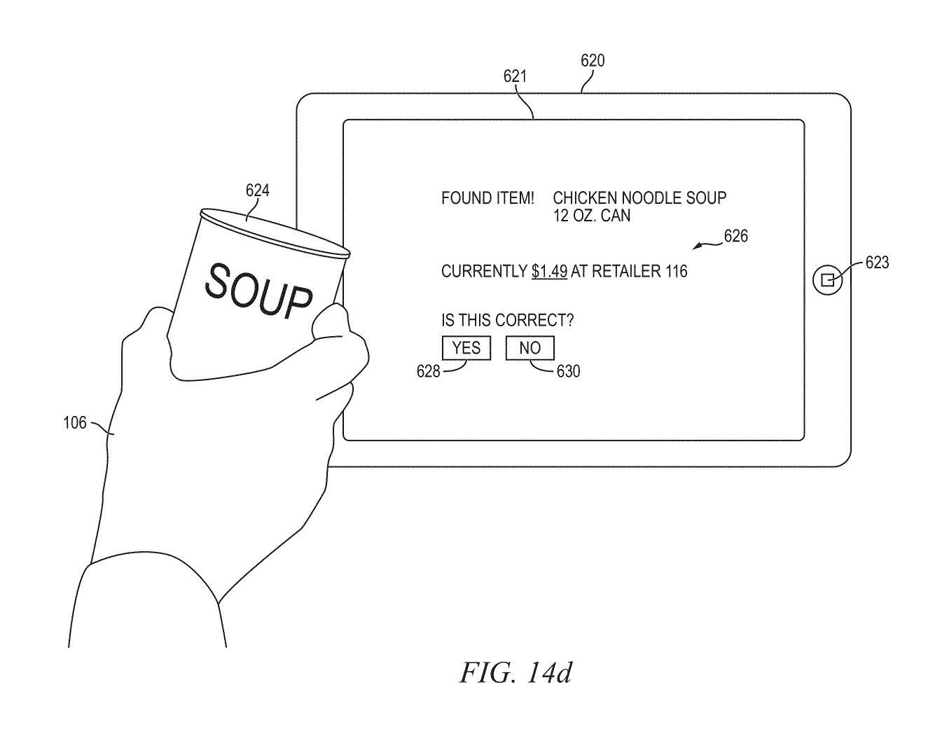

FIG. 14a illustrates consumer 106 picking up a product from a shelving unit 600 while shopping at retailer 116. Consumer 106 follows GPS instructions from mobile device 290, or merely goes to where the item is located based on personal knowledge. Retailer 116 includes retail shelving unit 600 which further includes product 602 on the retail shelving unit. Product 602 is an item on shopping list 130. Consumer 106 selects product 602 because consumer agent 104 negotiated a discount on product 602 in response to an intent to buy 122 submitted by the consumer. Product 602 is required for a recipe that consumer agent 104 selected for consumer 106, or was otherwise indicated as a desired product by the consumer. In one embodiment, consumer 106 submitted an intent to buy 122 for green beans 280, but consumer agent 104 negotiated a better deal on another manufacturer's green beans 602. Consumer 106 sees green beans 602 on shopping list 130 and selects green beans 602 off shelving unit 600. Consumer 106 places green beans 602 in shopping cart 604 and continues down shopping list 130. In another embodiment, consumer agent 104 selected a recipe that requires green beans, and the consumer agent determined that green beans 602 from retailer 116 was the best value for consumer 106.

In some cases, consumer 106 selects product 602 from shelving unit 600 even though product 602 is not on shopping list 130, and product 602 was never indicated as a desired product by consumer 106 to consumer agent 104. Consumer 106 walks down the shopping aisle adjacent to shelving unit 600 and serendipitously sees and develops a desire to purchase product 602. Consumer 106 may recall a favorite recipe that the consumer has not prepared lately and that requires product 602. Product 602 may be a snack that consumer 106 sees and instantly develops a craving for. Whatever the reason, consumer 106 selects product 602 from retail shelving unit 600 and picks up the product.

Consumer 106 sees a price tag for product 602 on shelving unit 600, but is unaware of the price for product 602 in other sets of circumstances or conditions. Consumer agent 104 is able to analyze the conditions and circumstances that presently exist when consumer 106 is at retailer 116, and compare with other potential sets of circumstances. If an alternative set of circumstances exists for purchasing product 602 that creates an overall better deal for consumer 106, consumer agent 104 notifies consumer 106 that deferring the purchase of product 602 until the second set of circumstances can be realized is in the best interest of the consumer.

Consumer 106 interfaces with consumer agent 104 using a smartphone, tablet, smart watch, or other electronic device connected to service provider 102 via an electronic network. FIG. 14b illustrates an embodiment in which consumer 106 utilizes cell phone 290 to optically scan UPC 612 of product 610 in order to indicate to consumer agent 104 that the product was selected for purchase from a shelf at retailer 116. UPC 612 includes data embedded in a barcode, generally a series of numbers identifying product 610. Consumer 106 scans each product as the individual product is selected from a shelving unit and placed into shopping cart 604. Consumer 106 scans product 610 in FIG. 14b whether the product is being purchased off shopping list 130, or being purchased serendipitously. Consumer agent 104 receives the data embedded in UPC 612 and displays information about any scanned product on information portion 614 on the screen of mobile device 290. Consumer 106 may scroll to view additional information, give feedback to consumer agent 104 about the accuracy of information, and confirm the decision to purchase or not purchase the product.

If product 610 is not on shopping list 130, no one-to-one deal has previously been negotiated. Consumer agent 104 works in the background to negotiate with retailer 116, other retailers, and the manufacturer of Brand D, to attain a one-to-one negotiated deal, as illustrated above in FIGS. 12a-12b. If product 610 is on shopping list 130, consumer agent 104 checks UPC 612 against the correct UPC for the product on shopping list 130 to ensure that consumer 106 purchases the necessary product for any negotiated offers. In either case, consumer agent 104 displays product name, expected price, and other information for verification by consumer 106. Consumer agent 104 may also ask consumer 106 other questions for crowdsourcing of information, such as location of the product within retailer 116.

Finally, whether product 610 is on shopping list 130 or not, consumer agent 104 analyzes all the circumstances of the purchase of product 610 to determine whether alternative circumstances exist that provide a better overall deal. Consumer agent 104 generally operates with the directive of looking for ways for consumer 106 to reduce the price of product 610. If consumer agent 104 determines that consumer 106 can save money by purchasing product 610 under a second set of circumstances instead of a first set of presently existing circumstances, consumer 106 is given the option to defer the purchase of product 610 until the second set of circumstances can be achieved. The second set of circumstances may include purchasing product 610 at a different retailer, buying a alternative brand of a similar product, waiting until a pending sale for product 610 begins, buying another size of the same product, or any other different circumstance that effects the value of the exchange for consumer 106.

FIG. 14c illustrates a tablet computer 620 that can be used as an alternative to cell phone 290. Tablet computer 620 is similar to cell phone 290, and has similar features and functionality. Tablet computer 620 includes a wireless connection to service provider 102 via cell phone service towers, Wi-Fi routers, Bluetooth devices, or otherwise. Tablet 620 includes a larger screen 621 than cell phone 290, which improves functionality and ease of use when interacting with consumer agent 104. Camera 622 is used by software on tablet 620 to optically scan UPCs and other visual features to determine a product consumer 106 holds in front of tablet 620. Home button 623 triggers the software running on tablet 620 to return to a home screen.

Tablet 620 is mounted onto a handle of shopping cart 604 for easy access by consumer 106 while shopping. In other embodiments, tablet 620 is mounted on shopping cart 604 in other configurations, or carried with consumer 106 without mounting. Consumer 106 brings tablet 620 to retailer 116 and uses a tablet case with a mounting bracket to attach the table in the most convenient configuration. For each product consumer 106 takes off a shelf for purchase, the consumer positions the product in front of camera 622 briefly prior to placing the product in shopping cart 604. The software running on tablet 620 and interacting with consumer agent 104 analyzes a stream of images received from camera 622, and identifies the product consumer 106 has selected for purchase.

In one embodiment, the display of screen 621 is disabled until consumer 106 scans a product using camera 622. Leaving screen 621 disabled conserves battery power of the tablet. When consumer 106 holds a product in front of camera 622, which remains active, screen 621 is turned on by the tablet 620 software to display information about the product. In other embodiments, screen 621 remains on throughout the shopping trip. Prior to consumer 106 scanning a product with camera 622, screen 621 displays pertinent information such as a list of the items in shopping cart 604, items remaining on shopping list 130, or GPS directions to the next item on the shopping list within retailer 116.

FIG. 14d illustrates consumer 106 scanning product 624, a can of soup, using tablet 620. Consumer 106 holds soup 624 in front of camera 622 such that a UPC of the soup is visible to the camera. Consumer agent 104 recognizes product 624 as a twelve ounce can of chicken noodle soup. Consumer agent 104 displays the expected price of the soup at retailer 116, along with any other pertinent information, at message 626. To help improve the information in central database 56, consumer 106 can participate in crowdsourcing of data by answering prompts given by consumer agent 104. Consumer 106 presses “yes” button 628 to confirm that the displayed price is correct, or presses “no” button 630 to indicate that the price is wrong. In the case where information displayed by consumer agent 104 is incorrect, additional prompts are displayed which inquire as to the correct information. If “no” button 630 is pressed, consumer agent 104 prompts consumer 106 to enter the correct price for soup 624. Consumer agent 104 asks consumer 106 to confirm other information in other embodiments, such as the specific location of product 624 within the premises of retailer 116 or whether retailer 116 also carries specific competing products. Consumer agent 104 also displays the scanned UPC code along with other product information so that consumer 106 can verify whether the consumer agent interpreted the UPC correctly if the wrong product is displayed.

In other embodiments, other methods are used by consumer 106 to communicate product selections to consumer agent 104. In one embodiment, consumer 106 uses a portable laser-based barcode scanner that is connected to tablet 620 or cell phone 290 via a USB cable, Bluetooth, or other means. In the case where cell phone 290 is used, the cell phone is able to remain in a pocket or purse of consumer 106 until a product is scanned and consumer agent 104 is able to find a better set of alternative circumstances for the consumer. Consumer agent 104 communicates the existence of alternative circumstances to software running on cell phone 290, and a notification is generated to notify consumer 106. Cell phone 290 emanates a sound, vibrates, or both to notify consumer 106 of the option to defer a product purchase until a more advantageous set of circumstances can be attained. Only after being notified that better circumstances exist for purchasing a scanned product does consumer 106 need to access cell phone 290. In other embodiments, consumer 106 is given the option to defer all products scanned, even when better conditions cannot be predetermined by consumer agent 104. The product is put onto a defer list, and consumer agent 104 monitors conditions over time and notifies consumer 106 if better conditions become available.

In another embodiment, cell phone 290 or tablet computer 620 scan products selected by consumer 106 using Bluetooth beacons, radio-frequency identification (RFID) tags, or other electronic components disposed on products or on shelf price tags.

After receiving a positive identification for a product that consumer 106 has selected from a shelf of retailer 116, consumer agent 104 goes to work analyzing the present circumstances for the purchase as well as any potential alternative circumstances. Consumer agent 104 compares the present circumstances to available alternative circumstances to determine anything consumer 106 may be able to do differently to improve the overall deal. If consumer 106 can attain a better deal on a scanned product by deferring the purchase, consumer agent 104 creates a software notification on cell phone 290 or tablet 620 allowing the consumer to choose whether to defer until the second, more advantageous, circumstances can be attained.

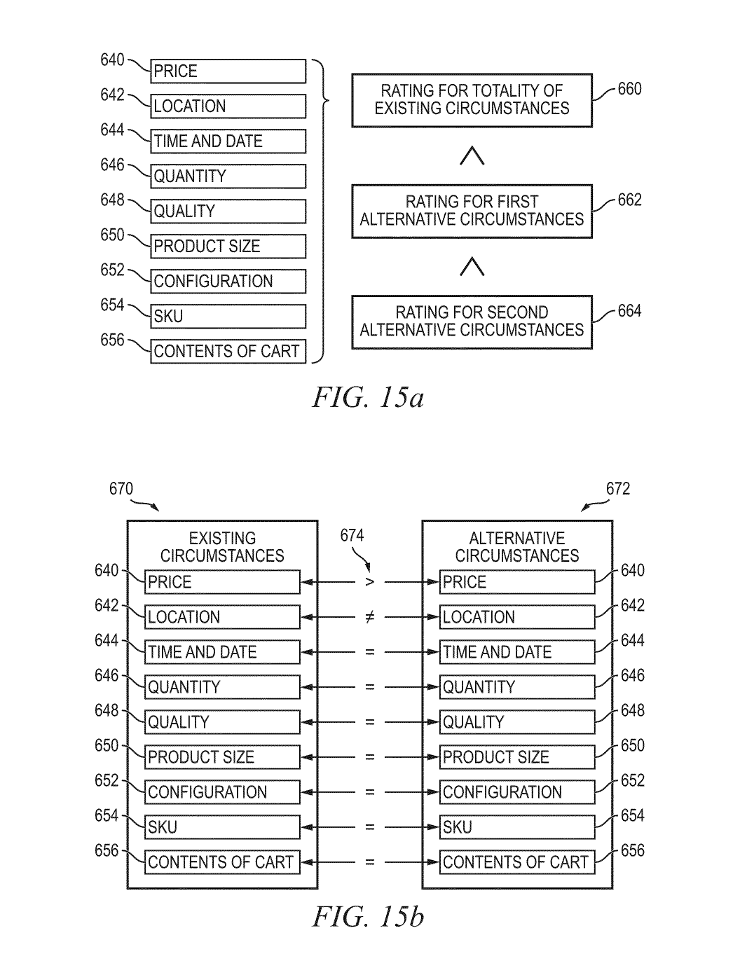

FIG. 15a illustrates a first paradigm used by consumer agent 104 to compare present circumstances to alternative circumstances. The circumstances compared include price 640, location 642, time and date 644, purchase quantity 646, product quality 648, product unit size 650, product configuration 652, stock keeping unit (SKU) 654, and contents 656 already in shopping cart 604. Consumer agent 104 generates a rating for each of the presently existing circumstances 640-656, and uses a formula to generate an overall rating 660 for the presently existing circumstances. Consumer agent 104 finds potential alternative circumstances and uses the same formula to calculate ratings 662 and 664 for the alternative circumstances. In FIG. 15a, rating 664 for the second alternative circumstances and rating 662 for the first alternative circumstances are both higher ratings than rating 660 for the presently existing circumstances.

Price 640 can refer to absolute price or price per unit size of a product. Price 640 reflects any price that consumer agent 104 can help consumer 106 achieve. Club card prices, sale prices, one-to-one negotiated prices, personalized offers, and other offers, are all reflected in price 640 for a given set of circumstances. In most cases, consumer 106 wants consumer agent 104 to find the cheapest price for products, so price may be weighted heavier in calculating ratings 660-664. In some embodiments, the price for a given set of circumstances is used as the rating rather than generating a rating using a formula.

Location 642 indicates the location a product is being purchased at. Location 642 can be different because a different retailer is shopped at, or because a different location of the same retailer is shopped at. Location 642 is an important circumstance because different retailers likely charge different prices for many products. Changing location 642 alone will not likely have a direct impact on a rating 660-664 unless consumer 106 specifically prefers or dislikes certain retailers. However, changing location 642 may have a large impact based on the other circumstances 640-656 that change due to the different location.

Time and date 644 is the current calendar day and time of day. Usually the highest rated date and time is the present time because consumer 106 is already at the store. However, a less convenient time for consumer 106 may still create an overall better set of conditions for the consumer if the price will be lower sometime in the future. In one example, retailer 116 has specific items that are on sale on certain days of the week, e.g., bananas are on sale for $0.59 per pound on Tuesdays. In another example, service provider 102 has advance access to circular advertisements of retailer 116 and knows that an item consumer 106 is about to purchase will be going on sale next week. In many cases, consumer 106 can realize a discount by timing the purchase of a product properly.

Quantity 646 refers to the number of a product being purchased. If a product is part of a buy one, get one free deal, then purchasing a quantity of two greatly improves the deal for consumer 106. The quantity also affects price in circumstances where a retailer offers a discount for bulk purchases.

Quality 648 is an overall rating of the product quality. Premium brands generally have a greater quality rating than store brands. In addition, ingredients of food products are analyzed by service provider 102 to determine a quality rating. More artificial ingredients or fillers in a selected product reduces the quality rating 648 of a set of circumstances. Purchasing a different, but substitutable, product may raise an overall rating 660-664 by raising the quality rating significantly, even though price is increased. A higher quality 648 rating could simply indicate that another brand is preferred by consumer 106, even though the objective quality of the product is equal.

Product size 650 affects the overall rating by changing the price per unit of size. For many products, large products are cheaper per serving size or other unit of size. For other products, a retailer may have specific sizes on sale, so if consumer 106 switches size a sale price can be attained.

Configuration 652 relates to the format of a product being purchased. For instance, if consumer 106 scans a package of shredded cheese, consumer agent 104 recommends that the consumer purchase the cheese configured as a block rather than pre-shredded to save 40%. Consumer agent 104 may notify consumer 106 of the price of a shredder at the same retailer, and the number of purchases of block cheese rather than shredded cheese that would have to be made to pay for the shredder. In another example, consumer 106 selects a package of pre-marinated carne asada. Consumer agent 104 notifies consumer 106 that carne asada and marinade can be purchased separately for 25% less.

SKU 654 is a rating of the unit from a manufacturer. If SKUs that are more advantageous are available, consumer agent 104 notifies consumer 106. For instance, a video game console being purchased may be available in another SKU for the same price but with an additional free game. Consumer agent 104 notifies consumer 106 to look for the SKU with the free game. If the free game SKU is only available at another retailer, consumer agent 104 presents that information. In another example, a music CD being purchased by consumer 106 is available with two exclusive bonus tracks at a different retailer. Consumer 106 can attain the free bonus tracks by deferring purchase of the music CD until at the other retailer.

Contents 656 of shopping cart 604 is relevant in certain types of sales that retailers run. In some cases, consumer 106 can save a certain amount by buying a certain number of products from a set of products determined by the retailer. For instance, retailer 116 may have a mix-and-match sale including twenty-five different products dispersed around the shelves of the retailer. Consumer 106 saves $4.00 by purchasing any eight products from the twenty-five products subject to the sale. Consumer agent 104 understands mix-and-match sales and compares the contents of shopping cart 604 with the set of products that are part of the sale. Consumer 106 is notified when additional products are required to complete the mix-and-match sale.

The circumstances related to a given purchase extend beyond just the illustrated circumstances 640-656. Consumer agent 104 is capable of analyzing any circumstance surrounding a purchase and notifying consumer 106 when the circumstance can be changed to improve the overall deal for the consumer. In one embodiment, consumer agent 104 considers the inventory consumer 106 currently has at home. If consumer 106 is purchasing olive oil, consumer agent 104 may tell the consumer that a large bottle of olive oil is already available at home. Consumer agent 104 will suggest that consumer 106 defer purchasing the olive oil until the supply at home runs low. Deferring is favorable to consumer 106 in the situation where stock is already available at home due to the time value of money. When a product purchase is deferred due to inventory levels, consumer agent 104 tracks the inventory level to determine when a deferred purchase should be made. When the product inventory is low, consumer agent 104 generates a notification to remind consumer 106 to purchase the deferred product. Consumer agent 104 may consider budgetary constraints in a set of circumstances. If consumer 106 wants to buy an expensive item, consumer agent 104 will analyze credit card and bank account balances, and propose timing of the purchase to reduce overdraft and interest fees on the accounts.

The second set of circumstances also potentially includes ordering the scanned product online. Consumer agent 104 can order a product for consumer 106 automatically while the consumer is still at retailer 116. Consumer agent 104 notifies consumer 106 that a product purchase at retailer 116 can be deferred and instead ordered online. Consumer agent 104 presents the likely delivery date and other pertinent information for the consumer to make the most informed decision possible on whether to defer. The second set of circumstances may also include subscribing to the product at an online or brick-and-mortar retailer to attain a discount.

The analyzed circumstances or conditions can be any condition that exists at the time of potential purchase and that may change. The weather could be a circumstance that consumer 106 may want to defer due to. For instance, consumer agent 104 gives consumer 106 the option to defer purchase of certain frozen products when the weather is hot but will soon cool off.

Consumer agent 104 tracks purchasing and consumption for the entire family. If the father of the family is shopping at retailer 116, the father may not realize that the mother purchased a gallon of milk earlier in the day. Because the mother scanned the milk using a mobile device, consumer agent 104 is aware that milk is already in inventory at home. Consumer agent 104 notifies the father that milk is already in inventory at home because the mother purchased milk, and presents an option to defer the milk purchase.

Consumer agent 104 calculates a rating 660 for the presently existing circumstances for a product that consumer 106 selects for purchase. Consumer agent 104 also calculates a rating 662 for a first set of alternative circumstances and a rating 664 for a second set of alternative circumstances. If the overall rating for any alternative set of circumstances is higher than the presently extant circumstances, consumer 106 is notified of the option to defer the purchase of the product until the alternative circumstances can be realized.

In FIG. 15a, circumstances 662 are rated higher overall than circumstances 660, and circumstances 664 are better overall than both circumstances 660 and 662. Consumer 106 receives a notification on cell phone 290 or tablet 620 that a better set of circumstances could be achieved by deferring purchase. Upon viewing the notification, or the application receiving communication from consumer agent 104, consumer 106 is presented with a summary of the alternative circumstances including what circumstances need to be changed and what savings can be realized. In cases such as FIG. 15a, where multiple sets of alternative circumstances offer improvement over the presently existing circumstances, each option is displayed for consumer 106. Consumer 106 can select which of the alternative circumstances to defer to.

GUI elements displayed on the screen allow the consumer to acknowledge and select a deferment option. If a deferment option is selected, consumer agent 104 records the deferment so that the consumer agent can later remind consumer 106 to purchase the product under the second set of circumstances. If the deferment was for purchasing the product on a specific day, consumer agent 104 generates a notification on the specific day in question to remind consumer 106 to purchase the product. If the deferment was for purchase at a different location, consumer agent 104 places the product on shopping list 130 for the new retailer. Additionally, or alternatively, consumer agent 104 reminds consumer 106 to purchase the product when the consumer is at the second retailer, as determined by GPS coordinates provided by cell phone 290 or tablet 620.

FIG. 15b illustrates a second paradigm for comparing two sets of circumstances. Circumstances 670 are a first set of circumstances 640-656 that presently exist as consumer 106 is shopping at retailer 116. Circumstances 672 are a second, alternative, set of circumstances that are compared to circumstances 670. In FIG. 15b, each circumstance 640-656 is separately compared between circumstances 670 and 672 to determine if a better deal can be acquired by consumer 106.

Comparisons 674 illustrate the completed comparison between each individual circumstance 640-656 of sets of circumstances 670-672. Comparisons 674 show that the same product can be purchased at a different location for a cheaper price. Each circumstance 644-656 includes an equal comparison between circumstances 670 and 672, meaning that the product is essentially the same between the two, and that the contents of the cart and other circumstances are irrelevant to attaining the respective prices. The comparison 674 for price 640 shows that the price is greater for circumstances 670 than for circumstances 672. The only other difference between circumstances 670 and 672, as shown by comparison 674, is that location 642 is different. Comparison 674 for location 642 shows a “not equal” sign, indicating that while the location is different between the two sets of circumstances, one location is not necessarily better than the other is.

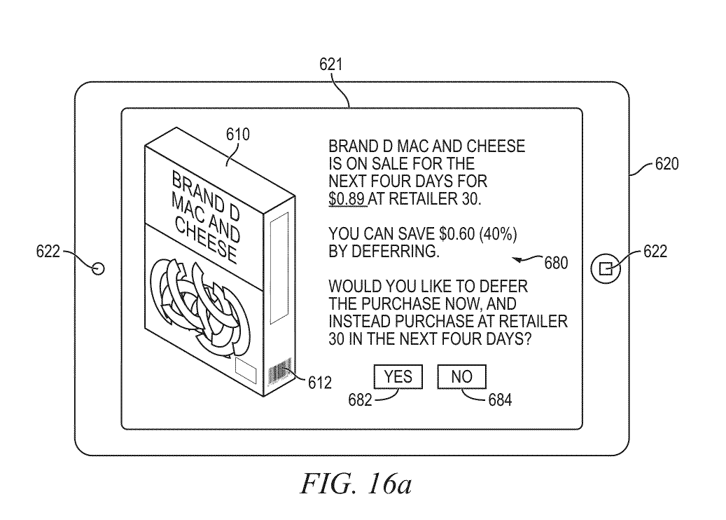

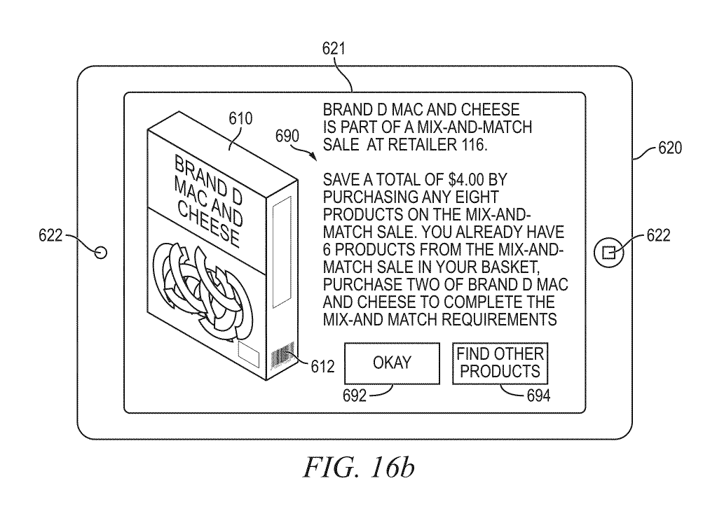

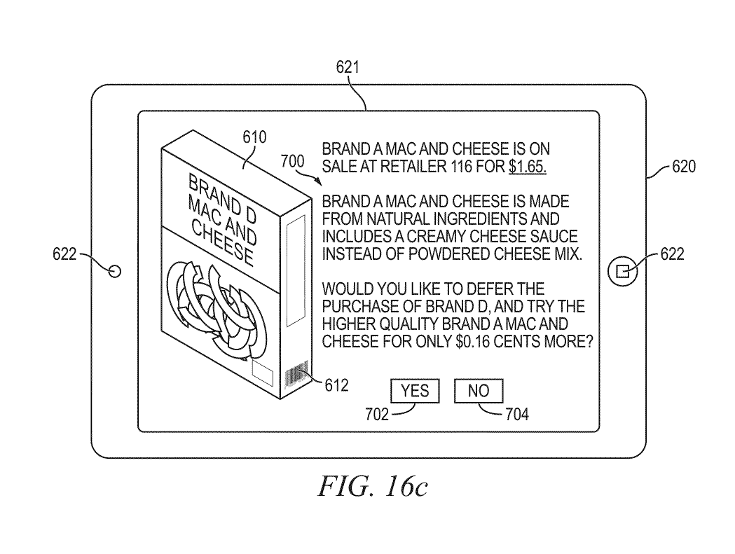

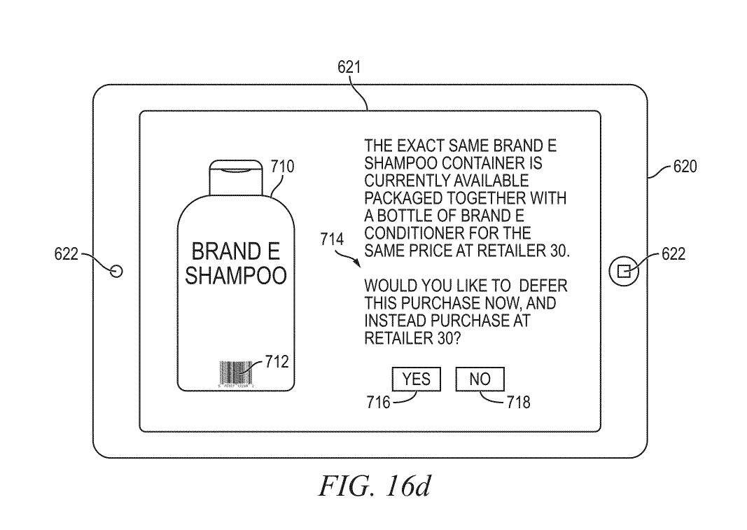

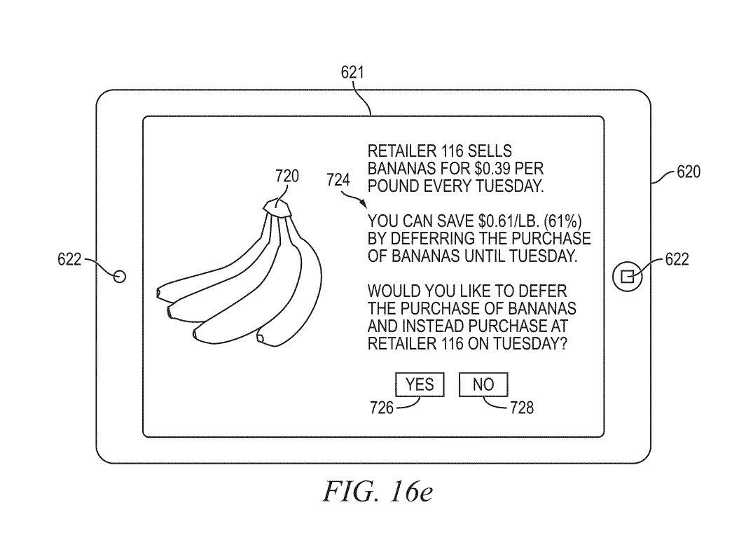

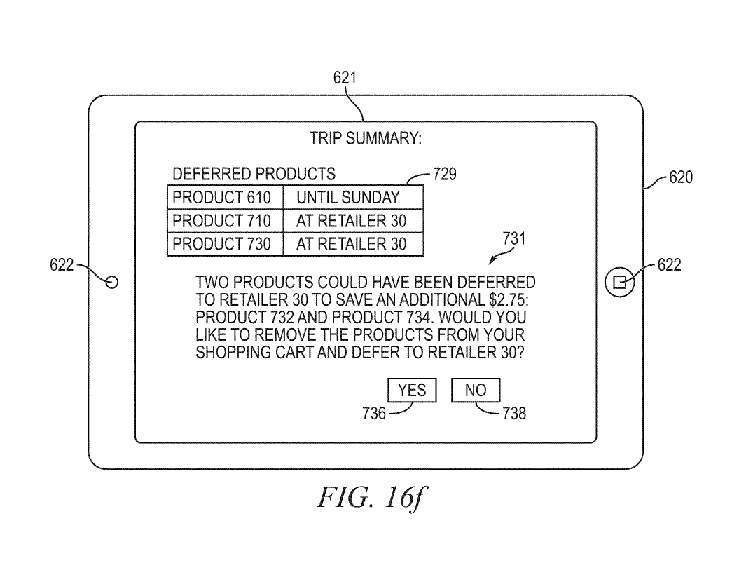

After consumer 106 scans the product in question in FIG. 15b, consumer agent 104 notifies the consumer that a better price for the product can be had at another retailer, and gives the consumer the option to defer. FIGS. 16a-16e illustrate various displays on screen 621 of tablet 620 showing consumer agent 104 giving consumer 106 the option to defer a purchase of a product.

In FIG. 16a, consumer 106 has scanned product 610, which is Brand D mac and cheese. Consumer agent 104 performs the comparison between the presently existing circumstances and possible alternative circumstances as in FIGS. 15a-15b and determines that product 610 can be purchased cheaper by deferring the purchase. Consumer agent 104 indicates in message 680 that product 610 is on sale for a 40% discount at retailer 30. The 40% discount can be achieved by deferring the purchase of product 610 until consumer 106 can travel to retailer 30.

If consumer 106 wants to defer the purchase of product 610 as recommended by consumer agent 104, the consumer clicks “yes” button 682. Consumer agent 104 adds product 610 at retailer 30 to a shopping list 130. Because the offer at retailer 30 is only for the next four days, consumer agent 104 creates a reminder to help consumer 106 remember to purchase the deferred product. Consumer 106 places product 610 back on the shelf of retailer 116 and continues shopping.

In some cases, consumer 106 may not want to defer the purchase of product 610. Consumer 106 may not want to make a special trip to retailer 30 just to save $0.60. Consumer 106 may need product 610 immediately and not be able to make it to retailer 30 before the need for product 610 will arise. Consumer 106 presses “no” button 684, and sets product 610 into shopping cart 604 for purchase at retailer 116.

In FIG. 16b, consumer 106 scans product 610, and consumer agent 104 finds that product 610 is part of a mix-and-match sale. Consumer 106 already has six of the eight required products from the set of products subject to the mix-and-match sale in shopping cart 604. Consumer agent 104 displays message 690 letting consumer 106 know that by purchasing two of product 610, the requirements for the mix-and-match sale will be fulfilled and $4.00 will be saved. Pressing “okay” button 692 is an indication by consumer 106 that the consumer will purchase two of Brand D mac and cheese to finish the mix-and-match requirements. Pressing find other products button 694 brings up a user interface showing other products that are a part of the mix-and-match set for the consumer to choose from to finish eight required products. Prior to checking out at a point-of-sale (POS) station of retailer 116, consumer 106 views a trip summary page that warns the consumer if the conditions for the mix-and-match sale are not met.

In FIG. 16c, consumer 106 scans product 610, and consumer agent 104 notifies the consumer that retailer 116 has Brand A mac and cheese, which is much better quality, on sale for only $0.16 cents more than the selected Brand D mac and cheese. Notification area 700 gives additional information on the alternative product. Consumer 106 presses “yes” button 702 to confirm the deferment of product 610, puts product 610 back on the shelf, and finds the Brand A mac and cheese that is on sale. If consumer 106 does not want to try Brand A, the consumer presses “no” button 704 and places product 610 in shopping cart 604.

FIG. 16d illustrates consumer 106 scanning product 710 using camera 622 of tablet 620. Product 710 is a bottle of Brand E Shampoo with UPC code 712. Consumer agent 104 recognizes that an alternative SKU of Brand E shampoo is available at retailer 30 that includes the same bottle of shampoo packaged together with a bottle of conditioner for the same price. Consumer agent 104 offers consumer 106 the opportunity to defer the purchase of product 710 using message 714. The alternative SKU gives consumer 106 an additional product with no change in price. If consumer 106 would like to defer purchase of product 710 to buy the better SKU for the same price at retailer 30, consumer 106 presses “yes” button 716. If consumer 106 would like to continue with the purchase of product 710 without the free bottle of conditioner at retailer 116, consumer 106 presses “no” button 718 and sets product 710 into shopping cart 604.

FIG. 16e illustrates tablet 620 after consumer 106 scans bananas 720 using camera 622. Bananas 720 are recognized by a bar code sticker stuck to one of the bananas, by another sticker on the bananas identifying a text based product look-up (PLU) code, or by optical recognition of the shape and color of bananas. Retailer 116 sells bananas for $0.39 a pound every Tuesday, but consumer 106 is attempting to buy the bananas on a day that is not Tuesday. In message area 724, consumer agent 104 notifies consumer 106 that the bananas are on sale on Tuesday, and gives the consumer the option to defer purchase of bananas 720 until Tuesday in order to take advantage of the sale. Consumer 106 presses “yes” button 726 to confirm deferment of the purchase of bananas 720, or “no” button 728 to purchase bananas 720 now at the more expensive price.

FIG. 16f is a trip summary displayed on screen 621 of tablet 620. Consumer 106 accesses the trip summary page prior to checking out at retailer 116. The trip summary page shows a list 729 of every product that remains deferred, and at what point the second, more advantageous, circumstances can be attained. Deferred products list 729 includes product 610, which has been deferred until Sunday when the product goes on sale. Products 710 and 730 are on list 729 and have both been deferred until consumer 116 can make it to retailer 30 to purchase at a lower price. Consumer agent 104 maintains the deferred product list 729 after the shopping trip is complete, and consumer 106 can review the list at any time. Consumer agent 104 combines all deferred products from all shopping trips into a single list for the use of consumer 106 at any time.

The trip summary page also shows a list or text display 731 of any products that consumer 116 should reconsider deferring. In the case of FIG. 16f, notification 731 informs consumer 106 that two more products could have been deferred to retailer 30 to save an additional $2.75. Notification 731 is valuable because consumer 116 may not think deferring any one product was worthwhile while browsing retailer 116, and so did not defer any of the products. However, by the end of the trip the sum of all possible deferred products may be substantial. Notification 731 gives consumer 116 the opportunity to see how much could be saved by deferring all possible purchases.

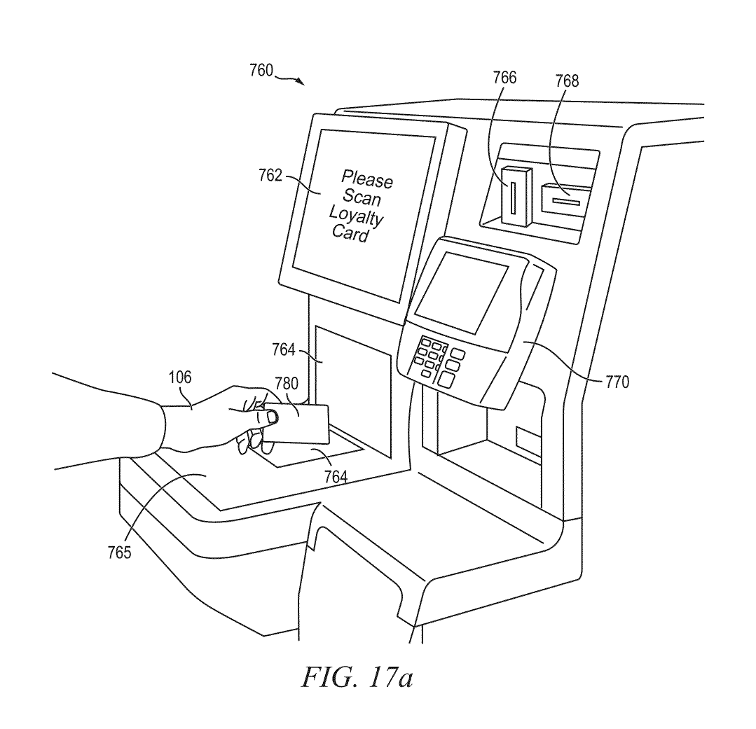

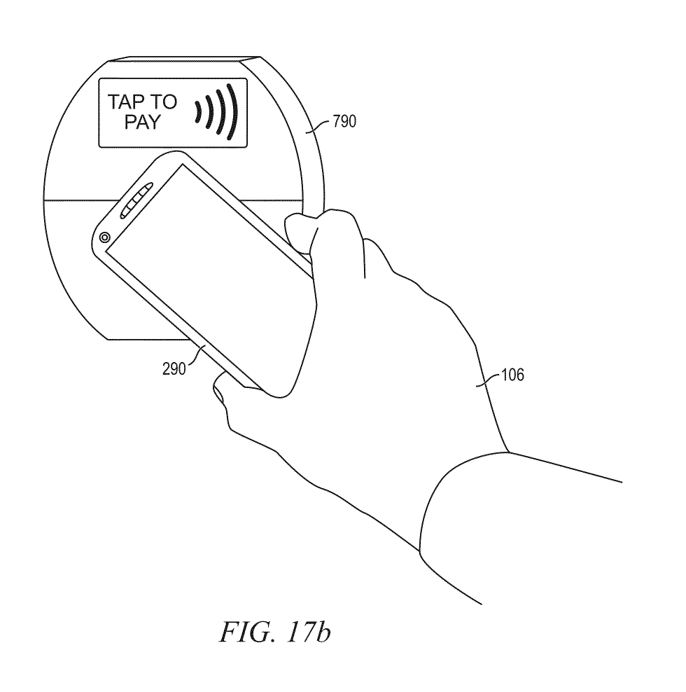

Even if consumer 106 never deferred any product purchase while shopping at retailer 116, notification 731 shows consumer 106 the total amount that can still be saved by deferring a subset of the total products being purchased. If consumer 106 is swayed by the total amount that could be saved by deferring, “yes” button 736 is pressed, and consumer 106 replaces products 732 and 734 back onto shelves of retailer 116. If consumer 106 would rather go ahead and purchase products 732 and 734 at retailer 116, the consumer presses “no” button 738, and continues to check out as illustrated in FIGS. 17a-17b.

Consumer agent 104 provides consumer 106 with the ability to defer product purchases and avoid purchasing items on a shopping list under a first set of conditions when one or more of the products on the shopping list could be purchased under a second set of conditions, which are more favorable to the consumer. Consumer agent 104 alerts consumer 106 regarding a product that is overpriced, and provides the consumer with the option to defer purchasing the product until the consumer can access an optimal or second set of sales conditions more favorable to the consumer. The option to defer purchases allows consumer 106 to purchase a product under optimal sales conditions and helps the consumer to avoid overpaying for products.

The factors considered as part of a set of conditions can be widely varying, and include any condition extant at the time of attempted purchase of a product. The key is that consumer 106 is provided the option to defer purchasing a product under a first set of conditions in order to purchase the product under a second set of conditions more favorable to the consumer. Deferring product purchases allows the consumer to obtain the best price available for a given product. While the option to defer product purchases has been discussed above in the context of a relationship between a consumer and a retailer, the defer functionality could also be available to a retailer using a retailer agent to purchase product inventory from a manufacturer, or a manufacturer purchasing equipment and raw materials.

In some embodiments, consumer agent 104 gives consumer 106 an option to defer purchasing a scanned product even though no second set of conditions is determined at the time the product purchase is deferred. Consumer 106 simply thinks the product is overpriced and defers purchase until the product is on sale. Consumer agent 104 does not know of a scheduled sale coming up, but will add the scanned product to the deferred product list and notify consumer 106 when the product goes on sale. Consumer 106 can set a specific discount amount to wait for, e.g., consumer agent 104 alerts the consumer when the product is available with at least a 30% discount. Consumer 106 may defer because the consumer is not certain the product is needed or desired. The second set of conditions is then that the consumer finally becomes certain that the purchase should be made. Consumer 106 may defer for reasons unknown to consumer agent 104. In one case, consumer 106 defers purchase because the consumer cannot afford the product now, but is expecting a bonus from work soon. The second set of conditions in this case occur when the consumer can finally afford the product. Consumer agent 104 notifies consumer 106 when optimal conditions exist even if a product was not initially deferred. When optimal conditions for purchasing a product consumer 106 likes exist, consumer 106 is notified even without having previously deferred the product.

In one embodiment, once a product is on the list of deferred products, the second set of conditions can be validly fulfilled not only for the specific product deferred, but also for any product in a consideration set with the deferred product. For instance, if consumer 106 defers the purchase of Brand A laundry detergent, the consumer may be notified when Brand B laundry detergent goes on sale if the consumer indicated Brand A and Brand B laundry detergents as substitutes.

Consumer agent 104 uses the immediately pending purchase of a product to improve the negotiating position during another round of one-to-one negotiation 126. Once a product is placed into shopping cart 604, the negotiating position of consumer agent 104 is very strong. Other retailers are motivated to offer more extreme discounts to persuade consumer 106 to defer the purchase at retailer 116. In addition, the information of consumer 106 deferring a purchase is important for retailer 116, because retailer 116 can offer a larger discount to match the price resulting from the second set of circumstances.

The data regarding consumer 106 and other consumers deferring purchases at retailer 116 is important market intelligence data for the retailer. Service provider 102 can compile data for products deferred by a plurality of consumers and offer the data to retailer 116, potentially for a fee. The bulk data related to products deferred at retailer 116 benefits the retailer because management at the retailer can analyze the data and set product prices using the market intelligence.

After consumer 106 selects each item from shopping list 130 designated for purchase at retailer 116, consumer 106 completes a checkout process, with negotiated discounts applied prior to payment, as illustrated in FIGS. 17a-17b. FIG. 17a illustrates consumer 106 checking out at point-of-sale (POS) or self-checkout station 760. Station 760 includes screen 762, scanner 764, scale 765, coin slot 766, bill acceptor 768, and credit card reader 770. Consumer 106 moves loyalty card 780 in front of scanner 764. Loyalty card 780 includes a visible UPC or QR code readable by scanner 764. In other embodiments, loyalty card 780 includes an NFC chip and antenna capable of radio communication with station 760. The information embedded on loyalty card 780 identifies consumer 106 to station 760. Station 760 connects to control system 118 of the retailer to look up consumer 106 and retrieve any negotiated deals associated with the consumer. In one embodiment, station 760 communicates the identity of consumer 106 to control system 118, and control system 118 accesses retailer agent 114 via an API to read the consumer's discounts stored in central database 56.

After consumer 106 scans loyalty card 780 as shown, consumer 106 proceeds to scan all the items for purchase at retailer 116 by scanning UPC codes on the products using scanner 764. As consumer 106 scans items, station 760 applies the negotiated discounts, and screen 762 displays the discounted price for consumer 106 to verify. In some embodiments, consumer 106 scans a UPC or QR code displayed on a printed sheet of paper or a mobile phone screen instead of or in addition to loyalty card 780. In other embodiments, loyalty card 780 includes a magnetic strip that is slid through card reader 770 instead of a bar code or QR code scanned by scanner 764. Consumer 106 can scan loyalty card 780 after scanning the items being purchased and station 760 applies negotiated discounts to the items that have already been scanned.

After each item to be purchased has been scanned, and consumer 106 has also scanned loyalty card 780 to receive negotiated discounts, consumer 106 pays by inserting cash into coin slot 766 and bill acceptor 768, sliding a credit card using card reader 770, or by using a near-field communication (NFC) payment system as illustrated in FIG. 17b. When consumer 106 inserts cash into coin slot 766 or bill acceptor 768, the total amount of cash inserted is reflected on screen 762, in addition to the amount of payment still needed to meet the total purchase price. Card reader 770 allows consumer 106 to slide a credit card through a magnetic reader to pay any remaining balance after cash is used to pay a portion of the total price.

FIG. 17b illustrates consumer 106 using an NFC payment system. Mobile device 290 of consumer 106 includes specific NFC hardware used to communicate with nearby devices that include complementary NFC hardware. In one embodiment, mobile device 290 includes a large loop antenna that exhibits inductive properties. A magnetic field generated by the loop antenna in mobile device 290 is detected by NFC payment station 790. A magnetic field generated by NFC payment station 790 is received by mobile device 290, providing two-way communication between the mobile device and NFC payment station. In some embodiments, only one of payment station 790 and mobile device 290 generates a magnetic field, and the second of the two devices manipulates the generated magnetic field to provide two-way communication.

Mobile device 290 includes a payment application associated with credit cards of consumer 106. The application on mobile device 290 also includes a connection to consumer agent 104. In one embodiment, the same application used by consumer 106 to scan bar codes and QR codes to enter intent to buy 122 handles payment during the checkout process as well. Mobile device 290 not only handles transaction payments, but also automatically communicates loyalty program membership to the retailer computer system when paying. A payment app on mobile device 290 securely transmits credit card or bank account information used for payment, together with loyalty card information, to payment station 790. In one embodiment, payment station 790 replaces card reader 770 in FIG. 17a, or a hybrid reader is used that accepts magnetic credit cards and NFC payments. In other embodiments, mobile device 290 displays a bar code or QR code on the screen of the mobile device which is scanned by scanner 764 in FIG. 17a to communicate a loyalty program membership to the retailer POS system so that negotiated discounts can be looked up.

After completion of the checkout process as illustrated in FIGS. 17a-17b, consumer 106 exits retailer 116 with the purchased groceries, loads the groceries into a vehicle, and continues the shopping trip. The GPS capability of mobile device 290 guides consumer 106 back to the vehicle, because the app running on the mobile device automatically remembers where the consumer parked. If consumer agent 104 has created a shopping list with additional retailers, as illustrated in FIG. 13, consumer 106 continues the shopping trip by travelling to the next retailer, i.e., retailer 48. If mobile device 290 is being used for GPS directions, the mobile device understands when consumer 106 has left retailer 116 and begins displaying driving directions to retailer 116. Consumer 106 follows GPS directions from retailer 116 to retailer 48, similar to how the consumer found retailer 116 in FIG. 14a. Once consumer 106 arrives at retailer 48, mobile device 290 begins displaying the floorplan of retailer 48 in a similar manner to FIG. 14b. Consumer 106 navigates through retailer 48 using mobile device 290 for GPS directions to pick up each item designated by consumer agent 104 for purchase at retailer 48. Consumer 106 completes the checkout process shown in FIGS. 17a-17b for the goods selected at retailer 48, and proceeds home. If additional retailers are on the shopping trip, consumer 106 visits those retailers prior to returning home.

While one or more embodiments of the present invention have been illustrated in detail, the skilled artisan will appreciate that modifications and adaptations to the embodiments may be made without departing from the scope of the present invention as set forth in the following claims.

What is claimed:

1. A method of controlling a commerce system, comprising:
providing a shopping agent;
selecting a product for purchase displayed at a premises of a first retailer;
optically scanning a bar code displayed on the product using a mobile device;
transmitting data stored in the bar code from the mobile device to the shopping agent;
analyzing a first set of conditions existing while selecting the product;
determining a second set of conditions that will result in a lower price for the product;
communicating the second set of conditions from the shopping agent to the mobile device; and
presenting an option to defer the purchase of the product until the second set of conditions exist.

2. The method of claim 1, further including generating a notification on the mobile device when the second set of conditions exist.

3. The method of claim 1, further including:
providing a sales agent; and
notifying the sales agent that the purchase of the product is being deferred.

4. The method of claim 1, wherein the second set of conditions includes purchasing the product at a second retailer.

5. The method of claim 1, wherein the second set of conditions includes subscribing to the product.

6. The method of claim 1, wherein the second set of conditions includes purchasing the product at the first retailer at a later date than under the first set of conditions.

7. A method of controlling a commerce system, comprising:
providing a shopping agent;
selecting a first product for purchase at a first retailer;
notifying the shopping agent that the first product was selected;
analyzing a first set of conditions existing while selecting the first product;
determining a second set of conditions that will result in a lower price for the first product; and
presenting an option to defer the purchase of the first product until the second set of conditions exist.

8. The method of claim 7, further including generating a notification when the second set of conditions exist.

9. The method of claim 7, further including:
providing a sales agent; and
notifying the sales agent that the purchase of the first product is being deferred.

10. The method of claim 7, further including satisfying the second set of conditions with a second product in a consideration set with the first product.

11. The method of claim 7, wherein the second set of conditions includes a one-to-one negotiated offer for the first product.

12. The method of claim 7, wherein the second set of conditions includes purchasing the first product at the first retailer at a later date.

13. The method of claim 7, further including providing a list of deferred products to the first retailer.

14. A method of controlling a commerce system, comprising:
selecting a product for purchase under a first set of conditions;
determining a second set of conditions that will result in a lower price for the product; and
presenting an option to defer the purchase of the product until the second set of conditions exist.

15. The method of claim 14, further including generating a notification when the second set of conditions exist.

16. The method of claim 14, further including:
providing a sales agent; and
notifying the sales agent that the purchase of the product is being deferred.

17. The method of claim 14, wherein the second set of conditions includes purchasing a plurality of the product.

18. The method of claim 14, wherein the second set of conditions includes subscribing to the product.

19. The method of claim 14, wherein the second set of conditions includes purchasing the product at a later date.

20. The method of claim 14, further including generating a list of deferred products.

21. A method of controlling a commerce system, comprising:
selecting a first product for purchase under a first set of conditions; and
presenting an option to defer the purchase of the first product until a second set of conditions exist.

22. The method of claim 21, further including generating a notification when the second set of conditions exist.

23. The method of claim 21, wherein the second set of conditions includes purchasing a plurality of the first product.

24. The method of claim 21, wherein the second set of conditions includes subscribing to the first product.

25. The method of claim 21, further including satisfying the second set of conditions with a second product from a consideration set including the first product and second product.
